(19) United States
(12) Patent Application Publication
(10) Pub. No.: US 2004/0034555 A1
(43) Pub. Date: Feb. 19, 2004

(54) Hierarchical methodology for productivity measurement and improvement of complex production systems

(76) Inventors: John P. Dismukes, Toledo, OH (US); Qi Su, Toledo, OH (US); Samuel H. Huang, Loveland, OH (US); Lawrence K. Miller, Toledo, OH (US); Rahul Mittal, Toledo, OH (US); Mousalam A. Razzak, Dubai (AE); Ranganath Kothamasu, Cincinnati, OH (US); Milan H. Doshi, Toledo, OH (US)

Correspondence Address: EMCH, SCHAFFER, SCHAUB & PORCELLO CO, P O BOX 916, ONE SEAGATE SUITE 1980, TOLEDO, OH, 43697

(21) Appl. No.: 10/388,921

(22) Filed: Mar. 14, 2003

Related U.S. Application Data
(60) Provisional application No. 60/365,282, filed on Mar. 18, 2002.
(60) Provisional application No. 60/368,841, filed on Mar. 28, 2002.

(51) Int. Cl. G06F 17/60

(52) U.S. Cl. 705/7

(57) ABSTRACT

A hierarchical method, computer system, and computer product for causally relating productivity to a complex manufacturing system to provide an integrated analysis of the system which measures, monitors, analyzes and, optionally, simulates performance of the complex manufacturing system based on a common set of productivity metrics for throughput effectiveness, throughput, cycle time effectiveness, and inventory.

### CROSS-REFERENCE TO RELATED APPLICATIONS

This application is based upon and claims priority under Provisional Patent Application No. 60/365,282 filed Mar. 18, 2002 and Provisional Application No. 60/368,841 filed Mar. 28, 2002.

### FIELD OF THE INVENTION

This invention relates to a method, computer system, and computer product for causally relating productivity to a production system comprising describing a production system, including equipment, subsystems, product lines, manufacturing processes, factories, transportation systems, and supply chains (which includes transportation systems and manufacturing systems), developing and applying algorithms and software tools for measurement, monitoring and analysis of system level performance, and, optionally, building a simulation model for rapid what-if scenario analysis and factory design. The present invention also relates to a method for the description and analysis of cost and environmental impact, linked to productivity. In particular, according to the present invention, the production system comprises series, parallel, assembly, expansion and complex subsystems and rework.

In particular, according to the present invention, the production system comprises complex subsystems.

### BACKGROUND OF THE INVENTION

Total Productive Maintenance (TPM) principles and Overall Equipment Effectiveness (OEE) metrics for the productivity measurement and analysis of individual equipment have been described as follows (see end of specification for cited references):

References 8-12, 18, and 21 review OEE and provide summary level descriptions of measuring OEE of an individual equipment in a factory.

Reference 8 provides a general overview of OEE for the semiconductor industry.

Reference 9 describes a spreadsheet tool for calculating OEE of an individual piece of equipment in a factory, including how to predict improvements by changing OEE. This provides a comprehensive description at the equipment level, but does not discuss factory level performance.

Reference 10 provides a general discussion of measuring OEE for a piece of equipment, but no description of details of data collections methods or systems.

Reference 11 describes and summarizes, without details, the use of a “CUBES” tool derived from Konopka's thesis work in reference 9, to collect and analyze data on OEE for a machine in a factory.

Reference 12 provides a general description of an OEE monitoring system in a factory, including the architecture of the computer and data collection system.

Reference 18 provides a general discussion of OEE for equipment, and a spreadsheet for calculation of OEE from individual data. It is an extension of the work of Konopka to the glass industry.

Reference 20 reviews OEE definitions and applications and proposes the need for factory level productivity measurements.

References 22, 23 and 24 describe software packages for measurement of Overall Equipment Effectiveness (OEE) and analysis of root causes based on downtimes, production rates and yield.

In spite of the extensive description of equipment performance, no suitable methodology for applying OEE for processing multiple products has been presented. Even more crucial is a lack of the systematic framework and methodology for description of production systems and analysis of system level productivity in terms of equipment productivity. For example, although modeling methods such as IDEF0 [25] and process mapping [26] or flow charting software (e.g. ABC Flowcharter, Visio, etc.) can be used to provide a visual representation for manufacturing flow sequence, such techniques do not systematically describe production systems and hence do not provide the quantitative basis required for calculation and analysis.

References 89 to 94 give a general overview of simulation methodology. Simulation technology holds tremendous promise for reducing costs, improving quality and shortening the time to market for the manufacturing industry. Manufacturing simulation focuses on modeling the behavior of manufacturing organizations, process and system, Simulation models are built to support decisions regarding investment in new technology, expansion of production capabilities, modeling of supplier relationships, material management, human resources and the like.

Simulation software useful to apply simulation methodology provides tools that facilitate flexible modeling, easy sharing of simulation efforts and effective utilization of the work already done in the past, thereby avoiding the need of duplication of efforts. This speeds up the model building process and saves more time for model validation and “what if” analysis. Simulation is also helpful to predict the performance of manufacturing operations before those processes are operated in the real world.

Knowledge and analysis of the productivity of manufacturing operations at the factory and supply chain level are of increasing importance to companies seeking to continuously optimize existing operations for close match of supply to market demand, and to rapidly bring new product lines through the start-up phase to highly efficient, flexible, steady state operation. In spite of the interest in equipment level productivity, no generic framework for manufacturing system description and no standard quantitative methodologies are available for description and analysis of system level productivity, and relation of system level productivity to equipment level productivity. This invention provides a sound and practically applicable method to address these needs.

Equipment Level Productivity

The Total Productive Maintenance or TPM paradigm [1-7] has provided a quantitative metric for measuring the productivity of an individual production component (equipment, machine, tool, process, etc.) in a factory. This metric, the conventional Overall Equipment Effectiveness (OEE), calculates the equipment's productivity relative to its maximum capability,

OEE=A_{eff}*P_{eff}*Q_{eff}≦1 (1)

Thus OEE is a quantitative measure of equipment manufacturing productivity, by Equation (1), involving rate and yield as well as time. In Equation (1), A_{eff} (≦1) captures the deleterious effects due to breakdowns, setups and adjustments, P_{eff} (≦1) captures those due to reduced speed, idling and minor stoppages, and Q_{eff} (≦1) captures those due to defects, rework and yield, where,

A_{eff} (≦1)=Availability Efficiency=T_{U}/T_{T},

P_{eff} (≦1)=Performance Efficiency=NOR*SR=[Tₚ/T_{U}]*[R_{avg}/Rₜₕₐ], and, Q_{eff} (<1)=Quality Efficiency=Yield of Good Product=P_{g}/Pₐ, Where

NOR=net operating rate, SR=speed ratio, and the other parameters are defined in Tables 1 and 2 (FIGS. 2 and 3, respectively).

FIG. 1 defines the time parameters used in the analysis and application of OEE to the productivity of manufacturing equipment.

Following the first publication in 1988 of detailed information on the TPM methodology outside of Japan by Seichi Nakajima [1], manufacturing companies have recognized the importance of the OEE metric, and have begun applying it as part of their overall quality programs to address systematic waste elimination, continuous improvement and optimization of manufacturing processes carried out on individual production equipment. Researchers in the semiconductor chip industry [8-14] have taken the lead in these efforts, in collaboration with International SEMATECH (Austin, Tex.) and the Center for Semiconductor Manufacturing (UC Berkeley, California). Published literature assessments of OEE [11-12, 15-16] indicate some typical, broad ranges of OEE in manufacturing industries, but typically cite only overall OEE numbers, providing little insight into the effect of individual manufacturing variables on the three major efficiency factors of OEE in Equation (1). More recently, researchers at The University of Toledo in collaboration with the glass industry have published analyses of OEE related to flat glass manufacturing [17-20] which include analysis of the individual factors. To date, however, there are still relatively few publications describing the theory and a standard format for application of OEE to industrial processes.

System Level Productivity

Notwithstanding the importance of the productivity of individual equipment, an understanding the productivity of a real production system (e.g. product line, factory, supply chain) typically involves the analysis and understanding of the complex layout and interconnection of many pieces of equipment. Hence the overall productivity of the system depends on many factors, including input and output schedules, inventory levels, the number of different products being processed, and the architecture for product flow between individual pieces of equipment, as well as the OEE of each equipment.

Burbidge [27-29] pioneered the recognition of the need for systematic description of factories by classifying them according to 1) type of material or product flow (continuous, discrete fabrication, or batch) and 2) type of manufacturing system integration or architecture (processing, expansive, flexible, or assembly). He concluded that in real factories one type of product flow and one type of system architecture often predominate. He also recognized that several types may be present in an actual product line or factory depending upon the complexity of manufacturing. However, Burbidge's approach has been employed for qualitative, not quantitative, description of manufacturing systems. FIG. 4 presents a matrix representing the inventor's interpretation of the Burbidge classification methodology, showing as examples the predominant classification of particular industries at the intersection between specific types of product flow and system architecture.

This analysis highlights key criteria which are prerequisites for quantitative analysis of overall factory performance, namely an accurate manufacturing layout (or flow chart), the product flow sequence, and flow rates between each equipment. Other key criteria include: 1) the availability of data on appropriate production parameters for each equipment, 2) well-defined rules for interconnecting UPP's within a manufacturing layout, 3) quantitative metrics for equipment throughput and cycle time, 4) a methodology to relate individual equipment performance to overall system performance, and 5) a sensitivity analysis methodology both for assessing root causes of poor performance and providing guidance for improvement and optimization.

There has been no single, well-defined, proven paradigm for analysis of overall production system performance meeting these criteria. Rather, a variety of techniques have been put forward for consideration. Factory engineers and managers typically address factory analysis, improvement and optimization by empirical application of one or more tools, such as 1) simulation [30-31], 2) theory of constraints [32-33], 3) cycle time management [33], 4) continuous flow manufacturing [34], and 5) computer integrated manufacturing [36]. Therefore, there is a need to understand and alleviate the observed inverse relation between product throughput and product cycle time in the case of processing multiple part types or products or recipes.

Scott [35-36] analyzed the need for a coherent, systematic methodology for productivity measurement and analysis at the factory level. Scott examines this need from the perspective of chip manufacturing in the semiconductor industry, and suggests a weighted average of ten “overall factory effectiveness” or “OFE” metrics for evaluating the overall performance of the factory. These metrics are: 1) OEE of individual equipment, 2) cycle time efficiency, 3) on time delivery percentage, 4) capacity utilization, 5) rework percentage, 6) mechanical line yield, 7) final test yield, 8) production volume or value versus schedule, 9) inventory turn rate, and 10) start-up or ramp-up performance versus plan. The copending above-referenced PCT/US01/49333 invention meets this need for a coherent, systematic method for productivity measurement and analysis.

However, there is a further need to reduce these metrics to a smaller basis set of metrics, and to develop relationships between a final base set of system level metrics and the metrics describing individual equipment.

There is a further need for practical methodologies for application of these metrics for the analysis, improvement and optimization of complex manufacturing subsystems, often called flexible manufacturing systems or cells.

### SUMMARY OF THE INVENTION

Due to global competition, companies are striving to improve and optimize manufacturing productivity in order to achieve manufacturing excellence. One step in this effort is to develop and apply well-defined productivity metrics to understand and then improve both equipment and factory performance. The earlier filed, copending and commonly owned application, PCT/US01/49332 filed Dec. 18, 2001 relates to a method, a computer system for, and a computer product for causally relating productivity to an array of production operations where: 1) a hierarchical framework is described for a production system (e.g., equipment, subsystem, product line, factory, transportation system, and supply chains (which also includes transportation systems and manufacturing systems), and 2) system performance is measured, monitored and analyzed by developing and applying algorithms and calculation methodologies, and 3) a rapid simulation of performance of the production system is built by using a common set of productivity metrics for throughput effectiveness, cycle time effectiveness, throughput and inventory.

Based on a Unit Production Process (UPP) template or building block in FIG. 5 representing a production component, equipment, machine, tool, process, and the like, algorithms are developed to calculate the unit-based Overall Equipment Effectiveness (OEE) and Cycle Time Effectiveness (CTE) at the equipment level for processing of multiple as well as single product types, in discrete or continuous production. One embodiment is the concept and methodology for unit-based OEE.

A production system (such as a manufacturing system, factory, transportation system and/or supply chain) is described as an array of UPP building blocks interconnected to accurately reflect the actual material flow sequence through the system, as illustrated in FIG. 6.

A base set of well-defined UPP sub-systems, as shown in FIG. 7, is defined and applied with predetermined interconnectivity rules, (as shown in FIGS. 8A and 8B, Table 4). These rules are applied generically to represent any system as a basis for measurement, monitoring, analysis and simulation.

Algorithms are developed and applied to assess the productivity metrics of each UPP, each UPP subsystem and, finally, the production system. This hierarchical approach allows the assessment of subsystem and system level productivity metrics of Overall Throughput Effectiveness (OTE) and Cycle Time Effectiveness (CTE) from equipment level metrics by application of algorithms for subsystem and factory connections illustrated for a system, generally shown herein for ease of illustration as a Unit Factory (UF) in FIG. 6.

These assessments are applied to the productivity of each UPP, UPP subsystem, and the production system to provide an insight into the dynamics of production. This assessment includes the various loss factors and their causes in relation to performance at the UPP level, the UPP subsystem level, and, finally, the overall system level. The metrics and the analysis methodology of the present invention, therefore, provide guidance essential for achieving both near term improvements and long-term equipment and system optimization.

Measurement and analysis of real systems, for example, factories based on factory data, are conducted using spreadsheet analysis and an inventive visual flowcharting and measurement tool with the algorithms for productivity measurement at the equipment, subsystem and factory level coded in a standard computer language (e.g. Visual Basic or other suitable computer language).

The system flowchart description is converted to a discrete event simulation description, to enable performance assessment by rapid simulation of various, alternative manufacturing scenarios. To do this, two different methods can be used. In the first method, data representing the interconnectivity of the manufacturing system and its intrinsic performance characteristics are transferred from the flowcharting and measurement tool via appropriately formatted spreadsheets (e.g. EXCEL) to rapidly set up an equivalent manufacturing array in a discrete event simulation software package. In the second method, data representing the interconnectivity of the manufacturing system and its intrinsic performance characteristics are transferred from a flowcharting and measurement tool to a unique UPP template built using a simulation software package. These templates represent different UPP types to represent various types of operations such as series, parallel, expansion and assembly, as shown herein. This enables dynamic simulation to be rapidly implemented to assess scenarios for eliminating bottlenecks and tailoring performance, and to develop new designs optimized for specific manufacturing performance objectives. In a preferred aspect, the dynamic simulation is linked to market demand.

In yet another aspect of the present invention, a fundamental methodology linking manufacturing productivity to product cost is described. This method accomplished linking both for direct manufacturing cost and for indirect cost, and thereby enables an improved understanding of the relation of performance measures to productivity. In this method, total cost is defined as the sum of direct manufacturing cost and indirect cost.

The present invention relates to a method, a computer system for, and a computer product for the productivity analysis of complex manufacturing subsystems, often called flexible manufacturing systems or cells. The invention includes the following method:

1) determine by measurement of an operating system, or by design of a new system, the number of Unit Production Processes (UPPs), and determine their operating characteristics;

2) determine the number of Operating Sequences (OSs) describing the material flow sequence of products (e.g. n products) through the complex manufacturing subsystem;

3) determine the product throughput or input, Pₐ, the good product output P_{g}, and the defective product, Pₐ-P_{g}, for the total time, T_{T}, of measurement or simulation;

4) flow chart each OS in the complex manufacturing subsystem (CMS), and determine the Overall Equipment Effectiveness (OEE) for each of the UPPs;

5) determine the availability efficiency (A_{eff}), the performance efficiency (P_{eff}), and the quality efficiency (Q_{eff}) or yield of each UPP; and

6) determine the Overall Throughput Effectiveness (OTE) of the CMS by the relations,

OTE_{CMS}=[P_{g(CMS)}]/P_{tha(CMS)} and P_{tha(CMS)}=R_{thavg(CMS)}*T_{T}

or,

OTE_{CMS}=A_{(CMS)}·P_{(CMS)}·Q_{(CMS)}

where, the quantity P_{tha(CMS)} is the theoretical actual product output units from the CMS in total time, and R_{thavg(CMS)} is defined as the average theoretical processing rate for the total product output from the CMS during the period of total time, T_{T}.

Prior to the present invention which allows for the detailed description of these CMS algorithms, it was not possible to describe an analytical relation between the output of the CMS, P_{g}, and the theoretical processing rate of the CMS, which can be calculated based on the OSs and the parameters of each UPP. The present invention enables the OSs and the CMS to be electronically flow charted and simulated as the basis for sensitivity analysis, to be used for improvement, and for new CMS designs.

### BRIEF DESCRIPTION OF THE DRAWINGS

FIG. 1 is a schematic diagram showing the relations of time parameter definitions for a unit production process (UPP).

FIG. 2 is Table 1 showing parameter definitions for a Unit Production Process (UPPᵢ) used in productivity calculations.

FIGS. 3A and 3B is Table 2 showing parameter definitions and equations for calculated parameters and metrics for a UPPᵢ.

FIG. 4 is a schematic diagram of a prior art industrial classification of factories based on the type of product flow and the type of manufacturing system architecture.

FIG. 5 is a schematic illustration of a Unit Production Process (UPP) showing inputs and outputs as the basis for a manufacturing system description and productivity measurement.

FIG. 6 is a schematic illustration of a production system or unit factory (UF).

FIG. 7 is a schematic illustration of five (5) generic UPP subsystems (UPP SS). Types of factoring and describing any production system; filled circles represent individual UPPs shown in FIG. 1; note that rework may be applied to any of the 5 generic subsystems.

FIGS. 8A and 8B are schematic illustrations of examples of connection and analysis rules for UPP subsystems and productions systems.

FIGS. 9A-9E are Table 3 showing parameter definitions and equations for a production system or Unit Factory (UF) which processes multiple parts.

FIG. 10 is a schematic illustration of re-work based on a series subsystem (as shown in FIG. 7).

FIG. 11 is a table showing Example 7.1 production data, listing the products, operation sequences, theoretical processing times of a product at different UPPs, and the quantity of actual and good products being processed at four operation sequences.

FIG. 12 is a table showing Example 7.2 Measured Time at each state for UPPs.

FIG. 13 is a schematic illustration showing a modeling process for a complex manufacturing system.

FIG. 14 is a table showing examples, Case 1 and Case 2, of unit based OEE as the foundation for production metrics.

FIG. 15 is a schematic illustration of a layout of a unit factory based on series and parallel subsystems.

FIG. 16 is a schematic illustration showing the UPPs combined into subsystems.

FIG. 17A is a table showing the OEE for a series-connected UPP subsystem; FIG. 17B is a table showing the time per part data.

FIG. 18A is a table showing the OEE for a parallel-connected UPP subsystem; FIG. 18B is a table showing the time per part data.

FIG. 19A is a table showing the OEE for a unit production system or factory; FIG. 19B is a table showing the time per part data; FIG. 19C is a table showing results from both subsystems and the UPP.

FIG. 20 is a schematic illustration of a metrics calculation for an assembly subsystem.

FIGS. 21A and 21B are tables showing the metric calculations of the assembly subsystem illustrated in FIG. 20.

FIG. 22 is a schematic illustration of a metrics calculation for an expansion subsystem.

FIGS. 23A and 23B are tables showing the metrics calculations of the expansion subsystem illustrated in FIG. 22.

FIG. 24 is an example of an electronically generated flowchart by the EFCPMT showing 15 UPPs in series and parallel subsystem connection.

FIG. 25 is an example of an electronically generated bar chart by the EFCPMT for OEE, OTE and CTE.

FIG. 26 is a flow chart illustrating an algorithm for subsystem recognition.

FIG. 27 is a flow chart illustration A) an example manufacturing system; and, B) a graphic representation.

FIG. 28 is a flow chart illustrating recognition of a series connected subsystem.

FIG. 29 is a flow chart illustrating recognition of an expansion connected subsystem.

FIG. 30 is a flow chart illustrating recognition of a parallel connected subsystem.

FIG. 31 is a flow chart illustrating a renumbered chart of FIG. 30.

FIG. 32 is a flow chart illustrating a renumbered chart of FIG. 31.

FIG. 33 is a flow chart illustrating product information.

FIG. 34 is an example of a simulation model in EXCEL format.

FIG. 35 is an example of an imported simulation model in ARENA.

FIG. 36 is a schematic illustration of a model flexible-sequence cluster tool.

FIG. 37 is a schematic illustration of operation sequences of model cluster tool operation.

FIG. 38 is a table showing production time data for model cluster tool operation.

FIG. 39 is a table showing model cluster tool production data.

FIG. 40 is a table showing cluster tool machine states (J, K, G, F, A, B, C, D, E, H) and operating sequences (OS1-OS5).

FIG. 41 is a table showing chamber availability, operation sequence availability, and cluster tool availability.

FIG. 42 is a table showing productivity calculations for individual cluster tool chambers.

FIG. 43 is a table showing productivity calculations for overall cluster tool subsystem.

FIG. 44A is a schematic illustration of a unit production process.

FIG. 44B is a table showing the definition of UPP parameters for FIG. 44A.

FIG. 45A is a schematic illustration showing a general logic for UPP in a simulation software template.

FIG. 45B is a table showing the definition of UPP parameters for FIG. 45A.

FIG. 46A is a schematic illustration showing an entry regular UPP: showing a generic diagram and parameter definition.

FIG. 46B is a table showing the definition of UPP parameters for FIG. 46A.

FIG. 47A is a schematic illustration showing an intermediate regular UPP showing a generic diagram and parameter definition.

FIG. 47B is a table showing the definitions of UPP parameters for FIG. 47A.

FIG. 48A is a schematic illustration showing a final regular UPP showing a generic diagram and parameter definition.

FIG. 48B is a table showing the definition of UPP parameters for FIG. 48A.

FIG. 49A is a schematic illustration showing an entry regular UPP showing a generic diagram and parameter definition.

FIG. 49B is a table showing the definition of UPP parameters for FIG. 49A.

FIG. 50A is a schematic illustration showing an intermediate regular UPP showing a generic diagram and parameter definition.

FIG. 50B is a table showing the definition of UPP parameters for FIG. 50A.

FIG. 51A is a schematic illustration showing a regular UPP for generic diagram and parameter definition.

FIG. 51B is a table showing the definitions of UPP parameters for FIG. 51A.

FIG. 52A is a schematic illustration showing regular entry UPP showing generic diagram and parameter definition.

FIG. 52B is a table showing the definition of UPP parameters for FIG. 52A.

FIG. 53A is a schematic illustration showing an intermediate regular UPP showing generic diagram and parameter definition.

FIG. 53B is a table showing the definition of UPP parameters for FIG. 53A.

FIG. 54A is a schematic illustration showing a final regular UPP showing generic diagram and parameter definition.

FIG. 54B is a table showing the definitions of UPP parameters for FIG. 54A.

FIG. 55 is a table showing parameters for entry regular UPP.

FIG. 56 is a table showing parameters for intermediate regular UPP.

FIG. 57 is a table showing parameters for final regular UPP.

FIG. 58 is a table showing parameters for entry inspection regular UPP.

FIG. 59 is a table showing generic list of parameters for different UPP types.

FIG. 60 is a schematic illustration showing the layout of series subsystem EFCPMT.

FIG. 61 is a table showing a list of generic input parameters exported from EFCPMT to a simulation model template.

FIG. 62 is a schematic illustration showing a layout of series subsystem automatically exported to a simulation software package.

FIGS. 63A and 63B are tables showing a simulation results for a series subsystem.

FIGS. 64, 65, 66, and 67 are tables showing the calculation of performic net metrics (availability, performance, quality, OEE, OTE, for a line 1 based simulation run); FIG. 64: availability; FIG. 65: performance; FIG. 66: quality; and, FIG. 67: OEE.

FIG. 68 is a table showing additional information obtained from simulation results.

FIG. 69 is a table showing utilization notes and performance formulas.

FIG. 70 is a schematic illustration of a unit process as the basis for manufacturing system description and productivity measurement.

FIG. 71 is a schematic illustration showing a traditional cost accounting methodology.

FIG. 72 is a graph showing the historical development of activity based costing determined by literature search covering 1969-2001.

FIG. 73 is a schematic illustration showing conventional activity based costing methodology.

FIG. 74 is a schematic illustration showing the basic concept and model of activity based costing.

FIG. 75 is a schematic illustration showing UPPCOS MASC methodology for visibility of producing manufacturing cost.

FIG. 76 is a schematic illustration showing manufacturing flow diagram and methodology for illustrative case study showing UPP, UPP sub-system (UPP-SS) and unit factory (USS).

FIG. 77 is a schematic illustration showing Unit Business Process (UPP) as Basis for Description and Productivity Measurement of Business Operations.

FIG. 78 is a table showing parameter definition for a UPP process shown in FIG. 76.

FIG. 79 is a table showing UPP production data and productivity calculations of 3 part types of UPPs in FIG. 76.

FIG. 80 is a table showing the parameter definitions for UPP sub-system (UPP SS) or unit factory (UF).

FIG. 81 is a table showing the UPP sub-system and unit factory production calculations of 3 parts shown in FIG. 76.

FIG. 82 is a table showing verification that the sum of all second stage cost drivers equals 1 for each direct manufacturing cost category.

FIG. 83 is a table showing direct manufacturing cost (DMC) as the sum of all costs of direct manufacturing costs categories at UPP activity centers.

FIG. 84 is a table showing direct manufacturing costs of products 1, 2 and 3 at UPP-1 through UPP-6 and the unit costs of each product.

FIG. 85 is a table showing the total costs of direct manufacturing activities at UPP activity centers.

FIG. 86 is a table showing the direct manufacturing costs categories for direct manufacturing costs for allocation of UPP activity centers.

FIG. 87 is a table showing indirect cost categories for factory and company overhead.

FIG. 88 is a table showing direct resource cost drivers relating to direct manufacturing costs to UPP activity centers.

FIG. 89 is a table showing indirect resource cost drivers allocating indirect costs to UBP activity centers.

FIG. 90 is a table showing direct manufacturing activities at UPP activity centers.

FIG. 91 is a table showing indirect activities at UBP activity centers.

FIG. 92 is a table showing direct activity cost drivers linking costs to products.

FIG. 93 is a table showing indirect activity cost drivers allocating indirect costs to products.

FIG. 94 is a table showing direct performance measures at 3 levels: UPP, UPP sub-system (UPP SS) and unit factory (UF).

FIG. 95 is a table showing indirect performance measure at company levels.

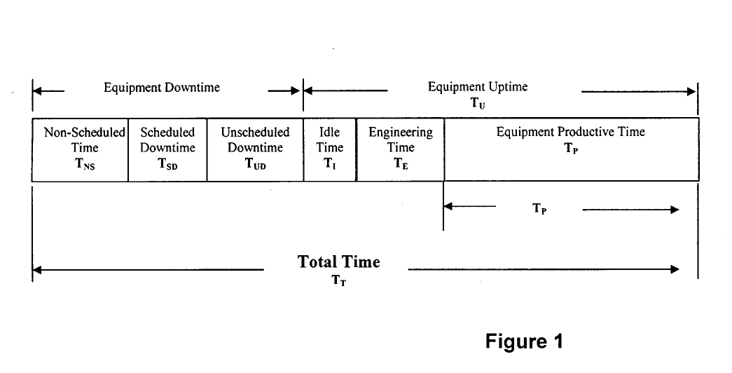

### DETAILED DESCRIPTION OF THE PREFERRED EMBODIMENT

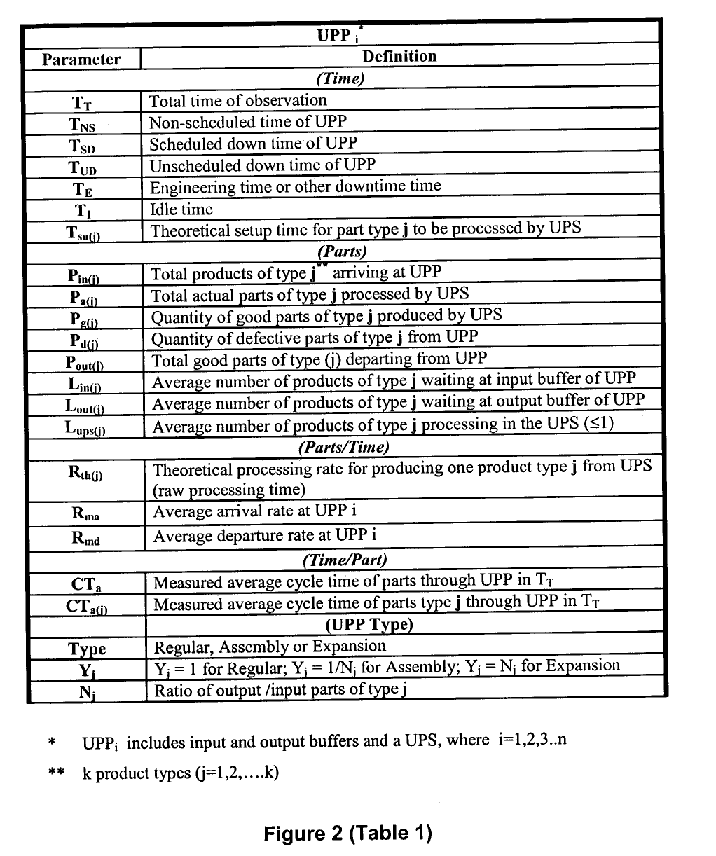

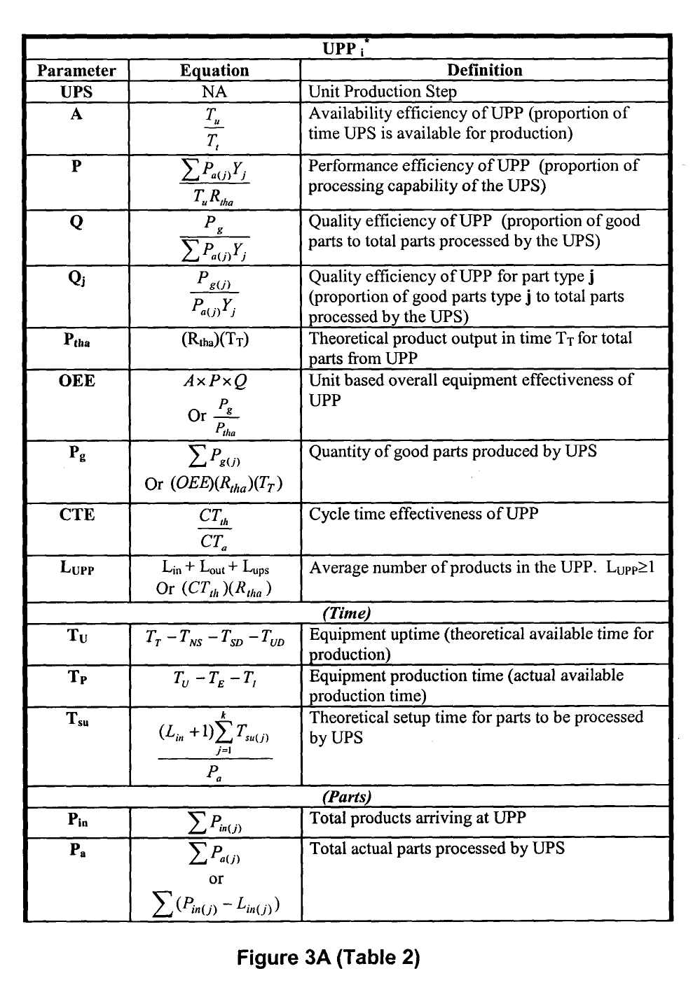

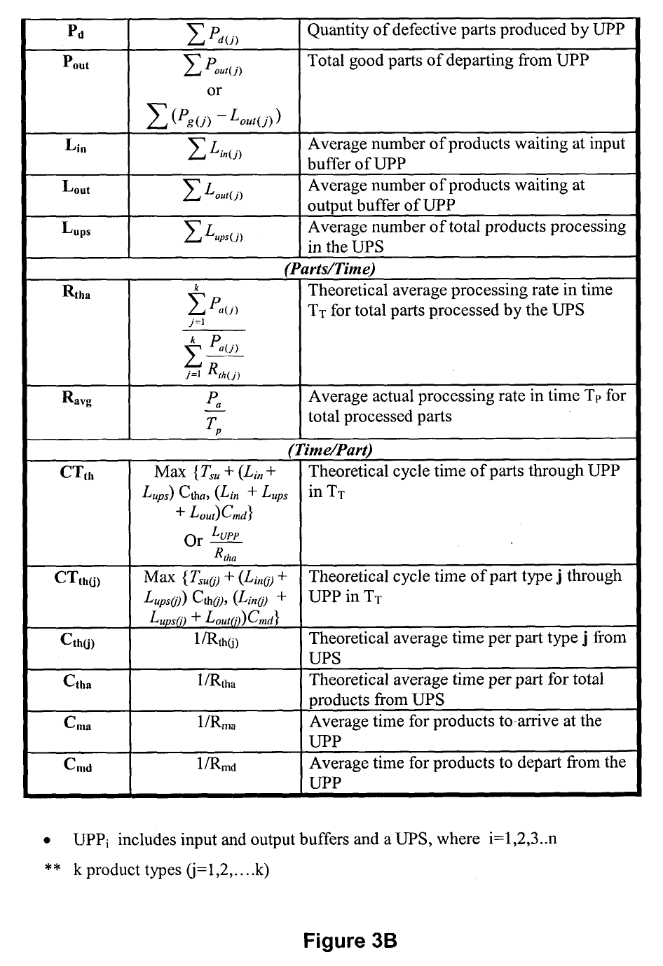

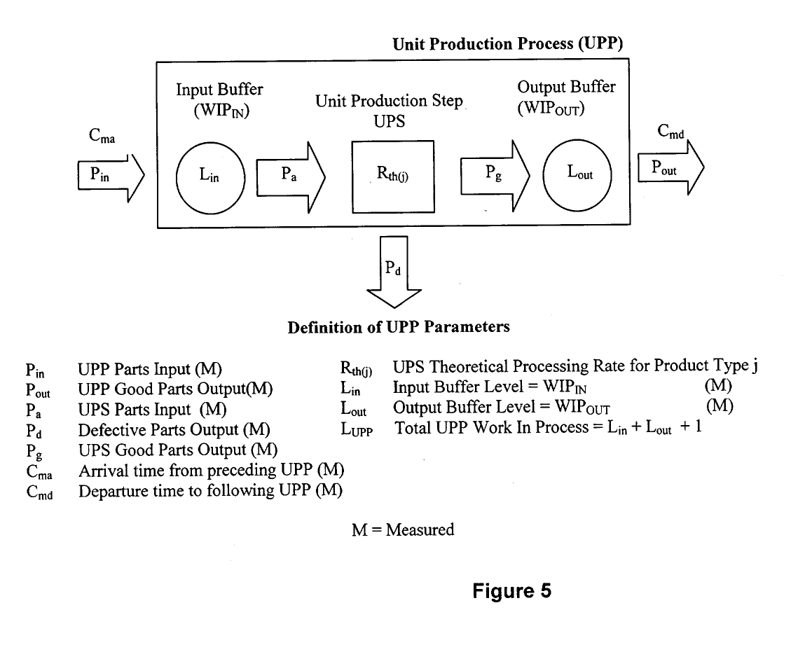

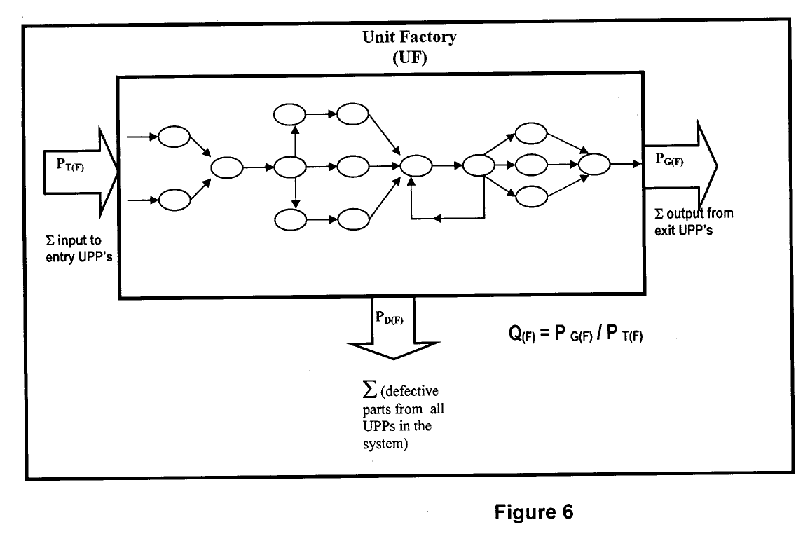

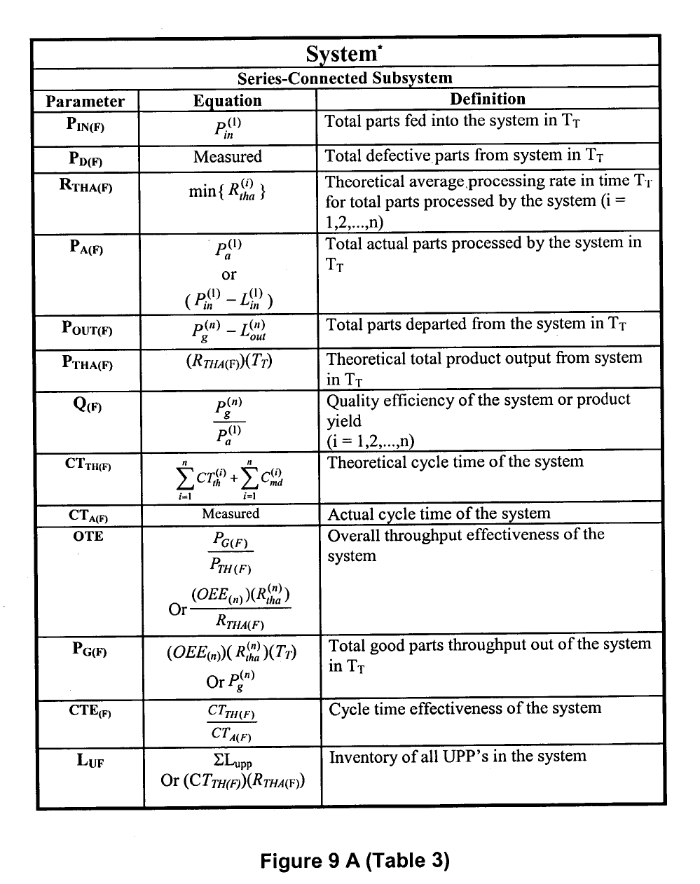

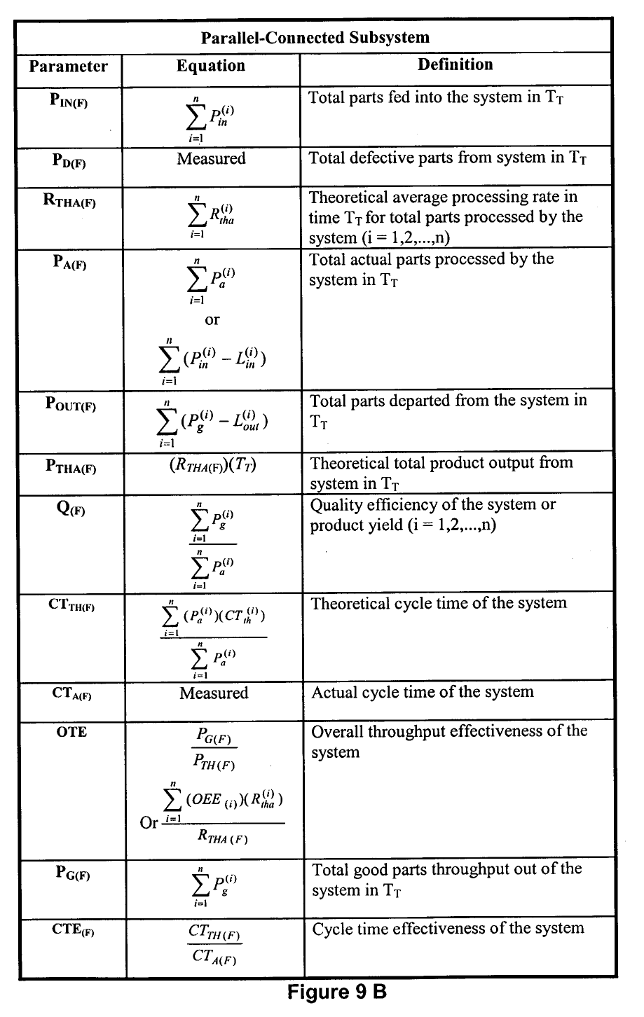

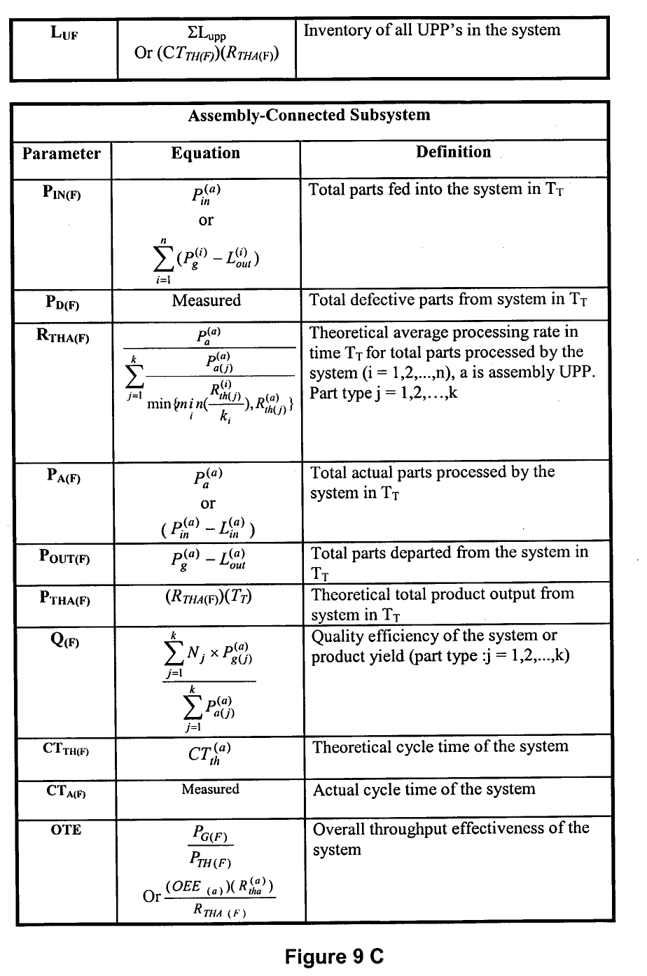

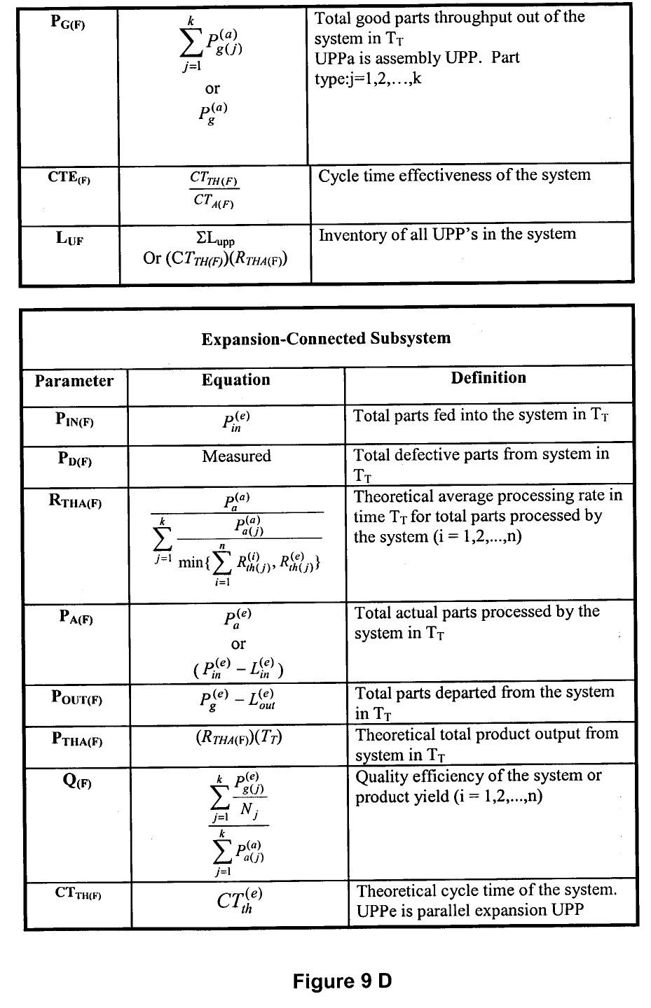

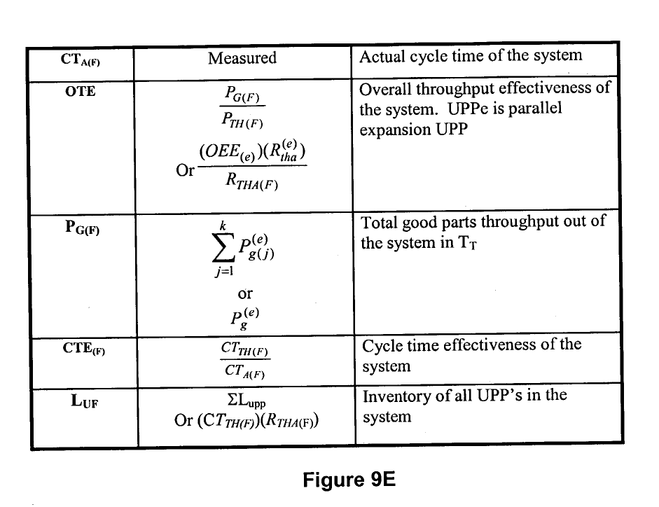

Productivity metrics for manufacturing systems or factories are of fundamental interest for systematic, quantitative determination of the effectiveness of production operations. In this invention, the Unit Production Process (UPP) illustrated schematically in FIG. 5 is the template or building block for quantitative measurement of equipment productivity, analysis of losses and determination of opportunities for performance improvement of individual equipment. In addition, the unit-based OEE metric (Section 9.1 below) together with other parameters and metrics applicable to a UPP (FIGS. 2A-2B and 3, Tables 1-2), are an embodiment for measurement of the productivity of a factory (shown in FIGS. 9A-9E, Table 3), made up of an interconnected array of UPP's and UPP subsystems, (see FIG. 6).

1. Productivity Metrics of a UPP

1.1. Overall Equipment Effectiveness (OEE) of a UPP

The UPP (FIG. 5) used as the basic equipment template for analysis consists of a unit process step (UPS) with input (Lᵢₙ) and output (Lₒᵤₜ) buffers. Based on the defining Equation (1) for OEE and the basic parameter definitions in Tables 1 and 2 (FIGS. 2A-2B and 3), demonstration of how to calculate the OEE for an UPP proceeds as follows. Note that OEE calculated for a UPP is actually based on characteristics of the UPS. Since OEE is independent of the inventory levels, this automatically reflects OEE of the UPP.

Example: Suppose during the observation period of T_{T}, that the total actual product units processed by the UPS is Pₐ. Among the Pₐ, there are k different product types and the quantity of product type j is Pₐ₍ⱼ₎, that is

$${P}_{a} = {\sum }_{j = 1}^{k} {P}_{a ( j )} .$$

The good product output (units) from the UPS is P_{g}. Among the P_{g}, the quantity of good product type j is P_{g(j)}, that is

$${P}_{g} = {\sum }_{j = 1}^{k} {P}_{g ( j )} .$$

If the theoretical processing rate (raw processing rate) of the unit processing step (UPS) for product type j is Rₜₕ₍ⱼ₎, then the theoretical average processing rate in total time T_{T} for the good product output (units) is determined by

$${R}_{thg} = \frac{{\sum }_{j = 1}^{k} {P}_{g ( j )}}{{\sum }_{j = 1}^{k} \frac{{P}_{g ( j )}}{{R}_{th ( j )}}} = \frac{{P}_{g}}{{\sum }_{j = 1}^{k} \frac{{P}_{g ( j )}}{{R}_{th ( j )}}} \qquad ( 2 )$$

Similarly, the theoretical average processing rate in total time T_{T} for actual product output (units) is determined by

$${R}_{tha} = \frac{{\sum }_{j = 1}^{k} {P}_{a ( j )}}{{\sum }_{j = 1}^{k} \frac{{P}_{a ( j )}}{{R}_{th ( j )}}} = \frac{{P}_{a}}{{\sum }_{j = 1}^{k} \frac{{P}_{a ( j )}}{{R}_{th ( j )}}} \qquad ( 3 )$$

Since the UPP might not process at its theoretical speed, thus the average actual processing rate during the time T_{P} for the actual product output is determined by

$${R}_{avg} = \frac{{\sum }_{j = 1}^{k} {P}_{a ( j )}}{{T}_{p}} = \frac{{P}_{a}}{{T}_{p}} . \qquad ( 4 )$$

and the average actual processing rate of UPP during the total time T_{T} for the actual product output is determined by

$${R}_{a} = \frac{{\sum }_{j = 1}^{k} {P}_{a ( j )}}{{T}_{T}} = \frac{{P}_{a}}{{T}_{T}} \qquad ( 4 a )$$

Thus, the availability efficiency of the UPP is calculated by

$${A}_{eff} = \frac{{T}_{u}}{{T}_{t}} , \qquad ( 5 )$$

the performance efficiency of the UPP by

$${P}_{eff} = \frac{{T}_{p}}{{T}_{u}} \times \frac{{R}_{avg}}{{R}_{tha}} , \qquad ( 6 )$$

and the quality efficiency of the UPP by

$${Q}_{eff} = \frac{{P}_{g}}{{P}_{a}} \qquad ( 7 )$$

Using Eqs. (1), (4), (5), (6), and (7), the conventional OEE defined in Equation (1) is further simplified as

$$\begin{matrix}OEE = \frac{{P}_{g}}{{P}_{tha}} \\ = \frac{Good Product Output ( Units )}{Theoretical Actual Product Output ( Units ) in Total Time} .\end{matrix} \qquad ( 8 )$$

where Pₜₕₐ=(Rₜₕₐ)(T_{T}), which is the theoretical actual product output (units) in total time T_{T}. Note, this is the maximum units can be processed by an equipment in total time T_{T}.

By the definition of Equation (8), OEE can be calculated directly from the measured P_{g} and calculated Pₜₕₐ without the use of any other factors. This expression for OEE, which is referred to as unit-based OEE, now has a straightforward interpretation: Unit-based OEE is the good product output (units) produced by the UPP divided by the actual product output (units) which should have been produced according to the theoretical processing rate in total time observed. Note that this expression for unit-based OEE in Equation (8) mathematically equals the conventional OEE defined in Equation (1). Further discussion of the rationale for using unit based OEE rather than time based OEE as the formulation from both equipment level and system level productivity metrics is provided below.

1.2. Good Product Output (P_{g}) of a UPP

Rewriting Eqs. (8) leads to another useful expression for P_{g}, which is

P_{g}=(OEE)(R_{Tha})(T_{T})=(Overall Equipment Effectiveness)(Theoretical Average Processing Rate)(Total Time) (10)

By this definition, P_{g} is determined by unit-based OEE (or conventional OEE), theoretical average processing rate for actual product output (units) Rₜₕₐ, and total time T_{T}.

1.3. Cycle Time Efficiency (CTE) of a UPP

The cycle time of an UPP is defined as the elapsed time between arrival of a product at the UPP and the departure of the product from the UPP. The cycle time effectiveness (CTE) of the UPP is be defined as follows:

$$CTE = \frac{{CT}_{th}}{{CT}_{a}} = \frac{Theoretical Cycle Time}{Actual Cycle Time} , \qquad ( 11 )$$

where, CTa=the actual cycle time of UPP in total time T_{T}.

If the average number of products waiting in input buffer and output buffer during the total time T_{T} is measured, then the formula to calculate the theoretical cycle time (per part) of the UPP in total time T_{T} is written as

CTₜₕ=Max {Tₛᵤ+(Lᵢₙ+Lᵤₚₛ) Cₜₕₐ, (Lᵢₙ+Lᵤₚₛ+Lₒᵤₜ) C_{md}}, (12)

where

Lᵢₙ=average number of products waiting in input buffer;

Lₒᵤₜ=average number of products waiting in output buffer;

Lᵤₚₛ=average number of products in the UPS (FIG. 5)

$$\begin{matrix}{C}_{tha} = \frac{1}{{R}_{tha}} \\ = \text{theoretical average processing time for actual product units;}\end{matrix}$$

theoretical average processing time for actual product units;

C_{md}=theoretical average time for product to depart from UPP; and

Tₛᵤ=theoretical total setup time for products waiting for processing in UPP.

Assume the steady state has been reached during the total time T_{T} and there is no setup time required, that is Tₛᵤ=0, then the following condition must be satisfied

Cₜₕₐ=C_{md}=Cₘₐ,

where

Cₘₐ=average time for product to arrive at the UPP.

Thus, Eq. (12) is rewritten as

$${CT}_{th} = \frac{{L}_{UPP}}{{R}_{tha}} \qquad ( 13 )$$

where

L_{UPP}=Lᵢₙ+Lᵤₚₛ+Lₒᵤₜ=average number of products in the UPP.

Note that Eq. (13) is an expression of famous Little's Queuing Formula, which equates the average number of products in UPP to the product of cycle time of the UPP and average processing rate of UPP. The theoretical cycle time (per part) of the UPP in total time T_{T} is also determined by Equation (13).

To demonstrate how to calculate the CTE for an UPP, suppose during the observation period of T_{T}, the total actual product units processed by the UPP is Pₐ, among Pₐ, there are k different product types and the quantity of product type is Pₐ₍ⱼ₎ that is

$${P}_{a} = {\sum }_{j = 1}^{k} {P}_{a ( j )} ,$$

, and the product units depart from the UPP is Pₒᵤₜ. Assume there is only one setup for each product type, if the theoretical setup time for product type j is Tₛᵤ₍ⱼ₎, then the theoretical total setup time for products waiting for processing in the UPP can be determined by

$${T}_{su} = \frac{{L}_{i n} {\sum }_{j = 1}^{k} {T}_{su ( j )}}{{P}_{a}} \qquad ( 14 )$$

Without loss of generality, Lᵢₙ can be calculated as follows, assuming during the observed time period, the number of products in the input buffer changes Nᵢₙ times. The changes occur at time t₁, t₂, . . . t_{N}_{ᵢₙ}. Let Δt₍ᵢ₎=tᵢ−tᵢ₋₁, where i=1, 2, . . . , Nᵢₙ+1, t₀=0 and t_{(N}_{ᵢₙ}₊₁₎=Tₜ are the start and the end of the observed time period, respectively. Let Lᵢₙⁱ denote the number of products in the input buffer from time tᵢ₋₁ to tᵢ. The average number of products waiting in the input buffer is determined by

$${L}_{i n} = \frac{{\sum }_{i = 1}^{{N}_{i n} + 1} {L}_{i n}^{i} Δ {t}_{( i )}}{{T}_{t}} \qquad ( 15 A )$$

Similarly, the average number of products waiting in the output buffer is determined by

$${L}_{out} = \frac{{\sum }_{i = 1}^{{N}_{out} + 1} {L}_{out}^{i} Δ {t}_{( i )}}{{T}_{t}} \qquad ( 15 B )$$

The average number of product processed at UPS, L_{UPS} is calculated as follows, assuming during the observed time period, the states of UPS are operational and idle and the states of UPS changes N_{UPS} times. The changes occur at time t₁, t₂, . . . t_{N}_{_{UPS}}. Let Δt₍ᵢ₎=tᵢ−t_{i-1,} where i=1, 2, . . . , N_{UPS}+1, t₀=0 and t_{(N}_{_{UPS}}₊₁₎=T_{T} are the start and the end of the observed time period, respectively. Thus

$${L}_{UPS} = \frac{{\sum }_{i = 1}^{{N}_{UPS} + 1} {L}_{UPS}^{i} Δ {t}_{( i )}}{{T}_{T}} \qquad ( 15 C )$$

where

$${L}_{UPS}^{i} = \{ \begin{matrix}1 & if UPS is operational from {t}_{i - 1} to {t}_{i} \\ 0 & if UPS is idle from {t}_{i - 1} to {t}_{i}\end{matrix}$$

The theoretical average time for product to depart from UPP, C_{md}, is determined by the layout and number of material handling devices/operators serving the UPP. The actual cycle time of the UPP in total time T_{T} can be calculated by

$${CT}_{a} = \frac{{\sum }_{j = 1}^{{P}_{out}} {CT}_{a ( j )}}{{P}_{out}} \qquad ( 16 )$$

where

CTₐ₍ⱼ₎ is the measured actual cycle time of product j (jεPₒᵤₜ) in time T_{T}.

1.4. Inventory Level (L_{UPP}) of a UPP

According to Little's Law or Equation (13), average inventory level for equipment (UPP) is defined as the product of the cycle time of the UPP and average processing rate of the UPP,

L_{UPP}=(CTₜₕ)(Rₜₕₐ)=(Cycle Time)(Theoretical Average Processing Rate) (17)

2. Productivity Metrics for a Production System or Unit Factory (UF)

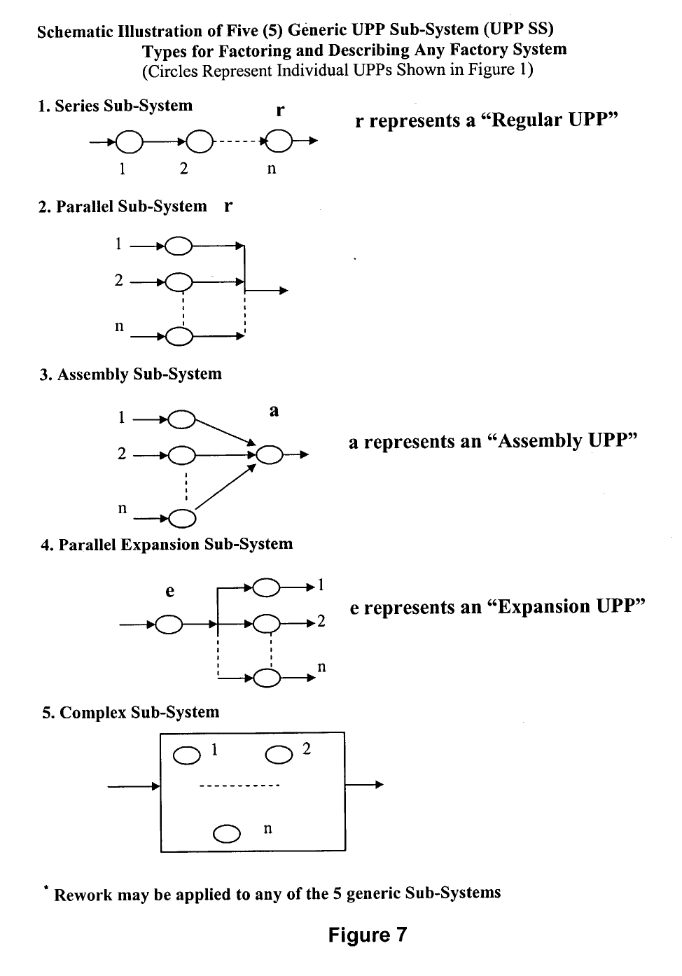

Productivity metrics for a Unit Factory (UF) are fundamentally important for determining the effectiveness of factory operation, based on the performance of each UPP and the overall layout or architecture of arrangement of the UPP's and their interconnections in the factory. Although Scott [30-31] proposed using a weighted average of ten metrics or criteria for Overall Factory Effectiveness (OFE), according to method of this invention for the analysis of system level productivity the following criteria and four basic metrics (throughput effectiveness, cycle time effectiveness, inventory, and throughput for a time T_{T}) are applied. The first criterion is to establish a unique layout or architecture for arranging all the UPP's in the production system. The second criterion is to calculate OEE and other parameters of the individual UPP's. The third is to calculate Overall Throughput Effectiveness (OTE_{F}) of the UPP subsystems and then the system. The fourth is to calculate the Good Product Output (P_{G(F)}) of the UPP subsystem and then the system. The fifth is to calculate Cycle Time Efficiency (CTE_{F}) of the UPP subsystems and then the system. The sixth is to calculate the Factory Level Inventory (L_{F}) of the UPP subsystems and then the system. For any system, the OEE of the individual UPP's is calculated as described in Section 1. Likewise, the system layout or architecture is determined by factoring the overall production system into unique combinations of UPP sub-systems shown in FIG. 7. In this section, algorithms for the OTEF P_{G(F)}), CTE_{F}, and L_{F} metrics are defined and derived.

2.1. Overall Throughput Effectiveness (OTE_{F}) of a Production System or Unit Factory (UF)

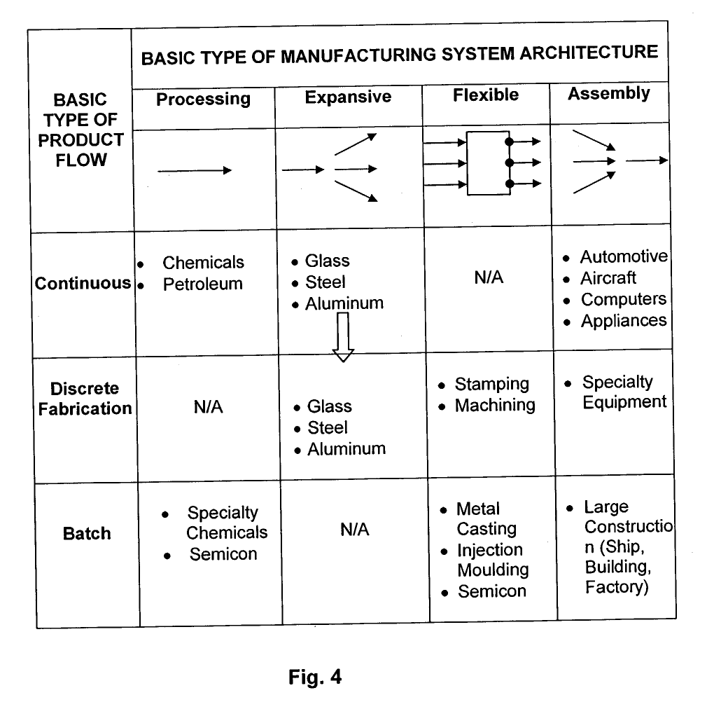

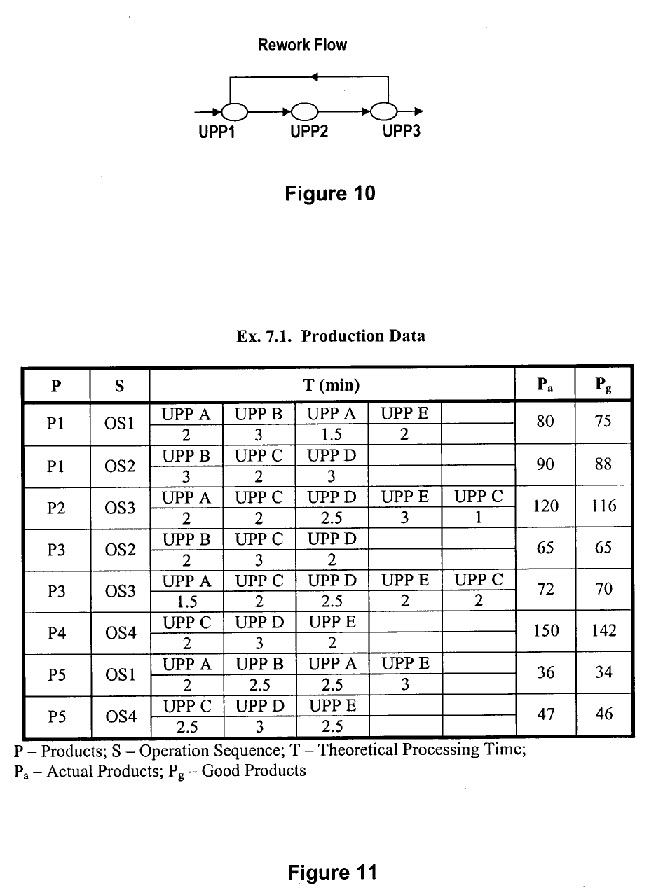

According to the analysis of Burbidge [27-29], a production system (or factory) is usually made up of one principal type of manufacturing architecture, but also includes other basic architectural types in the overall manufacturing operations, depending on industry type and which manufacturing stages are considered. The principal architecture typically reflects one of the common types of manufacturing system integration, designated in FIG. 4 as “processing”, “expansive”, “flexible”, and “assembly” configurations of individual unit production processes or UPP's. In one aspect of the present invention, all manufacturing systems are factored into five major “types” of unique UPP combinations or sub-systems, schematically defined in FIG. 7 as “series”, “parallel”, “assembly”, “expansion” (or dis-assembly) and “complex”, with the provision that “rework” can be applied as a modification of each of the basic subsystems, as illustrated in FIG. 10.

The overall throughput effectiveness, OTE, of each of these UPP sub-systems is uniquely calculated, and the system level overall throughput effectiveness, OTE_{F}, is calculated in a similar manner by combining the OTE of the individual UPP sub-systems making up the system.

As a basis, therefore, for overall production system analysis, expressions for the OTE of the five major UPP sub-systems are derived, based on the OEE and other parameters of each individual UPP in the sub-system, and then the OTE of the various sub-systems are combined to obtain the OTE_{F} of the overall factory.

Example: Suppose during the observation period of T_{T}, the OEE, for each individual UPP is determined by

OEE₍ᵢ₎=(A_{eff(i)})(P_{eff(i))})(Q_{eff(i)})

$$\begin{matrix}{OEE}_{( i )} = ( {A}_{eff ( i )} ) ( {P}_{eff ( i )} ) ( {Q}_{eff ( i )} ) & & & & \\ = \frac{{P}_{g}^{( i )}}{{P}_{tha}^{( i )}} & & & & i = 1 , … , n\end{matrix} \qquad ( 18 )$$

i=1, . . . , n (18)

where,

P_{g}⁽ⁱ⁾=the good product output (units) of UPP i.

By extending the definition and expression in Equation (8) for the unit-based OEE of a UPP to the manufacturing system (factory) level, manufacturing system (factory) level OTE (OTE_{F}) during the period of T_{T} is defined as

$$\begin{matrix}OTE = \frac{{P}_{G ( F )}}{{P}_{TH ( F )}} \\ = \frac{\text{Good Product Output (Units) from System (Factory)}}{\begin{matrix}\text{Theoretical Actual Product Output (Units) from} \\ \text{System (Factory) in Total Time}\end{matrix}}\end{matrix} \qquad ( 19 )$$

(19)

or,

OTE_{CMS}=A_{(CMS)}·P_{(CMS)}·Q_{(CMS)}

where

P_{THA(F)}=(R_{THA(F)})(T_{T}), is the theoretical actual product output from system in total time T_{T}. (20)

2.2. Good Product Output (P_{G(F)}) of a Production System or Unit Factory (UF)

Example: Suppose during the observation period of T_{T}, P_{g} for each individual UPP is determined by

P_{g}⁽ⁱ⁾=(OEE₍ᵢ₎)(Rₜₕₐ⁽ⁱ⁾)(T_{T}) i=1, . . . , n (21)

By using the same approach as in Section 2.1, the good product output (units) of a manufacturing system (factory) during the period of T_{T}, P_{g(F)}, is defined as

$$\begin{matrix}{P}_{G ( F )} = ( {OTE}_{F} ) ( {R}_{THA ( F )} ) ( {T}_{T} ) \\ = \text{(Overall Throughput Effectiveness)(Theoretical Average} \\ \text{Processing Rate of System (Factory))(Total Time)}\end{matrix} \qquad ( 22 )$$

Processing Rate of System (Factory)) (Total Time)

Note also that OEE₍ᵢ₎ and P_{g(i)} are all random variables. The reason is that for different observation period of T_{T} or even the same length of observation period starting at different time t, in most situations, the measured values of OEE₍ᵢ₎ and P_{g(j)} will be different because of the randomness of UPP availability. Therefore, the values of OEE₍ᵢ₎ and P_{g(i)} are not known with certainty before they are measured during the observation period of T_{T}. To be meaningful and useful, the measured values of OEE₍ᵢ₎ and P_{g(i)} must be associated with time. However, if during the observation period of T_{T}, UPPᵢ can reach steady state, then by using some statistical approaches, the expected values of OEE₍ᵢ₎ and P_{g(i)} can be determined. In addition, note also the importance of the relationship between factory architecture and the productivity metrics at the factory level.

2.3. Cycle Time Effectiveness of a Production System or Unit Factory (UF)

Example: Suppose during the observation period of T_{T}, the cycle time effectiveness, for each individual UPP is determined by

$$\begin{matrix}{CTE}_{( i )} = \frac{{CT}_{th}^{( i )}}{{CT}_{a}^{( i )}} & & & & & i = 1 , … , n\end{matrix} \qquad ( 23 )$$

i=1, . . . , n (23)

By using the same approach as in Section 3.1, the cycle time effectiveness for a manufacturing system (factory) is generically defined as

$$\begin{matrix}{CTE}_{F} = \frac{{CT}_{TH ( F )}}{{CT}_{A ( F )}} \\ = \frac{\text{Theoretical Cycle Time of System (Factory)}}{\text{Actual Cycle Time of System (Factory)}}\end{matrix} \qquad ( 24 )$$

Calculation of CTE_{F} for a specific factory requires the prior determination of the architectural arrangement of the UPP's making up the factory, the factoring of the overall arrangement into UPP sub-systems as illustrated in FIG. 7, and the calculation of CTE for these sub-systems based on the theoretical and actual cycle times.

2.4. Inventory Level (L_{F}) of a Production System or Unit Factory (UF)

Example: Suppose during the observation period of T_{T}, the average inventory level, for each individual UPP is determined by

L_{UPP}⁽ⁱ⁾=(CTₜₕ⁽ⁱ⁾)(Rₜₕₐ⁽ⁱ⁾) i=1, . . . , n (25)

By using the same approach as in Section 3.1, the manufacturing system (factory) level during the period of T_{T} is defined as

L_{F}=(CT_{TH(F)})(R_{THA(F)}) (26)

=(Cycle Time of System (Factory))(Theoretical Average Processing Rate)

3. Productivity Metrics for a Series-Connected UPP Sub-System

A series sub-system consisting of n individual UPPs is illustrated in FIG. 7. Based on the theory of conservation of material flow, during the observation period of T_{T}, the good product output (units) of UPP n must equal to that of the series process. That is

P_{G(F)}=P_{g}⁽ⁿ⁾ (27)

where,

P_{g}⁽ⁿ⁾=the good product output (units) of UPP n.

Therefore,

P_{G(F})=(OEE₍ₙ₎)(Rₜₕₐ⁽ⁿ⁾)(T_{T}) (28)

Defining

$${Q}_{( F )} = \frac{{P}_{g}^{( n )}}{{P}_{a}^{( 1 )}} \qquad ( 29 )$$

In a series sub-system, production is dominated by the slowest UPP in the sub-system. Therefore, the theoretical average processing rate of a series sub-system in total time T_{T} for actual product output (units) is determined by

R_{THA(F)}=min{Rₜₕₐ⁽ⁱ⁾}i=1, . . . ,n (30)

Using Eqs. (18), (22), (27), (28), and (30), the OTE for the sub-system is derived as

$$\begin{matrix}OTE = \frac{{P}_{G ( F )}}{{P}_{TH ( F )}} = \frac{{P}_{G ( F )}}{( {R}_{THA ( F )} ) ( {T}_{T} )} \\ = \frac{( {OEE}_{( n )} ) ( {R}_{tha}^{( n )} )}{{R}_{THA ( F )}} \\ = \frac{( {A}_{eff ( n )} ) ( {P}_{eff ( n )} ) ( {Q}_{eff ( n )} ) ( {R}_{tha}^{( n )} )}{{min}_{i} \{ {R}_{tha}^{( i )} \}}\end{matrix} \qquad ( 31 )$$

Note that the theoretical average processing rate of a series sub-system for actual product output (units) R_{THA(F)} depends on the number of product types, the theoretical processing rates of each UPP for different part types, and the observation time T_{T}.

The theoretical cycle time for a series connected UPP sub-system is therefore determined by

$${CT}_{TH ( F )} = {\sum }_{i = 1}^{n} {CT}_{th}^{( i )} + {\sum }_{i = 1}^{n} {C}_{md}^{( i )} \qquad ( 32 )$$

where Cₜₕ⁽ⁱ⁾ is described in Equation (12) and (13),

C_{md(i)}=theoretical average time for product to depart from UPP⁽ⁱ⁾ to UPP^{(iti)}.

Hence, the cycle time effectiveness (CTE) of the series connected sub-system is calculated from Equation (24), where CT_{A(F)} is calculated using Equation (16). Similarly, the inventory level (L_{F}) of the series-connected subsystem is calculated from Equation (26)

4. Productivity Metrics for a Parallel-Connected UPP Sub-System

A parallel UPP sub-system consisting of n individual UPP's is illustrated in FIG. 5. Based on the theory of conservation of material flow, during the observation period of T_{T}, the good product output (units) of all UPPs must equal to that of the parallel sub-system, and the actual product output (units) of all UPPs must equal to that of the parallel sub-system. That is

$${P}_{G ( F )} = {\sum }_{i = 1}^{n} {P}_{g}^{( i )} \qquad ( 33 )$$

where,

P_{g}⁽ⁱ⁾=the good product output (units) of UPP i.

Therefore,

$${P}_{G ( F )} = {\sum }_{i = 1}^{n} ( {OEE}_{( i )} ) ( {R}_{tha}^{( i )} ) ( {T}_{T} ) \qquad ( 34 )$$

Defining

$${Q}_{( F )} = \frac{{\sum }_{i = 1}^{n} {P}_{g}^{( i )}}{{\sum }_{i = 1}^{n} {P}_{a}^{( i )}} \qquad ( 35 )$$

In a parallel UPP sub-system, the production rate is the summation of the production rate of each UPP in the sub-system. Thus,

$${R}_{THA ( F )} = {\sum }_{i = 1}^{n} {R}_{tha}^{( i )} \qquad ( 36 )$$

Using Eqs. (18), (22), (33), (34), and (36), the OTE for the parallel sub-system is derived as

$$\begin{matrix}OTE = \frac{{P}_{G ( F )}}{{P}_{TH ( F )}} = \frac{{\sum }_{i = 1}^{n} ( {OEE}_{( i )} ) ( {R}_{tha}^{( i )} )}{{R}_{THA ( F )}} \\ = \frac{{\sum }_{i = 1}^{n} ( {A}_{eff ( i )} ) ( {P}_{eff ( i )} ) ( {Q}_{eff ( i )} ) ( {R}_{tha}^{( i )} ) \}}{{\sum }_{i = 1}^{n} {R}_{tha}^{( i )}}\end{matrix} \qquad ( 37 )$$

Note that OTE and P_{G(F)} are all random variables.

The theoretical cycle time for parallel sub-system is therefore determined by

$${CT}_{TH ( F )} = \frac{{\sum }_{i = 1}^{n} ( {P}_{a}^{( i )} ) ( {CT}_{th}^{( i )} )}{{\sum }_{i = 1}^{n} {P}_{a}^{( i )}} \qquad ( 38 )$$

where Cₜₕ⁽ⁱ⁾ is described in Equation (12) and (13).

Hence, cycle time effectiveness (CTE) of the parallel connected sub-system is calculated from Equation (24), where CT_{A(F)} is calculated using Equation (16). Similarly, the inventory level (L_{F}) of the parallel-connected subsystem can be calculated from Equation (26).

5. Productivity Metrics for an Assembly-Connected UPP Sub-System

An assembly UPP sub-system consisting of an assembly UPP (UPPₐ) and an individual upstream UPP's is illustrated in FIG. 7. Based on the theory of conservation of material flow, during the observation period of T_{T}, the good product output (units) of UPPₐ must equal to that of the assembly sub-system. That is

P_{G(F)}=P_{g}^{(a)}. (39)

Defining

$${Q}_{( F )} = \frac{{P}_{g}^{( a )}}{{P}_{a}^{( a )}} \times N = {Q}_{eff ( a )} \qquad ( 40 )$$

where,

$$N = {\sum }_{i = 1}^{n} {k}_{i} , {k}_{i} \neq 0 ;$$

kᵢ=the number of part(s) required from UPPᵢ to make a final product from UPPₐ.

Therefore,

OEE₍ₐ₎=(A_{eff(a)})(P_{eff(a)})(Q_{eff(a)}) (41)

P_{G(F)}=(OEE₍ₐ₎)(Rₜₕₐ^{(a)})(T_{T}) (42)

In an assembly UPP sub-system, production is dominated by the slowest UPP in the sub-system. Thus,

$${R}_{THA ( F )} = min \{ {min}_{i} ( \frac{{R}_{tha}^{( i )}}{{k}_{i}} ) , {R}_{tha}^{( a )} \} \qquad ( 43 )$$

Using Eqs. (18), (22), (39), (42), and (43), the OTE for the assembly sub-system is derived as

$$\begin{matrix}OTE = \frac{{P}_{G ( F )}}{{P}_{TH ( F )}} = \frac{{P}_{G ( F )}}{( {R}_{THA ( F )} ) ( {T}_{T} )} \\ = \frac{( {OEE}_{( a )} ) ( {R}_{tha}^{( a )} )}{{R}_{THA ( F )}}\end{matrix} \qquad ( 44 )$$

The theoretical cycle time for assembly sub-system is therefore determined by

CT_{TH(F)}=CTₜₕ^{(a)} (45)

where Cₜₕ⁽ⁱ⁾ is described in Equation (12) and (13).

Hence, the cycle time efficiency (CTE) of the assembly connected sub-system can be calculated from Equation (45), where CT_{A(F)} is calculated using Equation (26).

6. Productivity Metrics for an Expansion-Connected UPP Sub-System

An Expansion UPP sub-system consisting of an expansive UPP (UPPₑ) and n individual downstream UPP's is illustrated in FIG. 5. Based on the theory of conservation of material flow, during the observation period of T_{T}, the good product output (units) of all UPPs must equal to that of the expansive sub-system. That is

P_{G(F)}=P_{g}^{(e)}. (46)

Defining

$${Q}_{( F )} = \frac{{P}_{g}^{( e )}}{( {P}_{a}^{( e )} ) ( N )} = {Q}_{eff ( e )} \qquad ( 47 )$$

where,

$$N = {\sum }_{i = 1}^{n} {k}_{i}$$

kᵢ=the number of part(s) produced by a part from UPPₑ, which will be sent to UPPᵢ.

Therefore,

OEE₍ₑ₎=(A_{eff(e)})(P_{eff(e)})(Q_{eff(e)}) (48)

P_{G(F)}=(OEE₍ₑ₎)(Rₜₕ^{(e)})(T_{T}) (49)

In an expansive UPP sub-system, production is dominated by the slowest UPP in the sub-system. Thus,

$${R}_{THA ( F )} = min \{ {\sum }_{i = 1}^{n} {R}_{tha}^{( i )} , {R}_{tha}^{( e )} \} \qquad ( 50 )$$

Using Eqs. (18), (22), (46), (49), and (50), the OTE for the parallel expensive sub-system is derived as

$$\begin{matrix}OTE = \frac{{P}_{G ( F )}}{{P}_{TH ( F )}} = \frac{{P}_{G ( F )}}{( {R}_{THA ( F )} ) ( {T}_{T} )} \\ = \frac{( {OEE}_{( e )} ) ( {R}_{tha}^{( e )} )}{{R}_{THA ( F )}}\end{matrix} \qquad ( 51 )$$

The theoretical cycle time for parallel expensive sub-system is therefore determined by

CT_{TH(F)}=CTₜₕ^{(e)} (52)

Hence, the cycle time effectiveness (CTE) of the expansive connected sub-system can be calculated from Equation (24), where CT_{A(F)} is calculated using Equation (16). Similarly, the inventory level (L_{F}) of the expansive connected sub-system is calculated from Equation (26).

7. Productivity Metrics for a Complex UPP Sub-System

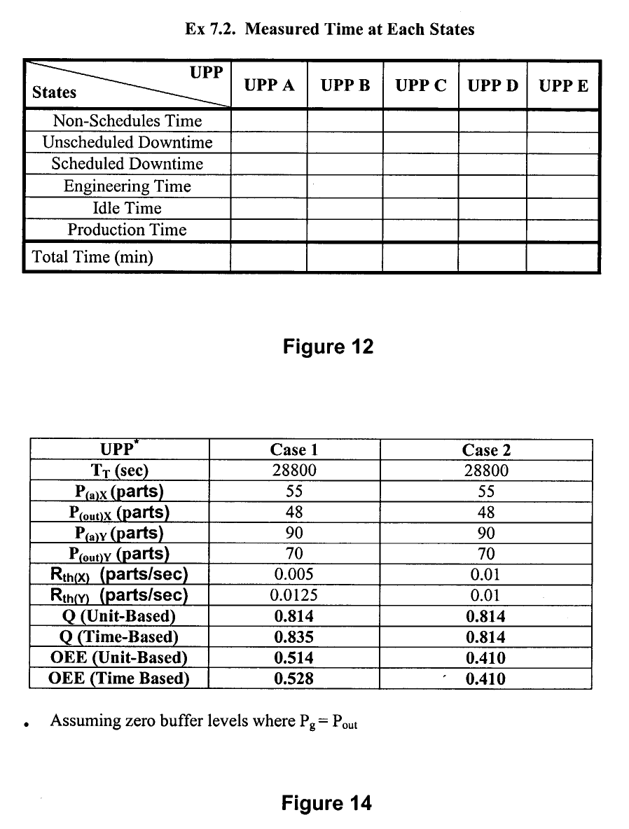

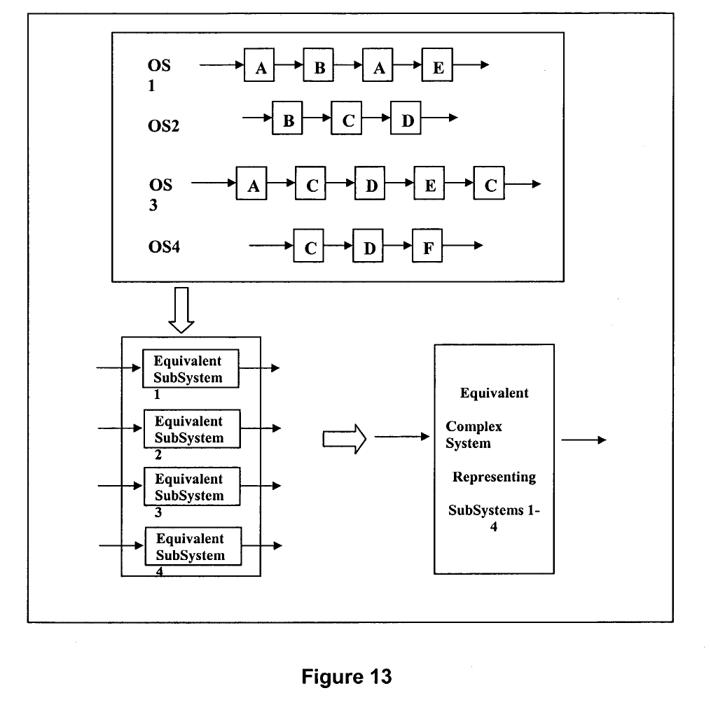

The complex manufacturing system as shown in FIG. 7 is a flexible manufacturing cell, which is called cluster tool in semiconductor industry. It consists of 5 UPPs, which are named A, B, C, D, and E respectively. During the observation period T_{T}, a batch of five different types of products, P1, P2, P3, P4, and P5 is processed. There are four operation sequences used for processing the five different products: OS1=(A, B, A, E), OS2=(B, C, D), OS3=(A, C, D, E, C), and OS4=(C, D, E). For operation sequence 1, OS1, a product goes first to UPP A, then to UPP B, then goes back to UPP A for rework or second processing, then to UPP E, and finally exits the system. FIG. 11, Example 7.1 lists the products, operation sequences, theoretical processing times of a product at different UPPs, and the quantity of actual and good products being processing at four operation sequences. FIG. 12, Example 7.2 shows the measures times of UPPs at each of the six equipment states. According to the operation sequences and the data in Example 7.1 and Example 7.2 (FIGS. 11 and 12), the productivity metrics of the complex manufacturing system during the observation period T_{T} may be calculated by modeling the complex manufacturing system using the principle types of sub-systems as shown in FIG. 13.

In one aspect, the approach to transform and measure productivity metrics of the complex manufacturing system is summarized by the following steps:

1) Decompose the complex manufacturing system or factory into a number of the basic UPP combinations based on the UPPs in the system/factory, operation sequences, and system/factory layout.

2) Transform each of the basic UPP combinations identified in Step 1 above into an equivalent sub-system based on the method described above and calculate the productivity metrics.

3) Further transform the set of equivalent sub-systems into an equivalent system, which represents the complex system or factory, in similar manner as Step 2 above.

8. Productivity Metrics for a Series UPP Sub-System With Rework

Rework can be found in most manufacturing systems. There are several different rework scenarios. For example, every UPP in series-connected sub-system, parallel-connected sub-system, assembly-connected sub-system, and parallel expensive-connected sub-system might produce defective products, and processing defective products generated by itself or from other UPPs in the sub-systems. To demonstrate how to calculate the OTE and CTES for a rework-connected UPP sub-system, a series-connected sub-system with rework generated by the third UPP and routed to first UPP to reprocess is employed and shown in FIG. 7. Based on the theory of conservation of material flow, during the observation period of T_{T}, the good product output (units) of UPP 3 must equal to that of the rework process. That is

P_{G(F)}=P_{g}⁽³⁾. (53)

Therefore,

P_{G(F)}=(OEE₍₃₎)(Rₜₕₐ⁽³⁾)(T_{T}) (54)

Assumed that after rework, the yield of reprocessed defective parts at each UPP is 100%, the quality efficiency of each UPP is determined by

$$\begin{matrix}{Q}_{eff ( i )} = \frac{{P}_{g}^{( i )}}{{P}_{a}^{( i )}} = \frac{{P}_{g}^{′ ( i )} + {P}_{d}^{( 3 )}}{{P}_{a}^{′ ( i )} + {P}_{d}^{( 3 )}} , & & & i = 1 , 2 , 3\end{matrix} \qquad ( 55 )$$

where,

P′_{g}⁽ⁱ⁾=the good product output (units) of UPP i from the actual good product units processed by UPP i;

P′ₐ⁽ⁱ⁾=the actual good product units processed by UPP i, and

P_{d}⁽³⁾=the defective product units produced by UPP 3, which are routed to UPP1 for rework.

In a series sub-system with rework, production is dominated by the slowest UPP in the sub-system. Therefore the theoretical average processing rate of a series sub-system with rework in total time T_{T} for actual product output (units) is determined by

R_{THA(F)}=min{Rₜₕₐ⁽ⁱ⁾}i=1, . . . ,3 (56)

Using Eqs. (18), (22), (53), (54), and (56), the OTE for the sub-system is derived as

$$\begin{matrix}OTE = \frac{{P}_{G ( F )}}{{P}_{TH ( F )}} = \frac{{P}_{G ( F )}}{( {R}_{THA ( F )} ) ( {T}_{T} )} \\ = \frac{( {OEE}_{( 3 )} ) ( {R}_{tha}^{( 3 )} )}{{R}_{THA ( F )}} \\ = \frac{( {A}_{eff ( 3 )} ) ( {P}_{eff ( 3 )} ) ( {Q}_{eff ( 3 )} ) ( {R}_{tha}^{( 3 )} )}{{min}_{i} \{ {R}_{tha}^{( i )} \}}\end{matrix} \qquad ( 57 )$$

Note that during the observation time T_{T}, the expression of OTE formula for a series sub-system with rework is exact the same as that of a series sub-system except for the different definition of quality efficiency, which includes rework. This conclusion is applicable to the other rework scenarios.

The theoretical cycle time for the series sub-system with rework is applicable therefore determined by the same equation for series sub-system, that is, Eq. (32). Similarly, the inventory level (L_{F}) of the parallel expensive connected sub-system is calculated from Equation (26).

9. Unit-Based OEE as the Foundation For Productivity Metrics

Note that if the average theoretical processing rate for actual product output (units), Rₜₕₐ is equal to R_{thg}, the average theoretical processing rate for good product output (units), then OEE is expressed as:

$$OEE = \frac{{T}_{g}}{{T}_{T}} = \frac{Theoretical Production Time for Good Product Output}{Total Time} , \qquad ( 9 )$$

where,

$$\begin{matrix}{T}_{g} = \frac{{P}_{g}}{{R}_{thg}} \\ = \frac{Good Product Output}{Average Theoretical Processing Rate for Good Product Output}\end{matrix}$$

The time-based OEE defined in Equation (9) is the metric developed by Leachman [13]. This interpretation of OEE differs from the unit-based definition given in Equation 8. As the names indicate, the difference between unit-based and time-based OEE lies in the emphasis on mass-balanced product throughput (unit-based) or on time utilization (time-based).

To illustrate this, the three factors composing OEE are examined: Availability, Performance and Quality. Availability and Performance efficiency (Equations 5 and 6) are the same for both unit-based and time-based definitions. Quality, however, is defined differently. Unit-based Quality efficiency does not differentiate between different part types. As shown in Equation (7) it is simply the ratio of total good parts produced to total parts produced:

$$Q = \frac{{\sum }_{j = 1}^{k} {P}_{g ( j )}}{{\sum }_{j = 1}^{k} {P}_{a ( j )}}$$

Time-based quality efficiency, on the other hand, weights each part type processed in the machine by the individual processing rate for each part:

$$Q = \frac{{\sum }_{j = 1}^{k} \frac{{P}_{g ( j )}}{{R}_{th ( j )}}}{{\sum }_{j = 1}^{k} \frac{{P}_{a ( j )}}{{R}_{th ( j )}}}$$

Since OEE is the product of the three factors (A, P and Q), it follows that OEE in general will have two different values depending on whether unit-based or time-based quality definition is used.

The advantages of using unit-based OEE can be summarized as follows: 1) unit-based OEE mathematically equals to the conventional OEE defined in Equation (1). Time-based OEE, however does not; 2) due to the nature of mass balance, unit-based OEE is directly related to productivity; 3) unit-based OEE lays the foundation to define and measure the factory level productivity as discussed herein.

Note, however, that unit-based OEE and time-based OEE are mathematically identical under any of the following special conditions:

Only one product type is being processed by the UPP during time T_{T},

The theoretical raw processing rates are equal for all product types processed by the UPP

during time T_{T}

Rₜₕ₍₁₎=Rₜₕ₍₂₎= . . . Rₜₕ₍ⱼ₎=Rₜₕ₍ₖ₎

The Quality ratios are evenly distributed among product types

$$\frac{{P}_{g ( 1 )}}{{P}_{a ( 1 )}} = \frac{{P}_{g ( 2 )}}{{P}_{a ( 2 )}} = \frac{{P}_{g ( j )}}{{P}_{a ( j )}} = Λ = \frac{{P}_{g ( k )}}{{P}_{a ( k )}}$$

The yield of all product types during time T_{T} is 100%

P_{g}=Pₐ

To illustrate this two examples as shown in FIG. 14, Table 4. In Case 1 the UPP produces two part types (X and Y) each at a different processing rate. In Case 2, the processing rates are identical for both part types.

By examining the FIG. 14 it is clearly seen that in Case 1 the unit-based quality is different from that of time-based quality and so are the OEE values. Case 2 illustrates one of the above described “special conditions” where equal processing rates result in equal quality efficiencies and OEE for both unit-based and time-based metrics.

10. Connection and Analysis Rules to Calculate Productivity Metrics of UPP Subsystems and Factory Systems

The framework for description and analysis of productivity according to this invention can be summarized as follows: FIG. 5 defines a Unit Production Process (UPP), the basis for analysis of equipment productivity. FIG. 6 defines a Factory System or Unit Factory (UF) consisting of a number of UPPs interconnected in a sequence experimentally determined by the sequence of material flow.

An embodiment of this invention is that the performance of any factory system, flow charted as an interconnected array of UPPs, can be measured and analyzed based on the five (5) basic types of UPP interconnectivity illustrated in FIG. 7. This is achieved through the following steps:

Step 1: Search the factory system for all UPP SubSystems (UPPSSs).

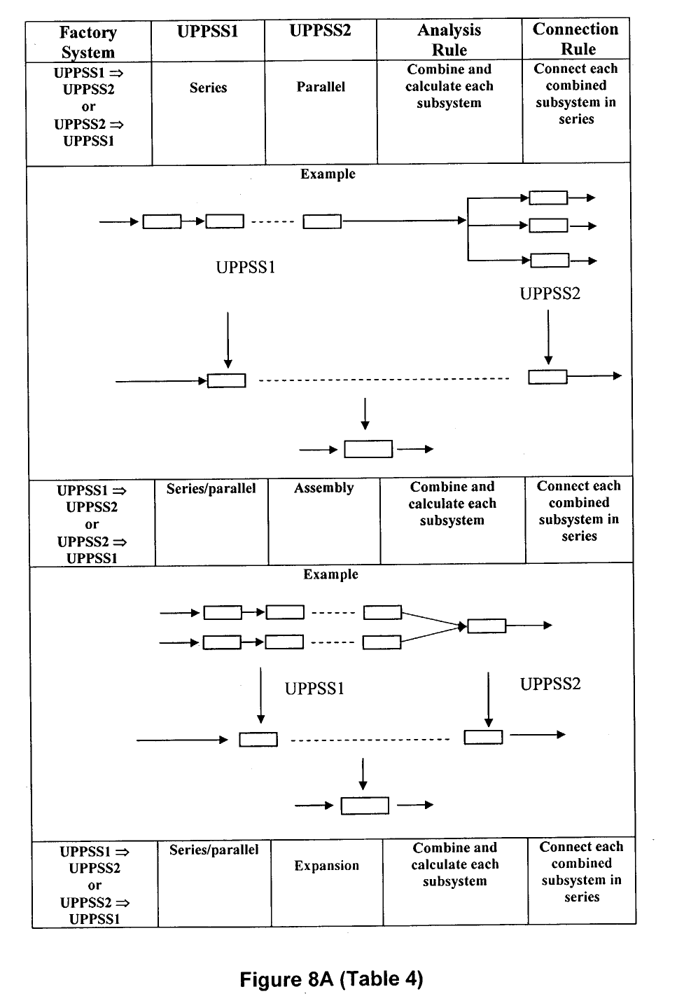

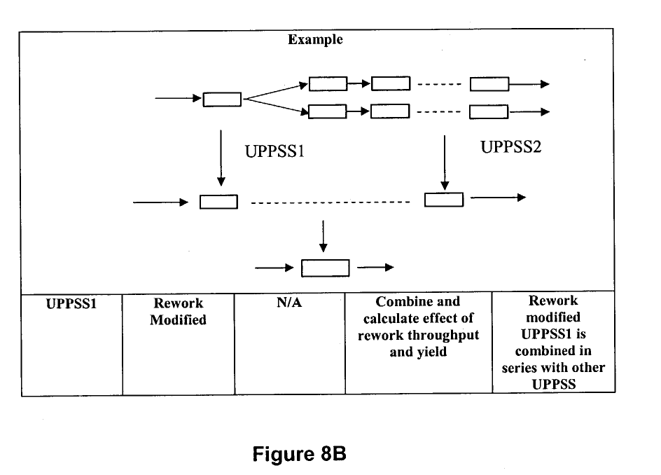

Step 2: Calculate the OTE and CTE for the identified UPPSSs using the combining and analysis rules summarized in FIGS. 8A and 8B, Table 4.

Step 3: Treat each UPPSS as a unit, analogous to a UPP, and connect them to form a new representation of the factory system.

Step 4: Repeat steps 1 to 3 until the new representation of the factory system reduces to a single unit factory (UF), thus obtaining the factory system's OTE and CTE.

This framework is applied for the application of the algorithms outlined in previous sections for calculation of throughput effectiveness, cycle time effectiveness, throughput and inventory of UPPs, UPPSSs and UFs. The next section provides examples for calculation of OEE, OTE and CTE.

11. Example Calculations: OEE, OTE and CTE

The application of the algorithms previously described for calculating OTE and CTE for UPP subsystems described as series, parallel, assembly, and parallel expansion in FIG. 7 are described herein. Parameter values used in the examples are hypothetical but realistic inputs based on data obtained for real manufacturing systems of an industrial manufacturer.

11.1. Example Metrics Calculation for Series and Parallel SubSystems

Parameter inputs in this example are for a production shift of 8 hours or 28,800 seconds.

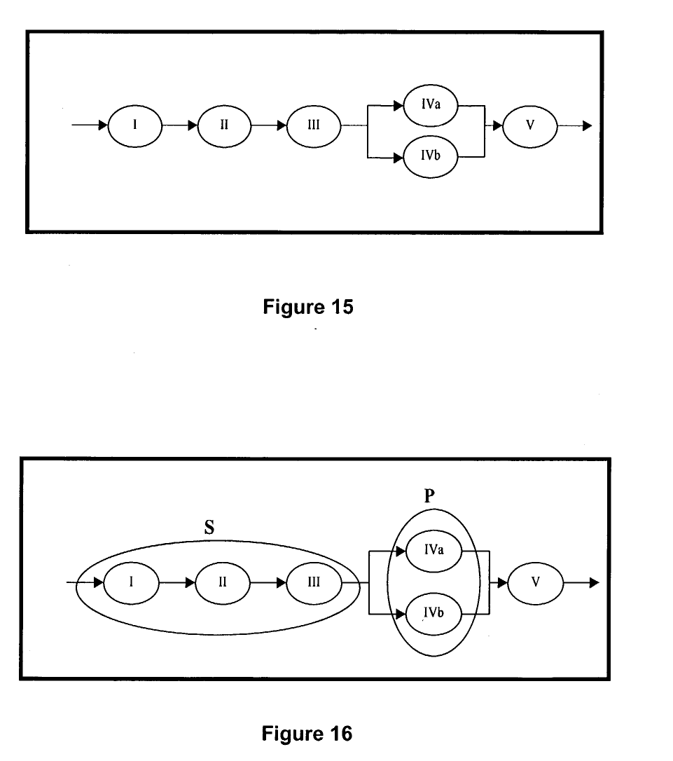

As shown in FIG. 15 the UF comprises seven UPPs interconnected either as series or parallel sub-systems. Two part types (X and Y) are produced at each UPP with different processing rates. The first three machines are connected in series with parts output from UPP III fed into either of two machines in parallel. Parts from both parallel machines are finally fed into the last UPP (V), assuming no input or output buffers and zero setup time at each UPP.

To apply the algorithms, the various UPPs is first categorized into sub-systems according to their interconnection between each other, in this case either parallel or series. Therefore, the seven UPPs become two sub-systems denoted S and P, for series and parallel respectively, connected to the single final UPP in the end (UPP V), shown in FIG. 16.

The combination rules used to combine UPPs based on their interconnections are also used to combine sub-systems or UPPs and sub-systems. According to FIG. 16 the two sub-systems S and P and the UPP (V) are connected in series. Combining these together finally provides a final result of OTE and CTE for the entire UF.

Sections 1.1 and 1.2 demonstrate calculating OTE and CTE for each sub-system and OEE for UPP V. Finally, in Section 1.3 OTE and CTE are calculated for the entire factory (UF).

11.1.1. Series-Connected UPP Sub-System

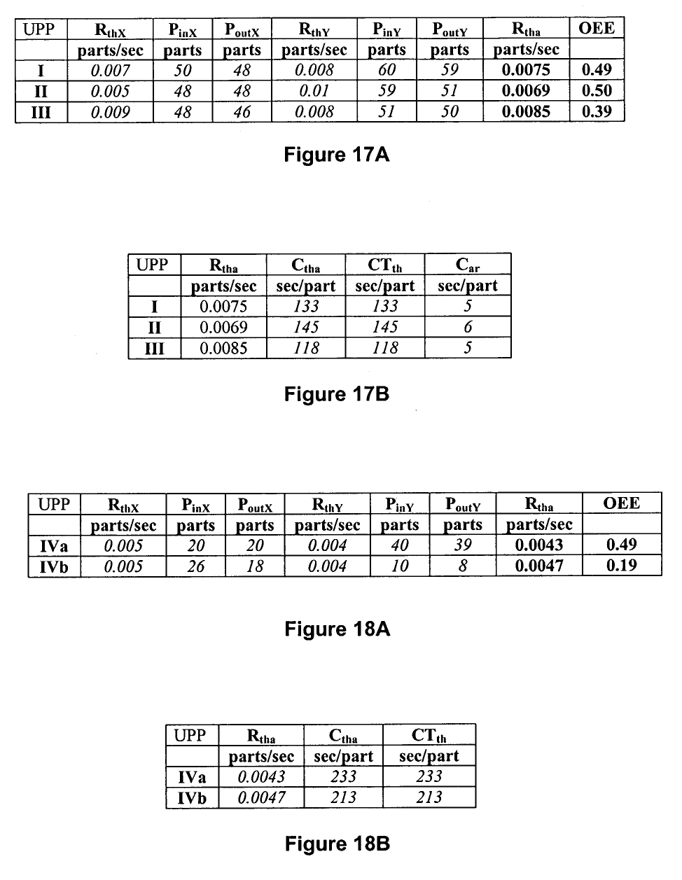

The OEE for each UPP in sub-system S is determined from the collected data using Equation (8). Before that the theoretical average processing rates Rₜₕₐ were calculated using Equation (3). Collected data and results are shown in the table in FIG. 17A.

The theoretical average processing rate for the series sub-system is determined from Equation (26) to be 0.0069 parts/sec and the total number of parts produced is 96 good parts of types X and Y. Therefore using Equation (27), OTE for sub-system S is:

OTE_{S}=0.48

Using transportation times given in the table in FIG. 17B and the assumptions listed above, CTTH for the series sub-system was determined from Equation (28) as 412 sec/part.

With a measured average actual cycle time (C_{TA(s)}) of 500 sec/part, the CTE for the series sub-system using Equation (23) would be:

CTE_{S}=0.82

11.1.2. Parallel-Connected UPP Sub-System

As with the series sub-system, Rₜₕₐ and OEE for each UPP were determined, as shown in the table in FIG. 18A.

From Equation (32), R_{THA(P)} is 0.009 parts/sec and Equation (33) gives,

OTE_{P}=0.33

The table in FIG. 18B lists CTth for each UPP also based on assumptions of no buffers and zero setup time. From Equation (34), CT_{TH(P)} is 225.5 sec/part.

With a measured average actual cycle time (CT_{A(P)}) of 300 sec/part, the CTE for the parallel sub-system using Equation (23) is:

CTE_{P}=0.75

11.1.3. Unit Factory

The production line or factory is now represented as two sub-systems (S and P) and a UPP (V) combined in series. Applying the same algorithms used for a set of series UPPs, OTE and CTE for the UF may be calculated after determining OEE and CTₜₕ of the last UPP (V).

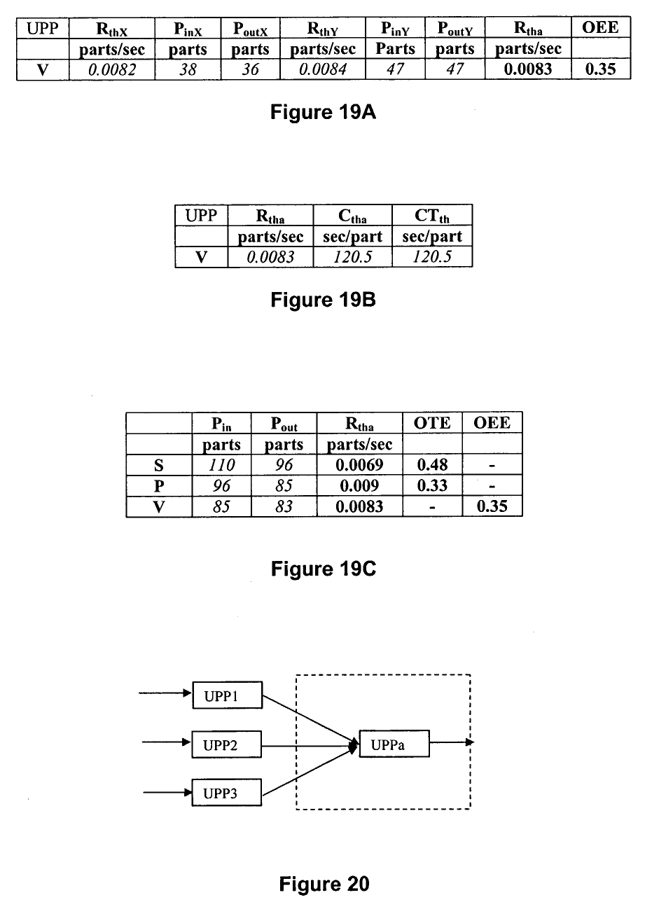

Data and calculations for the last UPP (V) are shown in the table in FIG. 19A.

CTₜₕ is also based on the same assumptions listed above with no transportation time following it. Hence using Equation (28) CT_{th(V)} is 120.5 sec/part (see the table in FIG. 19B).

With a measured average actual cycle time (CTₐ) of 160 sec/part, the CTE for the parallel sub-system using Equation (23) is:

CTE=0.75

The table in FIG. 19C summarizes results from both sub-systems and the UPP.

Again, from Equation (26) and (27):

R_{THA(F)}=0.0069 parts/sec and,

OTE_{(F)}=0.42

Since transportation times were already included in the sub-system calculations, CT_{TH(F)} for the UF is 758 sec/part.

Finally, with an average actual cycle (CT_{A(F)}) of 960 sec/part, Equation (23) yields: CTE_{(F)}=0.79 sec/part

11.2. Example Metrics Calculation for an Assembly Subsystem

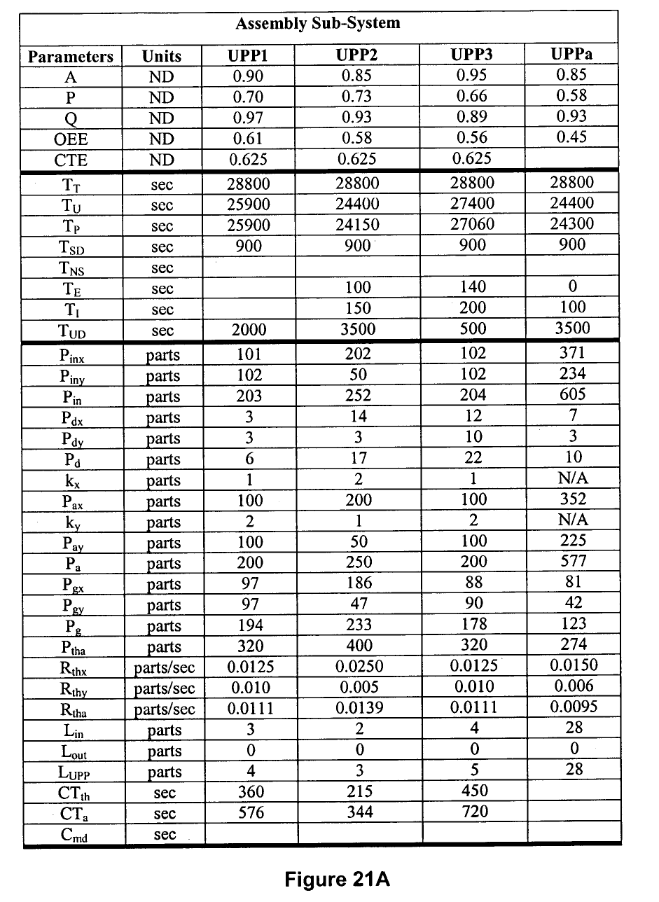

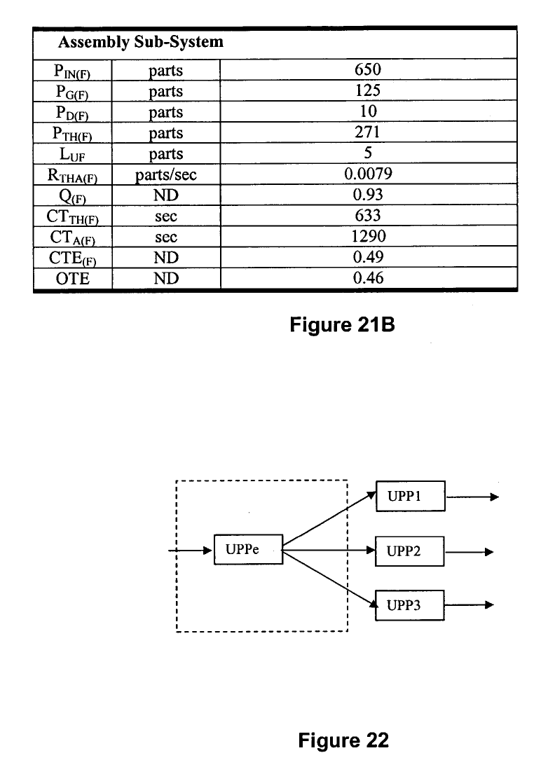

Parameter inputs in this example are for a production shift of 8 hours or 28,800 seconds, using the designations for the Assembly Subsystem as indicated below, where UPP1, UPP2 and UPP3 are “Regular UPPs”, and UPPa is an “Assembly UPP”. The example includes the processing of multiple product types. See FIGS. 20, 21A and 21B.

11.3. Example Metrics Calculation for a Expansion Subsystem

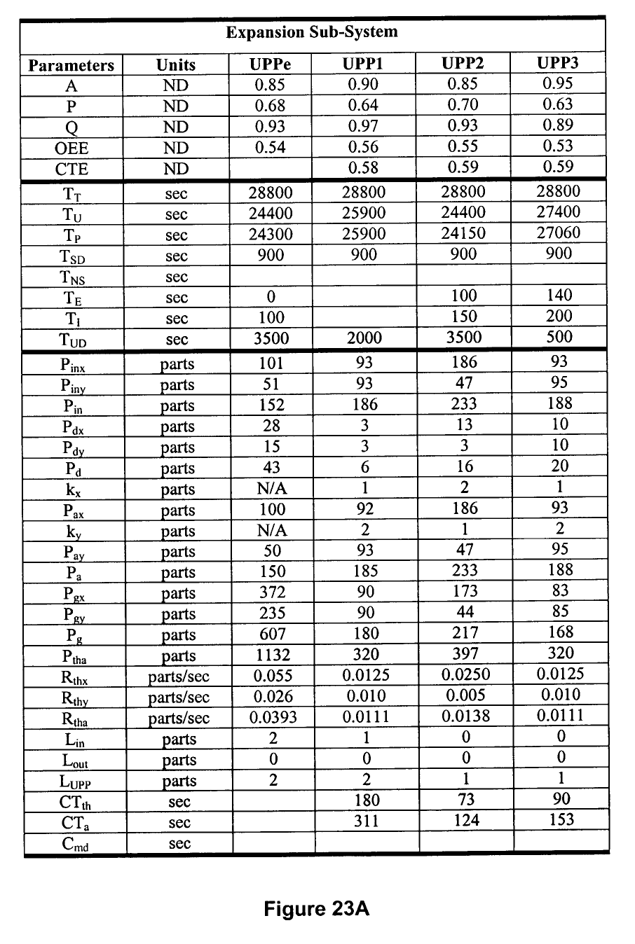

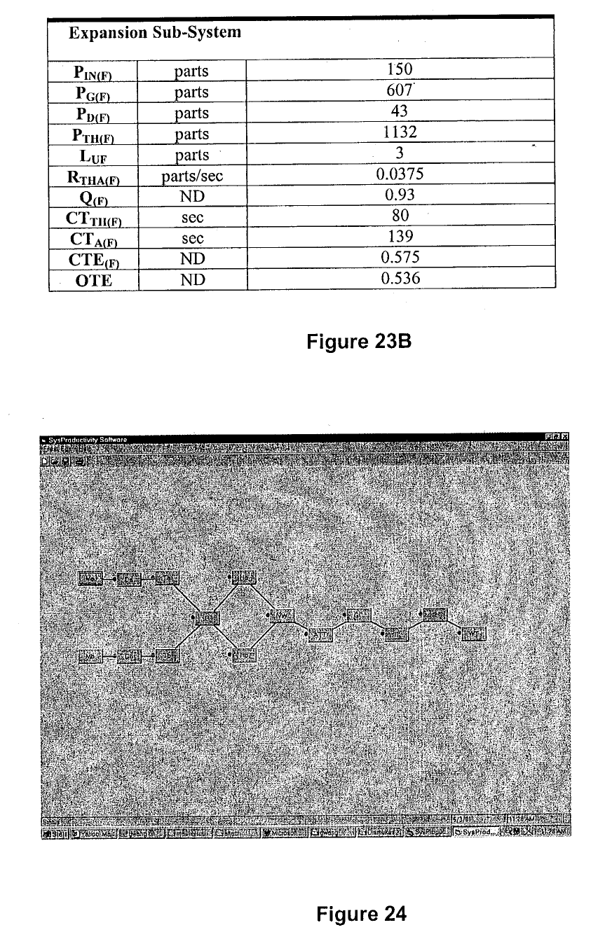

Parameter inputs in this example are for a production shift of 8 hours or 28,800 seconds, using the designations for the Expansion Subsystem as indicated below, where UPP1, UPP2 and UPP3 are “Regular UPPs”, and UPPe is an “Expansion UPP”. The example includes the processing of multiple product types. See FIGS. 22, 23A and 23B.

12. Methodology for Electronic Flow Charting and Productivity Measurement Tool 12.1. Overview of Electronic Flow Charting Productivity Measurement Tool (EFCPMT) Construction and Operation

One particular embodiment of this invention is the application of the productivity framework and algorithms for the measurement and analysis of the productivity of real factories based on factory data. One method to accomplish this is to use standard spreadsheet tools (e.g. EXCEL or other suitable tools) to conduct the calculations based on the factory flowchart and UPP and UPPSS algorithms. A second method is the use of a novel visual flowcharting and measurement tool with the manufacturing framework and the algorithms for productivity measurement at the equipment, subsystem and factory level coded in a standard computer language (e.g. Visual Basic or other suitable languages).

An Electronic Flow Charting Productivity Measurement Tool (EFCPMT) has been developed by using Microsoft™ Visual Basic 6.0 to measure and analyze manufacturing system productivity based on the developed manufacturing productivity metrics at Unit Production Process (UPP) level, UPP Sub-System (UPPSS) level and Factory System or Unit Factory (UF) level. Major functions of this software tool include 1) electronic flowcharting of the manufacturing system, 2) production data acquisition or input, 3) manufacturing productivity calculation, 4) export of manufacturing productivity metrics and information (e.g. EXCEL or other spreadsheets) and 5) export interconnectivity information of use the manufacturing system and its intrinsic performance characteristics to a suitable software package.

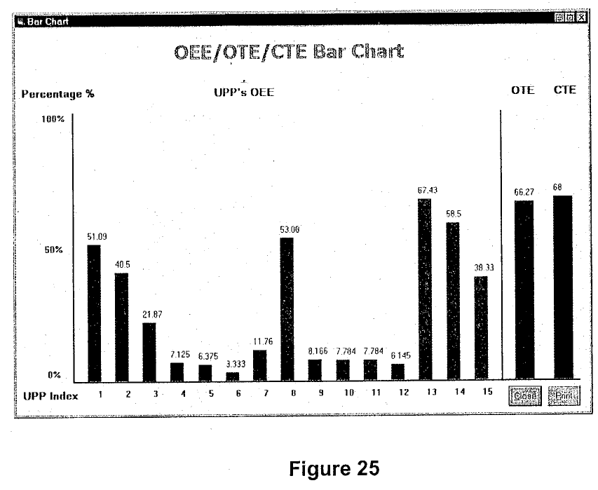

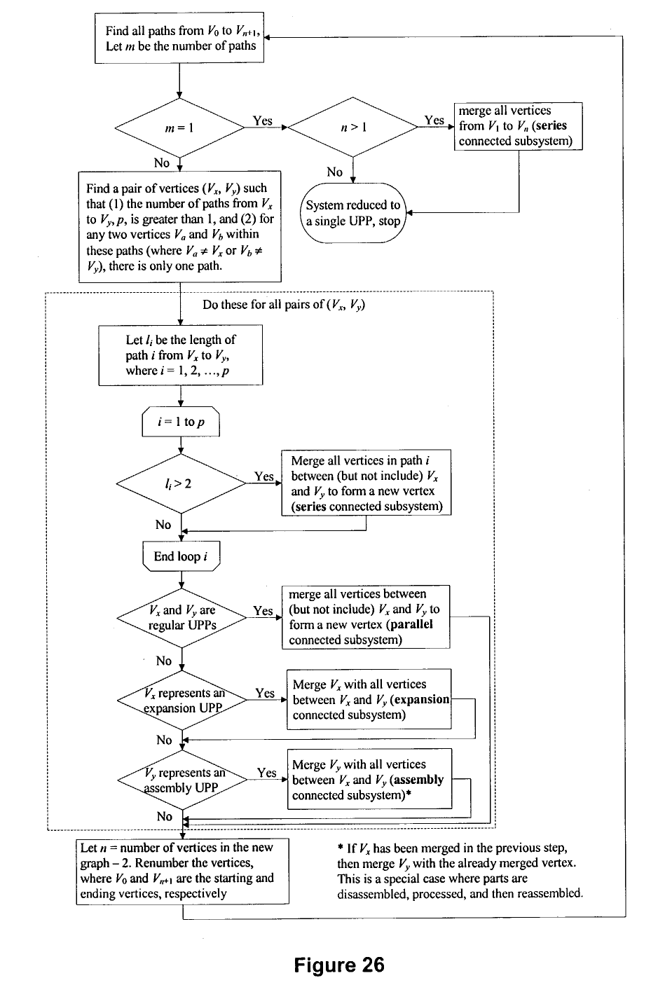

The first step is to create an electronic flowchart of the manufacturing flowchart in the EFCPMT, which incorporates all the parameter definitions of Tables 1-3 (FIGS. 2A-2B, 3 and 9A-9E) and the connection and analysis rules of Table 4 (FIGS. 8A and 8B). FIG. 24 illustrates an electronic flowchart generated by the EFCPMT for a manufacturing system of 15 UPPs. The next step after flowcharting the system is to enter the appropriate production parameters. This is implemented by individual entry of the data, or by interfacing with the Raw Data sheet in EXCEL file by using Visual Basic Application (VBA). Productivity metrics at UPP level, subsystem level and production system or factory level are then calculated, and a bar chart for OEE, OTE and CTE can be generated for system analysis as illustrated in FIG. 25. The results are written into a different sheet in EXCEL or a different table in other databases. The interfacing task is implemented by VBA. Data outputs can also be used as inputs for automatic creation of simulation models discussed in a following section.

12.2. Linkage Rules and Algorithms for UPP Interconnection and Algorithms for UPP SubSystem Recognition

For general application, UPPs are characterized in three categories: Regular, Assembly and Expansion. For a Regular UPP, used in Series and Parallel Subsystems, the input and output units of material flow are equal. For an Assembly UPP, the output units of material flow are a factor of 1/N times the input units, representing the assembly process. For an Expansion UPP, the output units of material flow are a factor of N times the input units, representing the expansion process.

The interconnectivity of a manufacturing system, visualized as a flow chart, is represented as a directed graph in the electronic flowcharting and productivity measurement tool (EFCPMT). Details of the representation is as follows:

A UPP i is represented as a vertex Vᵢ, where i=1, 2, . . . , n, n is the number of UPP in the manufacturing system

If parts flow from UPP i to UPP j, then there is a directed edge from Vᵢ to Vⱼ

Vertex Vᵢ, representing UPP i, has a property called type, which can be regular (R), assembly (A), or expansion (E).

A starting vertex V₀ and an ending vertex Vₙ₊₁, representing warehouses for the incoming materials and the outgoing products, respectively, are added. Both vertices are of type R. In other words, they are treated as regular UPPs.

An algorithm, based on graph theory, has been developed to automatically recognize UPP subsystems for the EFCPMT, as shown in FIG. 26. Details of the two top left side boxes in FIG. 26 are public knowledge in the graph theory literature, and hence, are not explained further. The type of merged vertices is always regular. The following is an example illustrating how the algorithm works.

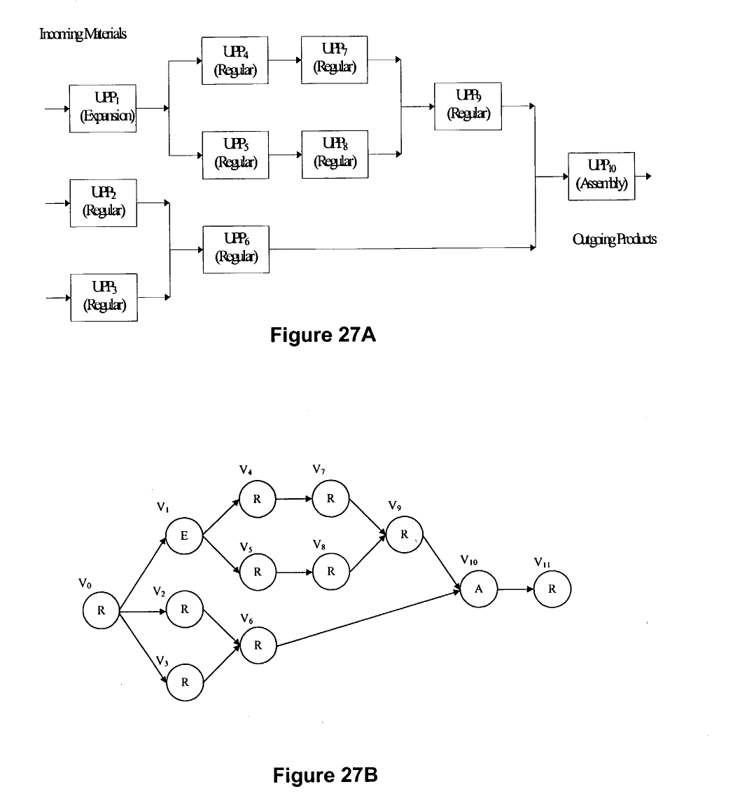

FIG. 27 shows the example manufacturing system and its corresponding graph representation. There are four paths from V₀ to V₁₁, listed as follows:

1. V₀→V₁→V₄→V₇→V₉→V₁₀→V₁₁

2. V₀→V₁→V₅→V₈→V₉→V₁₀→V₁₁

3. V₀→V₂→V₆→V₁₀→V₁₁

4. V₀→V₅→V_{6→V}₁₀″V₁₁

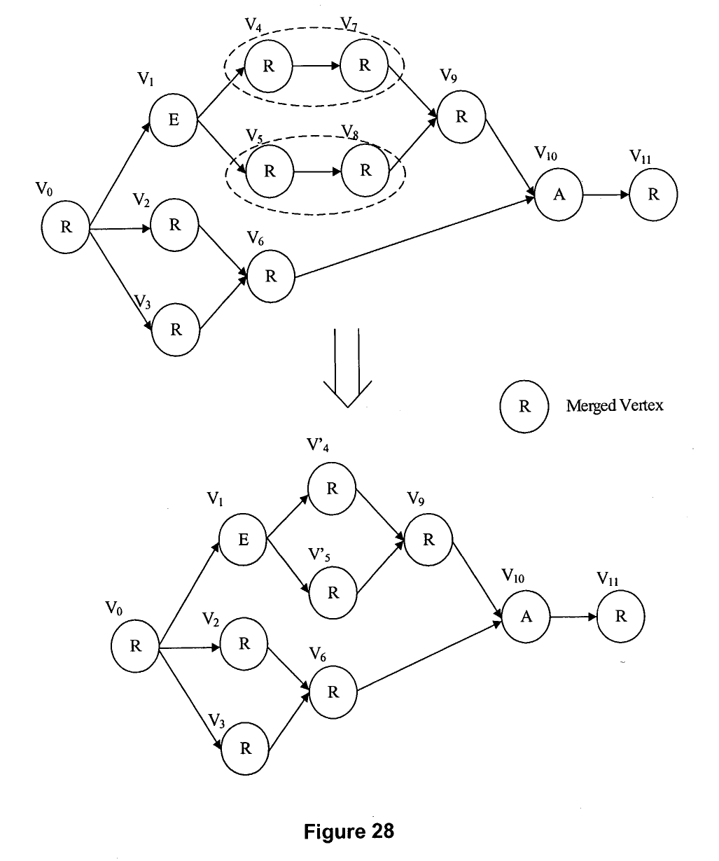

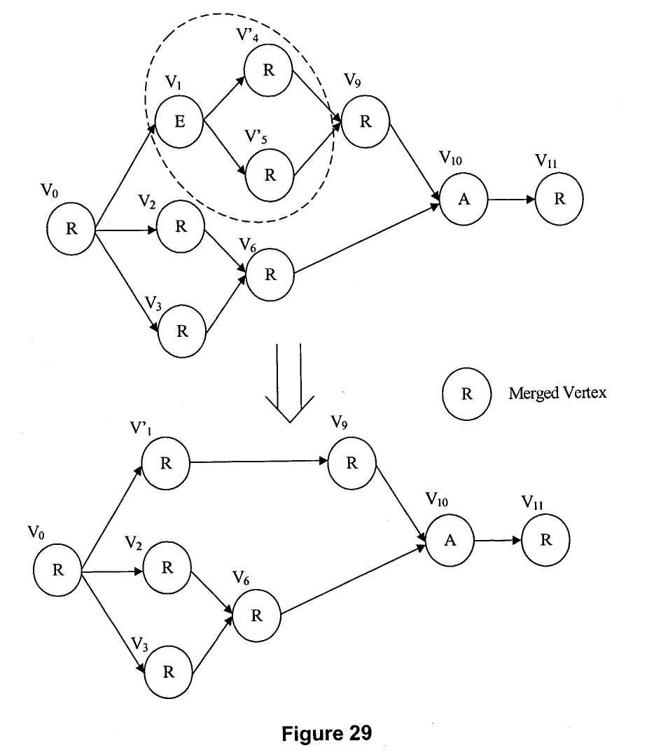

Therefore, the number of paths, m, is 4. Thus, the pairs of (Vₓ, V_{y}) must be found. There are two such pairs, (V₁, V₉) and (V₀, V₆). Consider the pair (V₁, V₉) first p=2; since there are two paths from V₁ to V₉, namely, V₁→V₄→V₇→V₉ and V₁→V₅→V₈→V₉. I₁=I₂=3, since there are three edges in both paths. Therefore, V₄ and V₇ form a series connected subsystem, while V₅ and V₈ form another. V₄ is merged with V₇ to form a new vertex V₄, and V₅ is merged with V₈ to form another new vertex V₅, as shown in FIG. 28. Since V₁ is an expansion UPP, it forms an expansion connected subsystem with V′₄ and V′₅. These three vertices are merged to form a new vertex V′₁, as shown in FIG. 29.

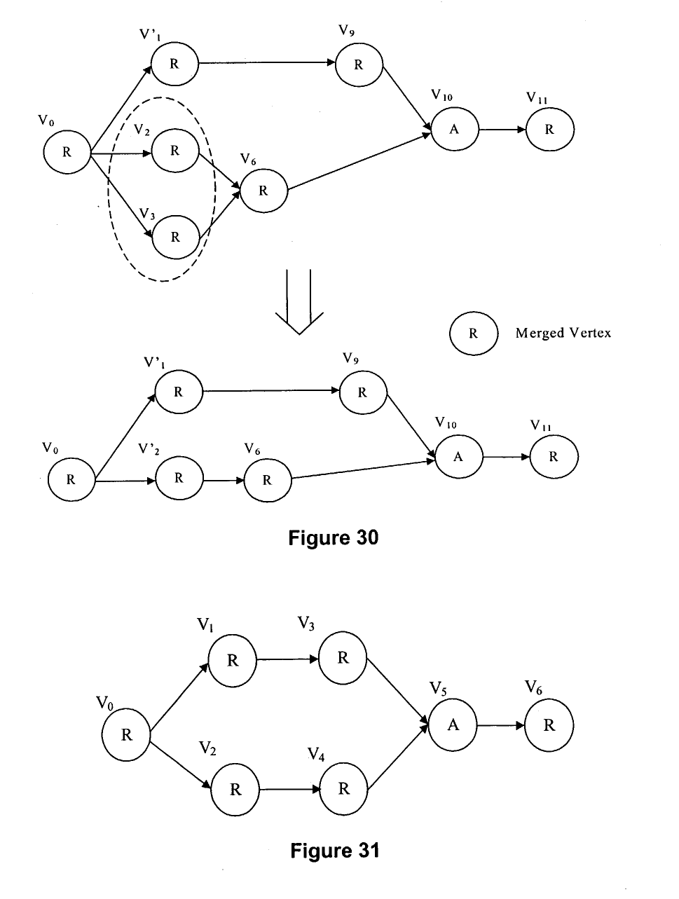

Now consider the pair (V₀, V₆). p=2, since there are two paths from V₀ to V₆, namely, V₀→V₂→V₆ and V₀→V₃→V₆. I₁=I₂=2, since there are two edges in both paths. Since both V₀ and V₆ are regular UPPs, V₂ and V₃ form a parallel connected subsystem. They are merged to form a new vertex V′₂, as shown in FIG. 30.

There are now 7 vertices in the new graph. Therefore, n=7−2=5. Renumber vertices of the graph as shown in FIG. 31, where V₀ is still the starting vertex and V₆ is the ending vertex. This time there are two paths from V₀ to V₆. One pair of (Vₓ, V_{y}) is found, namely, (V₀, V₅). p=2, since there are two paths from V₀ to V₅. I₁=I₂=3. Therefore, V₁ and V₃ form a series connected subsystem, while V₂ and V₄ form another. Since V₅ is an assembly UPP. The newly merged vertices V′₁ and V′₂ are merged with V₅ since they form an assembly connected subsystem.

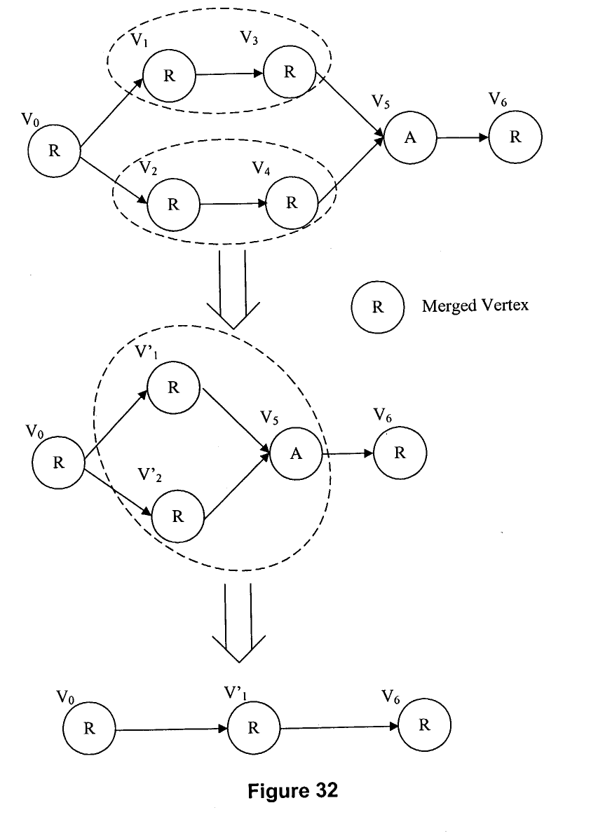

These steps are illustrated in FIG. 32. There are now 3 vertices in the new graph. Therefore, n=3−2=1, and there is only one path from the starting vertex to the ending vertex. This means the whole system has been reduced to a single UPP. The procedure terminates.

13. Methodology for Automated Simulation Model Building for Rapid What-If Scenario Analysis

The electronic flowcharting and productivity measurement tool (EFCPMT) provides a way to analyze an existing production facility (manufacturing system). One basic purpose of incorporating simulation with EFCPMT is to provide this tool real time data for productivity metrics calculations. Thus, using simulation analysis of particular manufacturing operations can be done before actually running that process physically. Also, when changes (introduction of new equipment, change of scheduling policy, etc.) are needed, it is desirable to evaluate the effect of these changes on productivity before they are actually implemented. This “What-if” scenario analysis is usually carried out through discrete event simulation, which allows a manufacturing company to implement the changes, and thereby “do things right the first time”. The simulation is very useful to predict the behavior of manufacturing operation before actually implementing such operation in real world.

While there are a number of commercially available software tools for discrete event simulation, building a simulation model require substantial experience and its time consuming. However, one aspect of the present invention provides two different methods to automatically build a simulation model from the electronic flowcharting and productivity measurement tool, based on the captured production data and the structure (connectivity) of the production facility.

In another aspect, the dynamic simulation is then linked to market demand. To illustrate how the first methodology works, the following example uses the ARENA simulation software tool, developed by Rockwell Software Inc., to represent the simulation environment. However, the method can be generally applied to other simulation software tools.

ARENA has the capability to import/export a simulation model from an external database such as Microsoft EXCEL and ACCESS. Each model database divides its model data into separate storage containers called tables (worksheets in EXCEL). These tables organize the data into columns (called fields) and rows (called records). The model information that may be stored in a model database includes the following:

Modules (including coordinates and data) from any panel

Submodels (including coordinates and properties)

Connections between modules and submodels

Named views

Project parameters, replication parameters, and report parameters specified in Arena's Run/Setup option

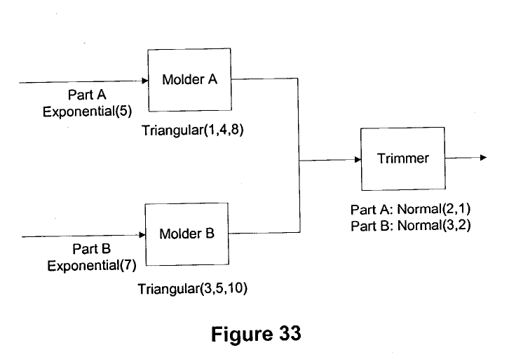

The electronic flowcharting and productivity measurement tool can automatically generate all of the information and stored them in ARENA required format. FIG. 33 shows an example flowchart with production information. Note that there are two part types (with different processing time at the Trimmer) and three process stations. Therefore, the following ARENA modules are generated

Two CREATE module to simulate the arrival of part A and B

Two ASSIGN module to assign different processing time at the Trimmer

Three PROCESS module to represent the three process stations

Two ENTITY module to represent part A and B

Three RESOURCE modules, one for each PROCESS module in order to collect process utilization statistics

Three QUEUE modules, one for each PROCESS modules to determine the scheduling policy and collect queuing statistics

One DISPOSE module to represent the end point of simulation

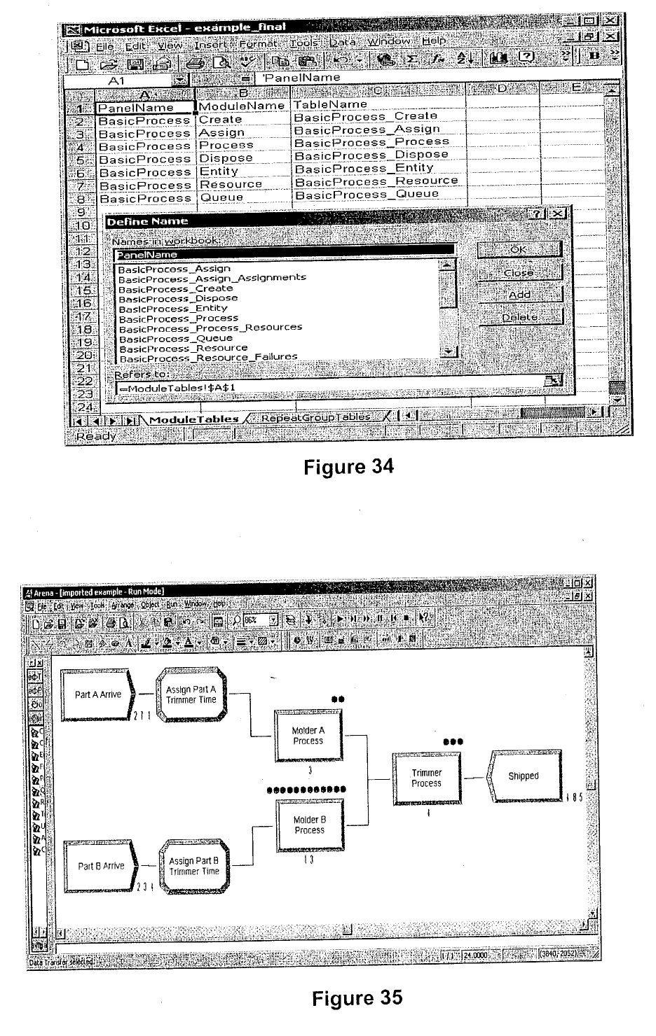

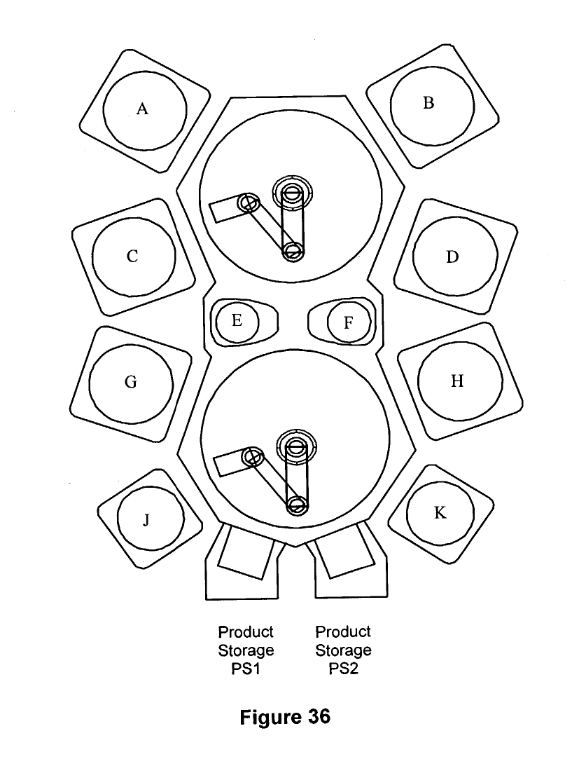

These modules, along with the connectivity information and simulation parameters (the length of simulation time, animation speed, etc.) are created in an EXCEL data file as shown in FIG. 34. This file is then imported to ARENA to automatically obtain the simulation model shown in FIG. 35. By a single mouse click, the simulation will proceed to see the effect on productivity.

To illustrate how the second methodology works, the following example uses the arena simulation software tool, developed by Rockwell software Inc., to represent the simulation environment. However, the method can be generally applied to other commercially available simulation software tools and custom developed simulation tools as desired.

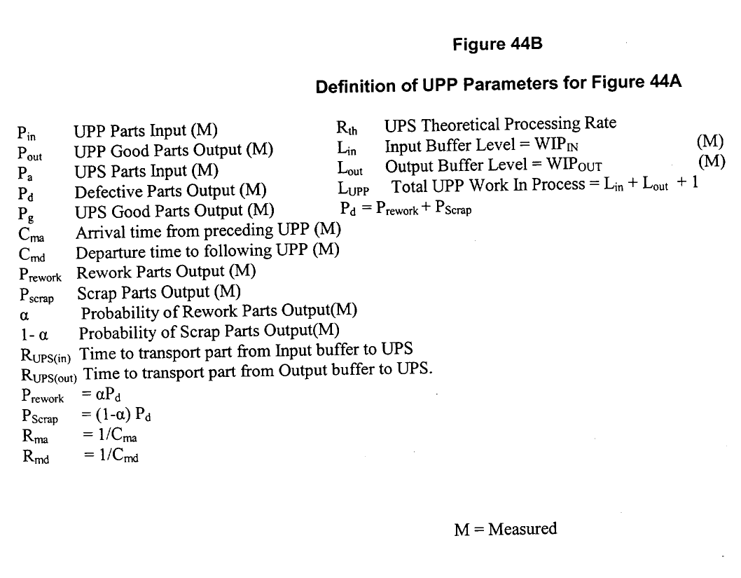

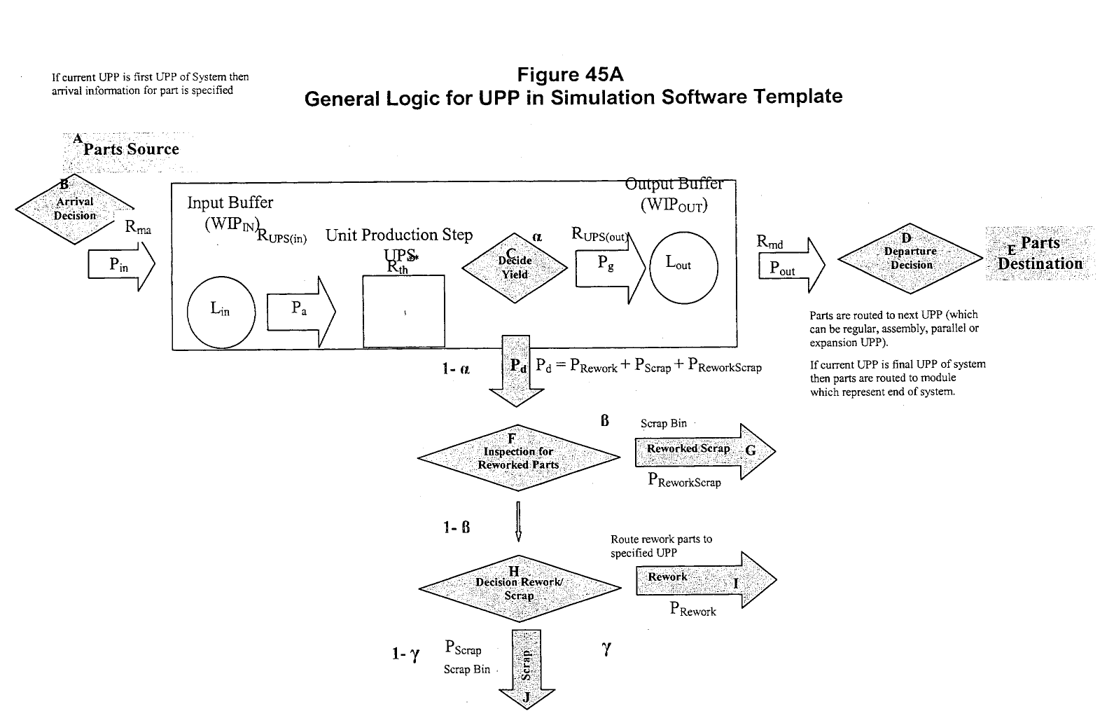

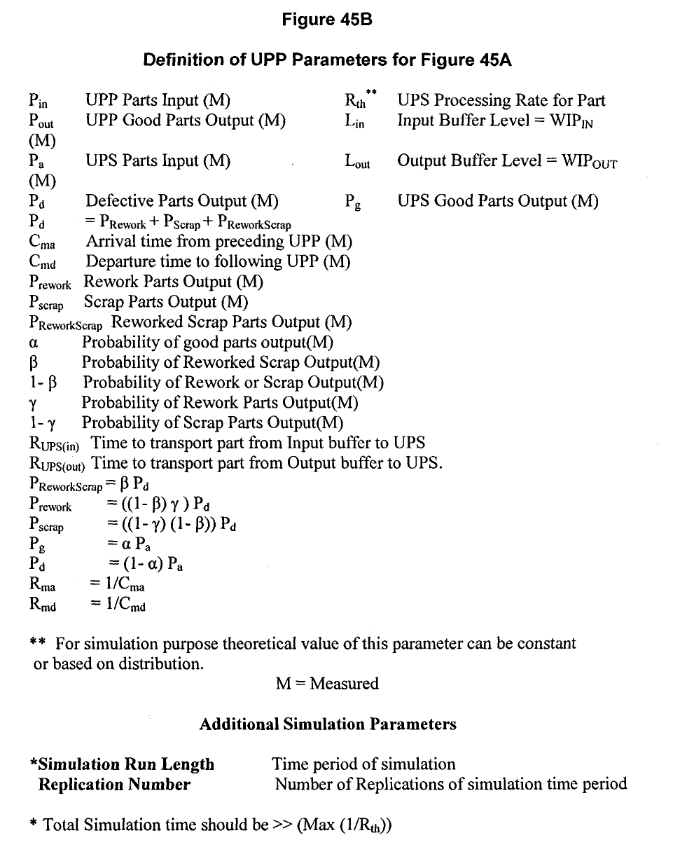

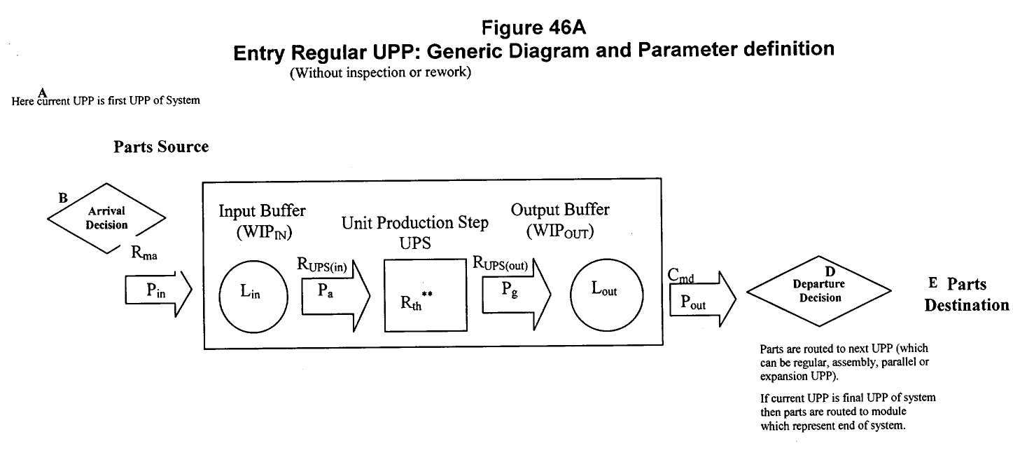

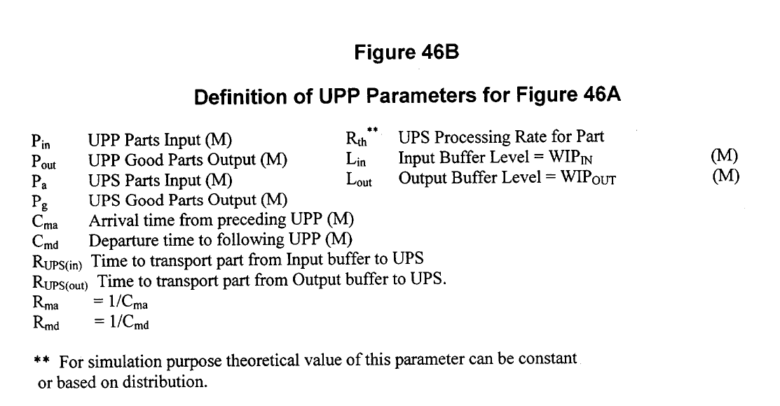

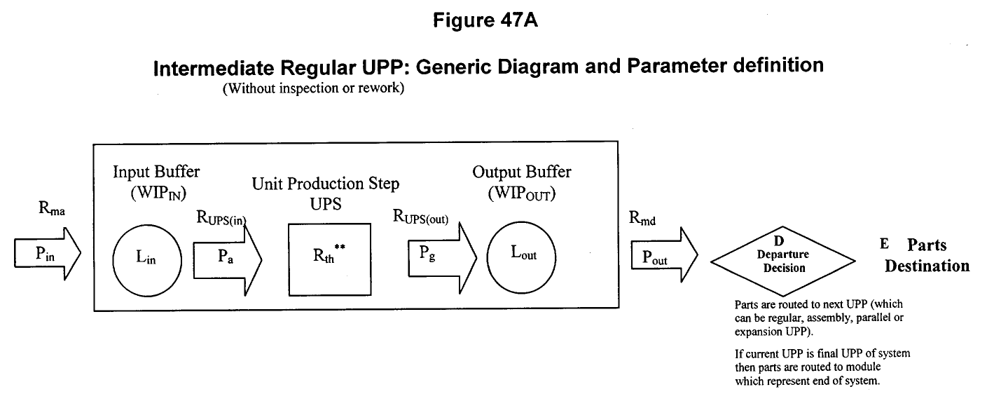

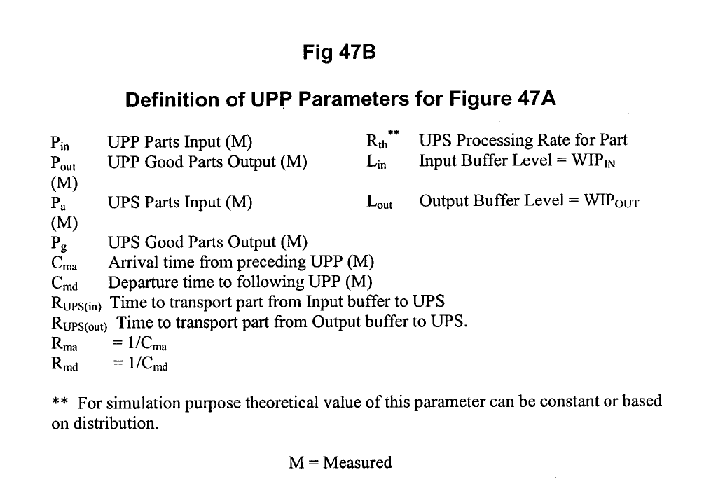

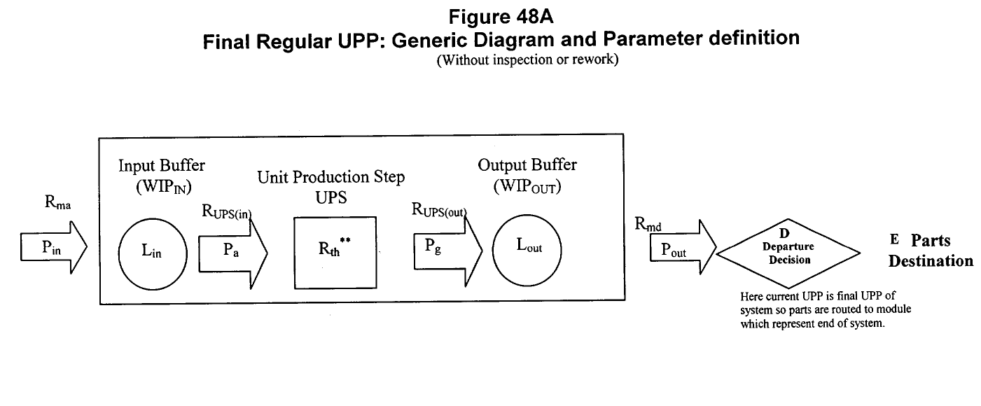

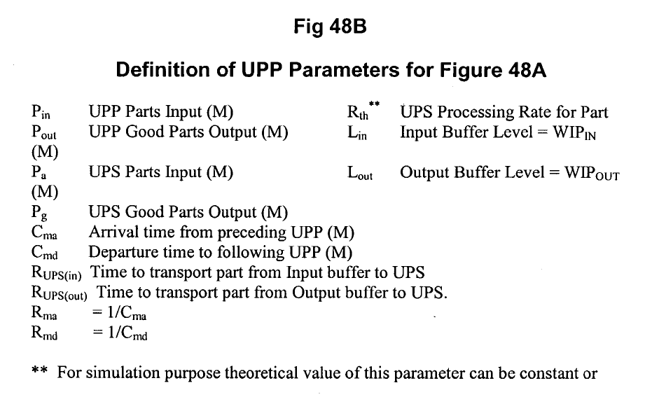

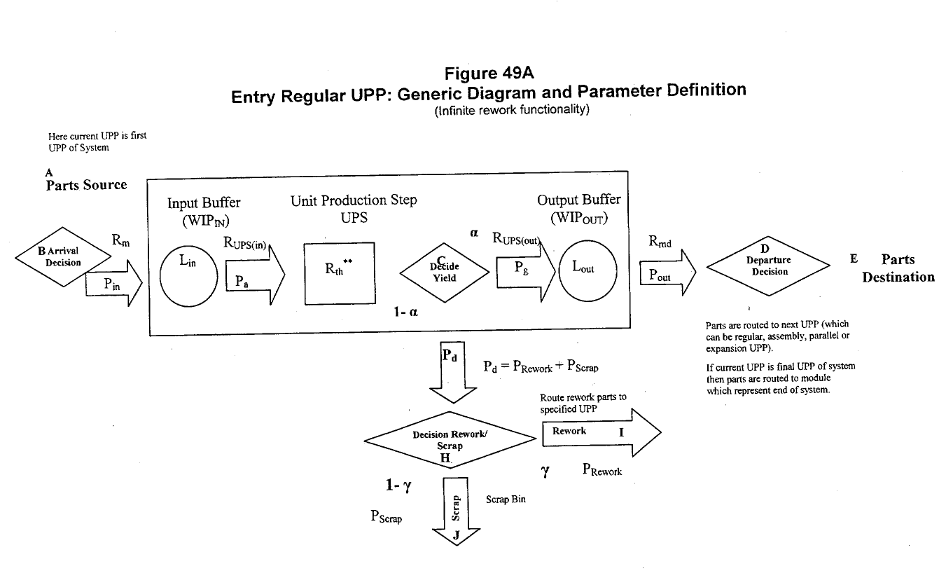

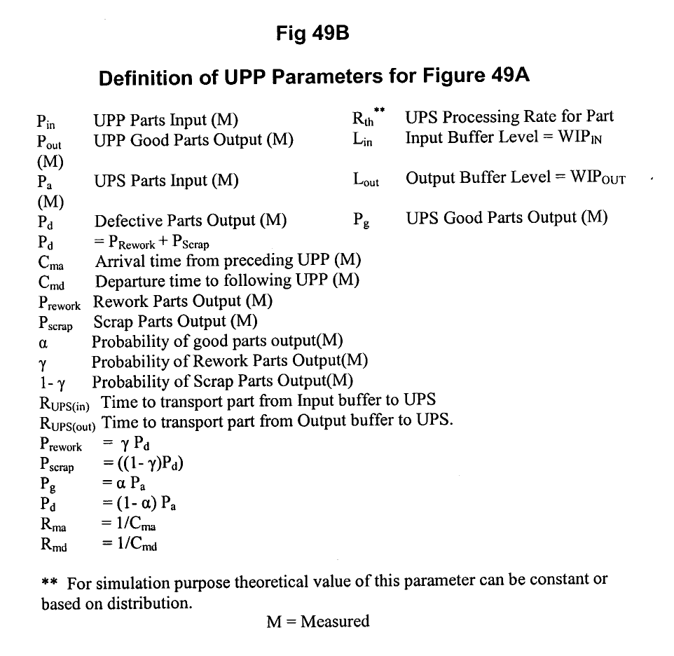

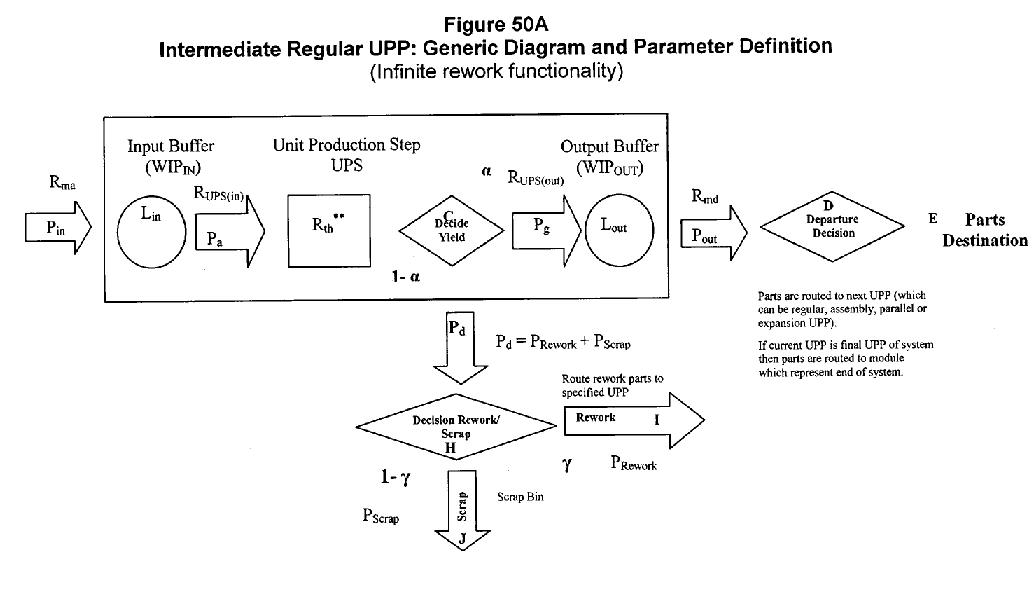

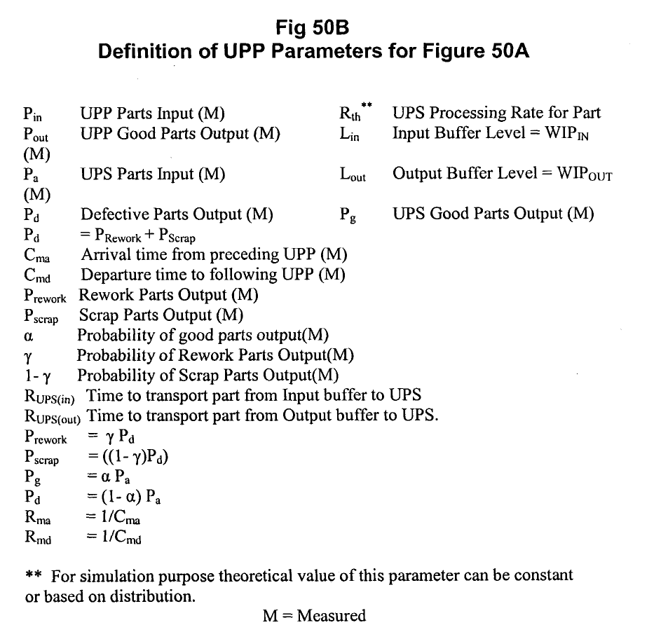

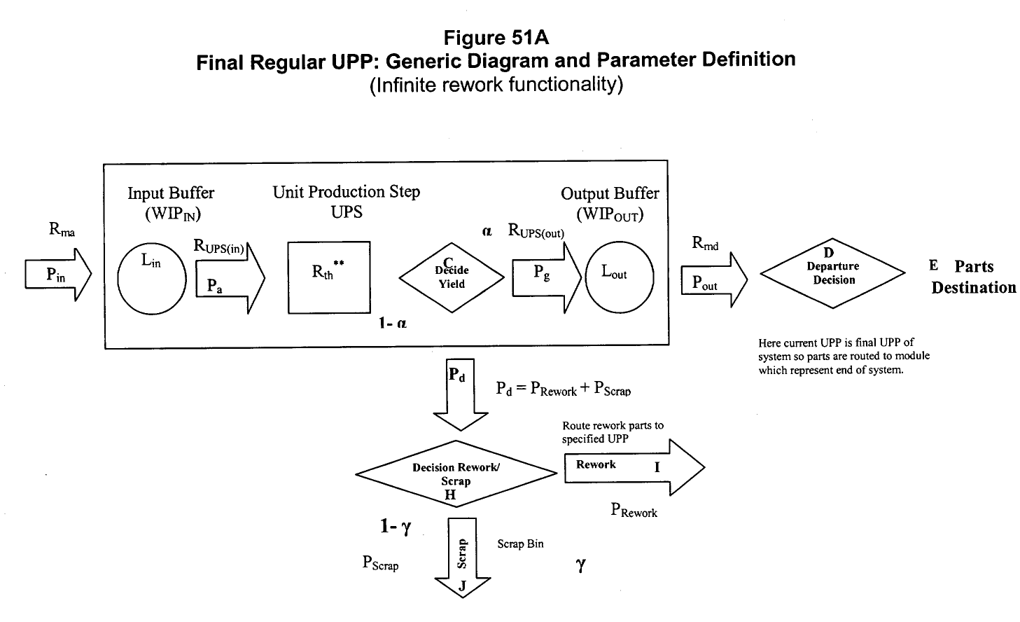

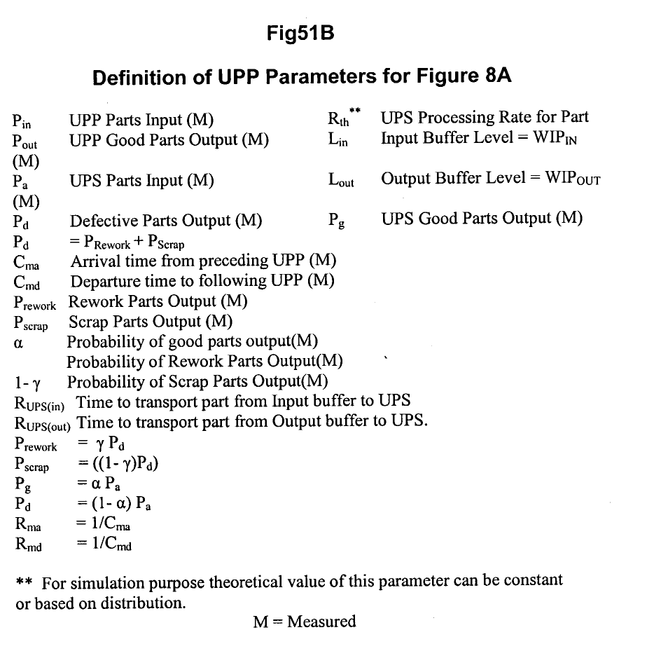

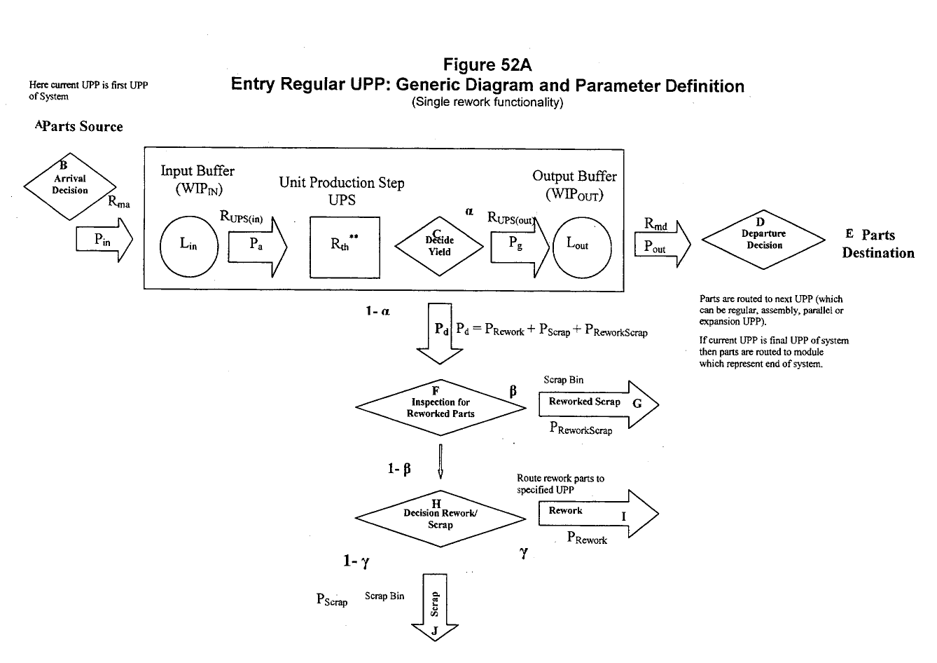

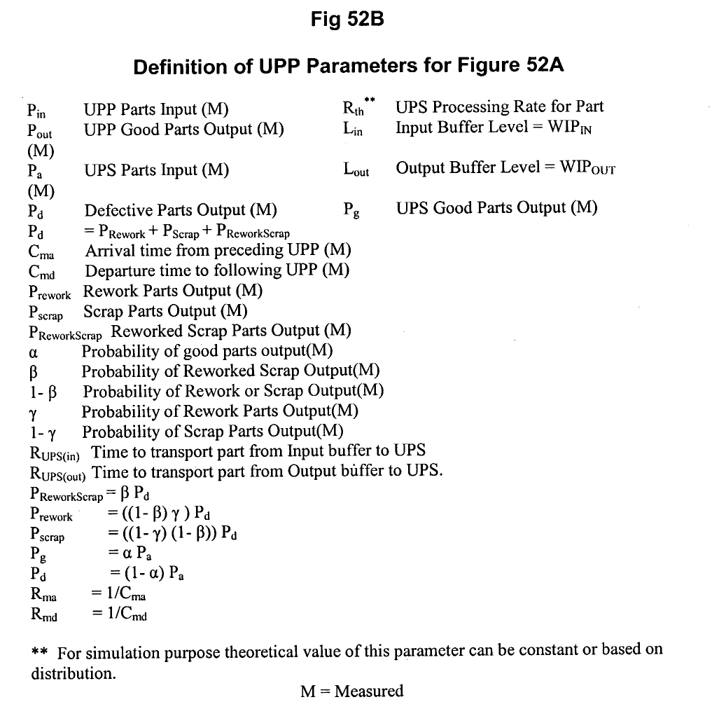

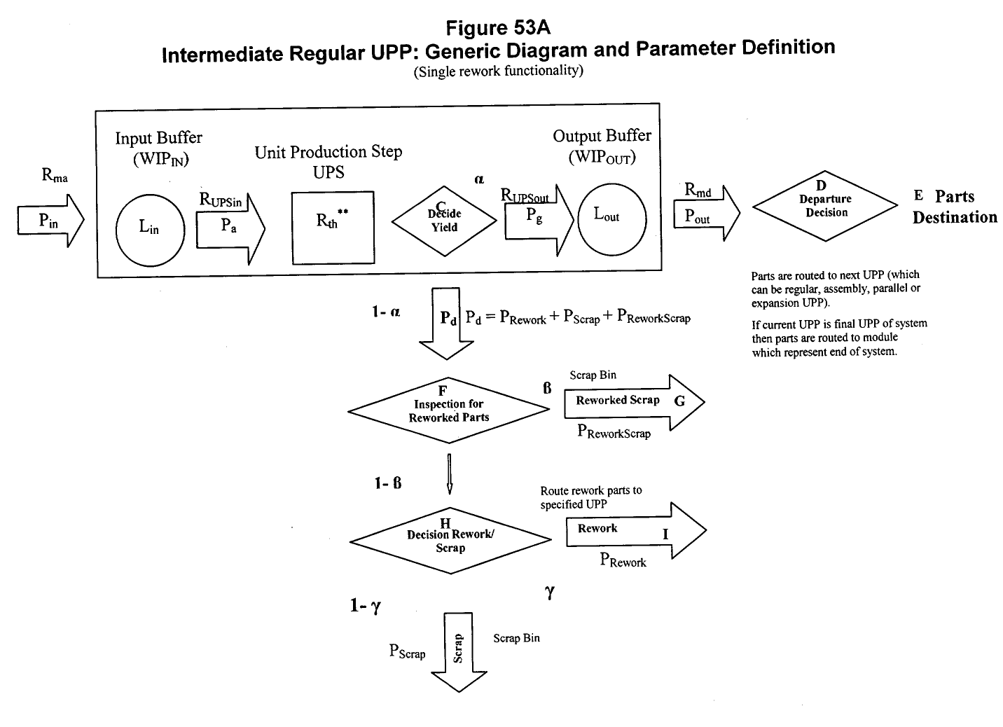

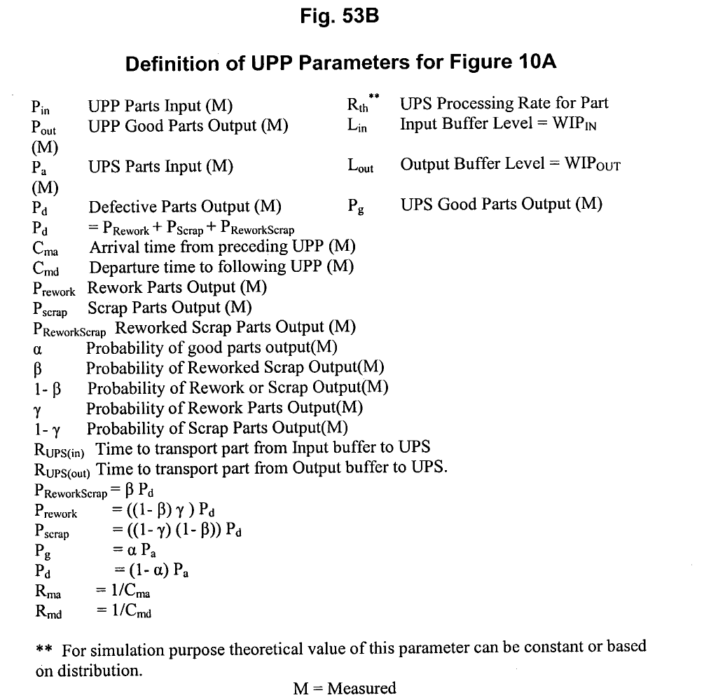

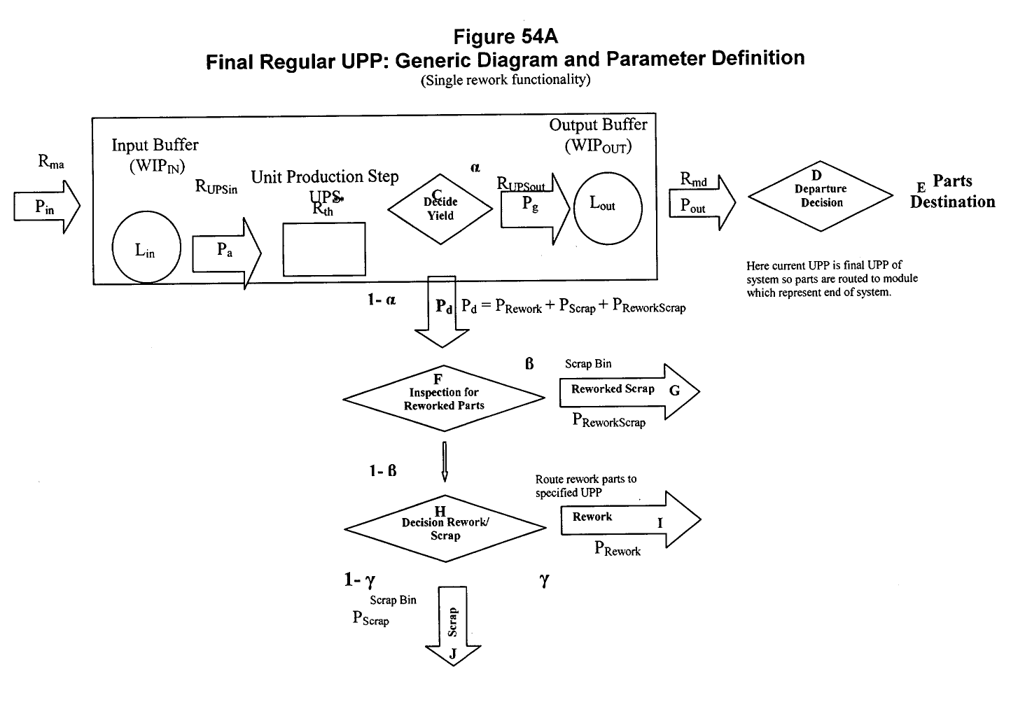

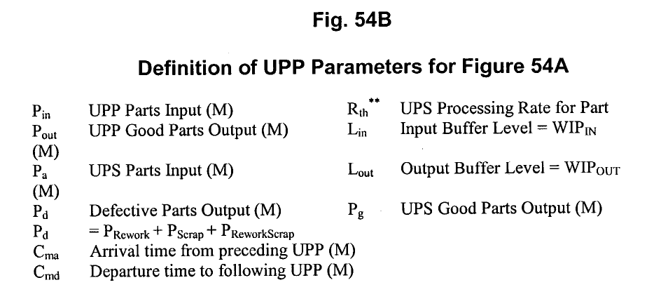

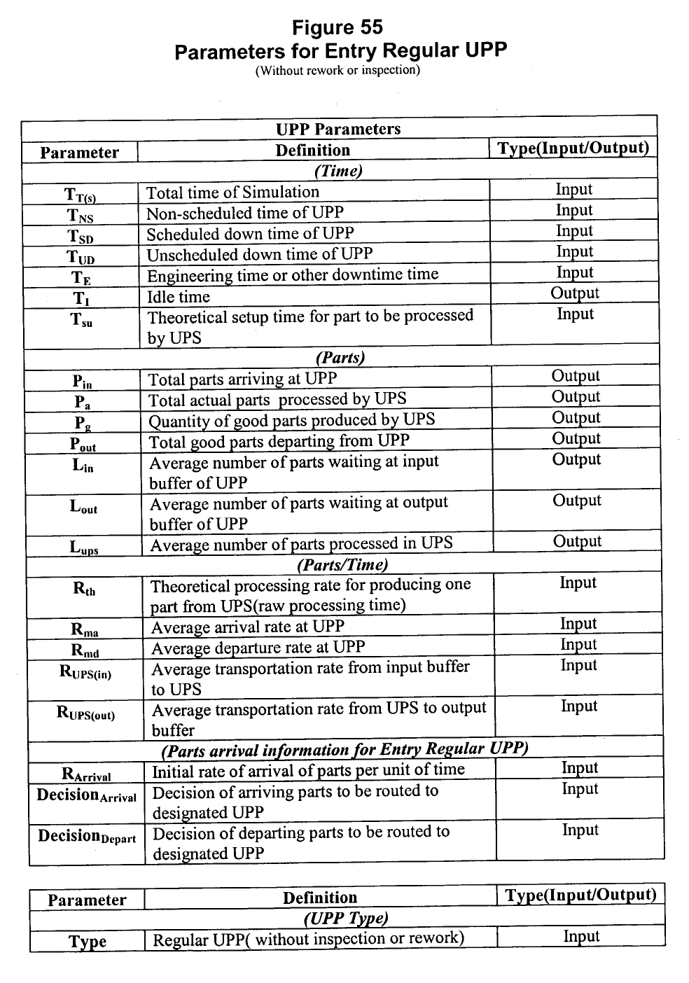

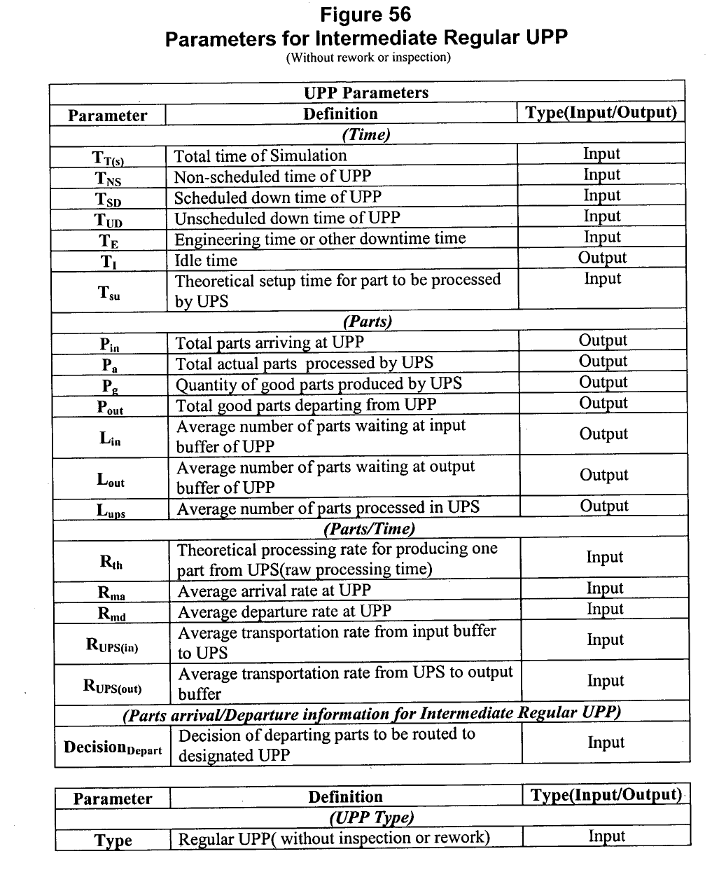

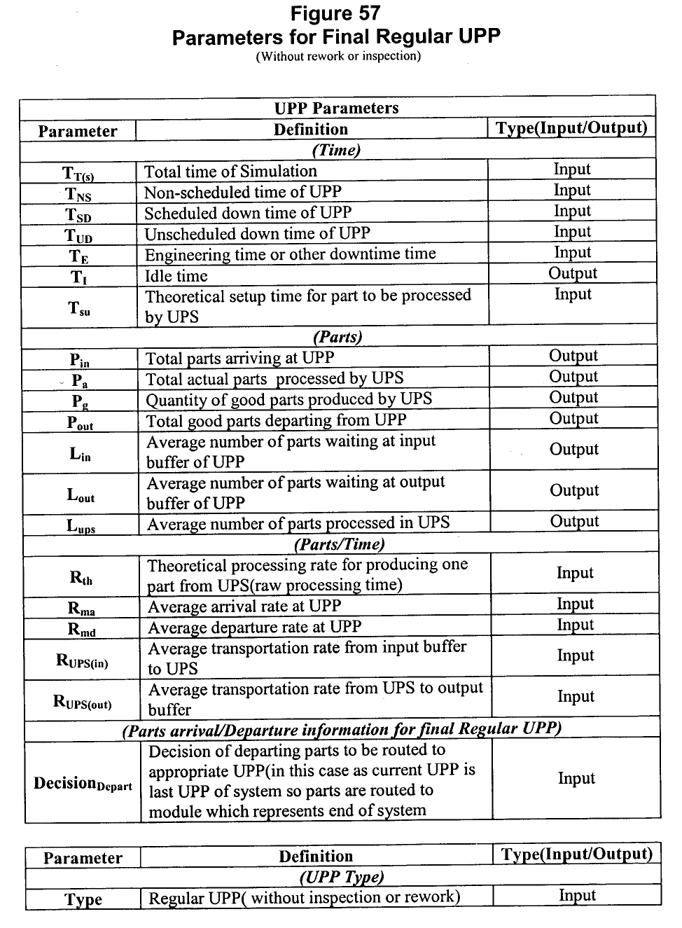

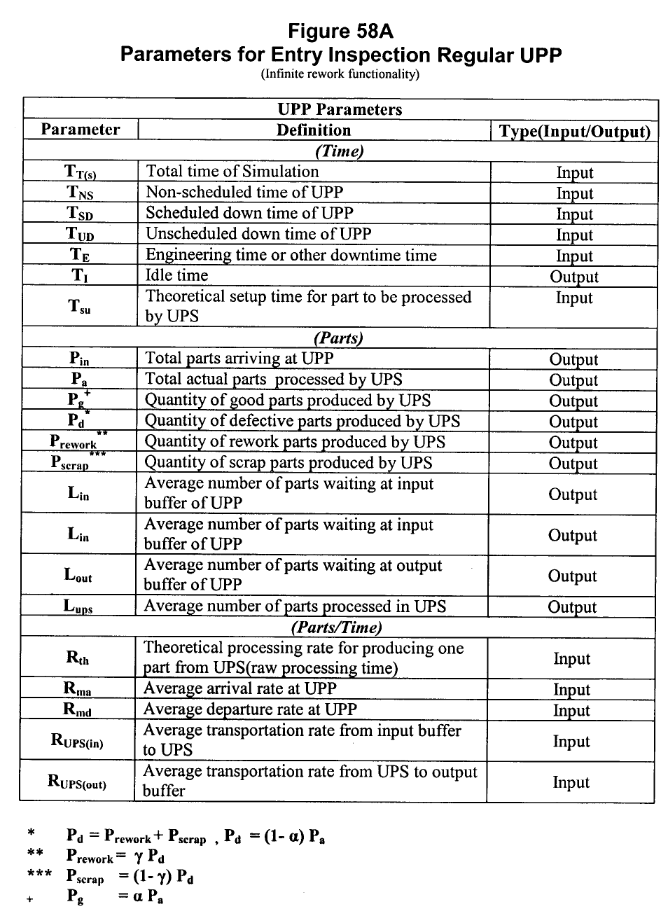

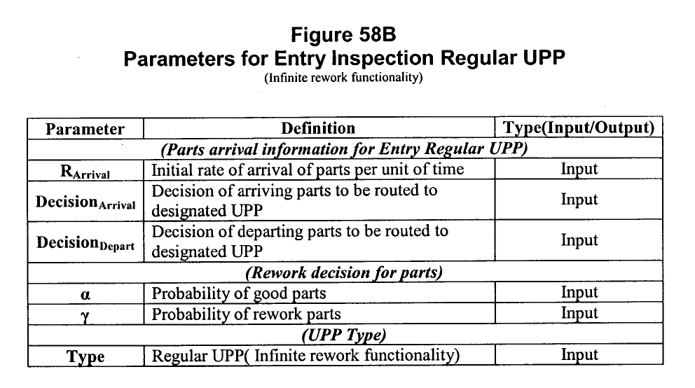

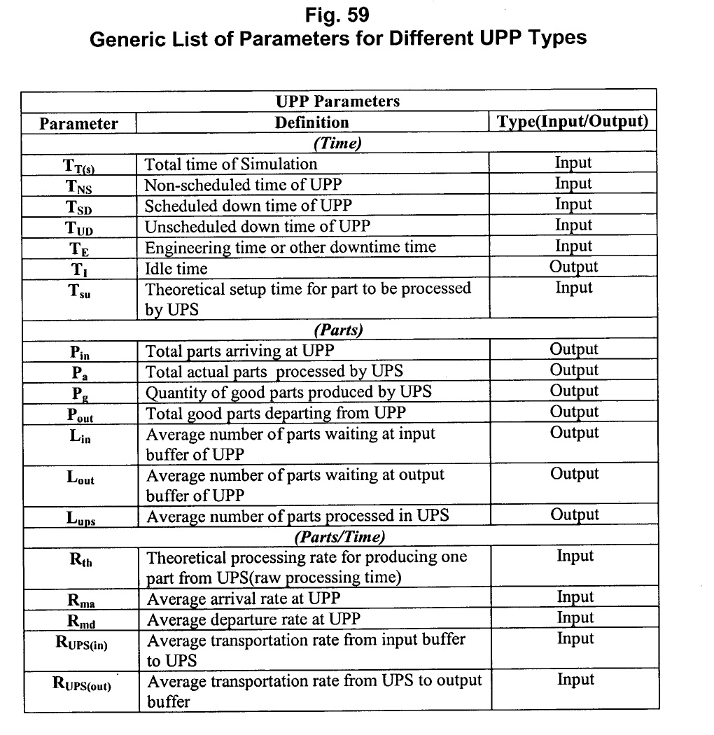

Arena provides feature to defined templates. Using templates, different types of manufacturing operations are represented in FIGS. 44A-54, where FIG. 59 contains a generic list of parameters for the different UPP types shown in FIGS. 44A-58. A template is created by modeling various modules provided by ARENA to define a particular manufacturing operation. Every template has a list of input parameters, as shown in FIGS. 55-58. The information about the template type, interconnectivity information and input parameters are directly exported from EFCPMT to Arena template model required format. Based on the information supplied from EFCPMT, simulation model (equivalent to EFCPMT model) is automatically built up in Arena. By single mouse click, simulation will proceed and results of simulation can be viewed and analyzed for different metrics calculations.

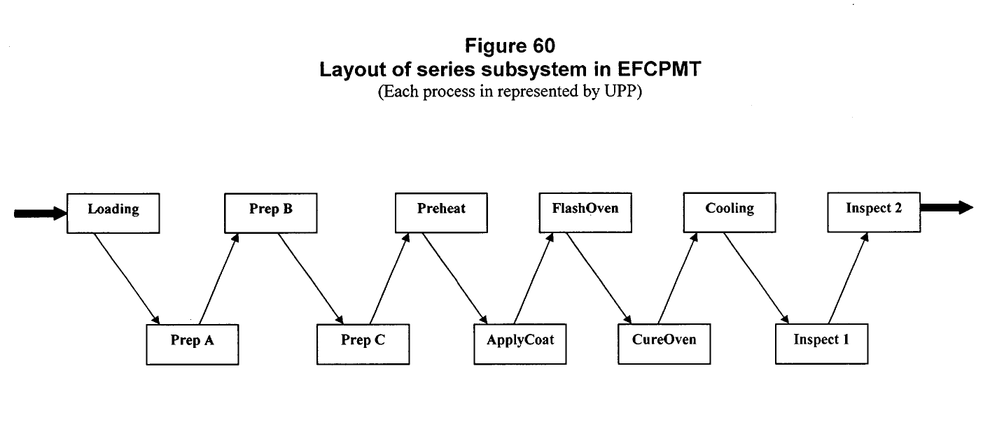

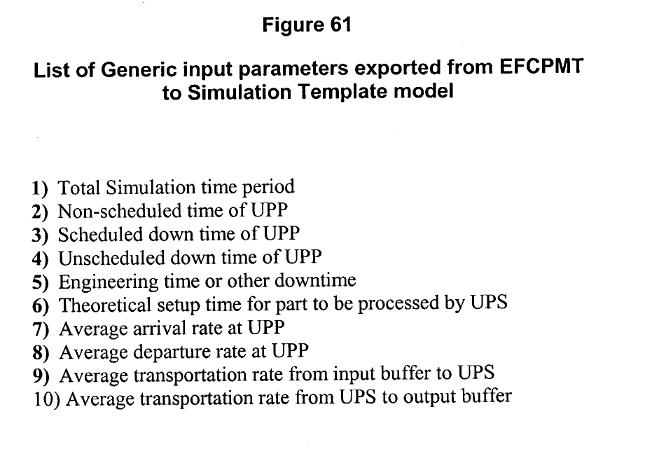

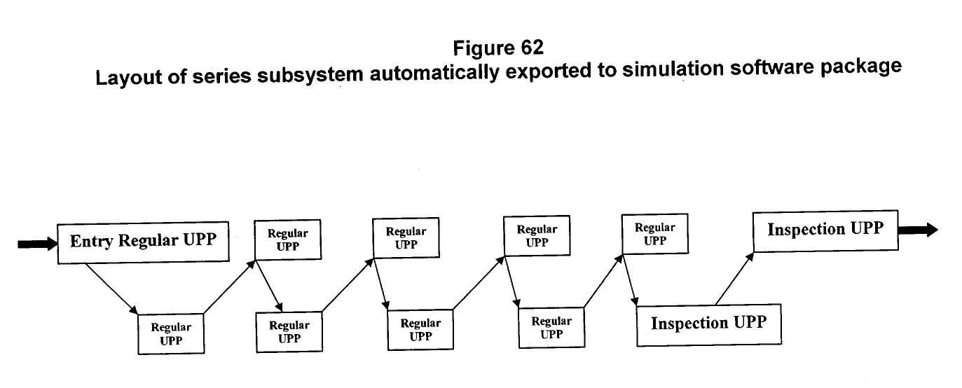

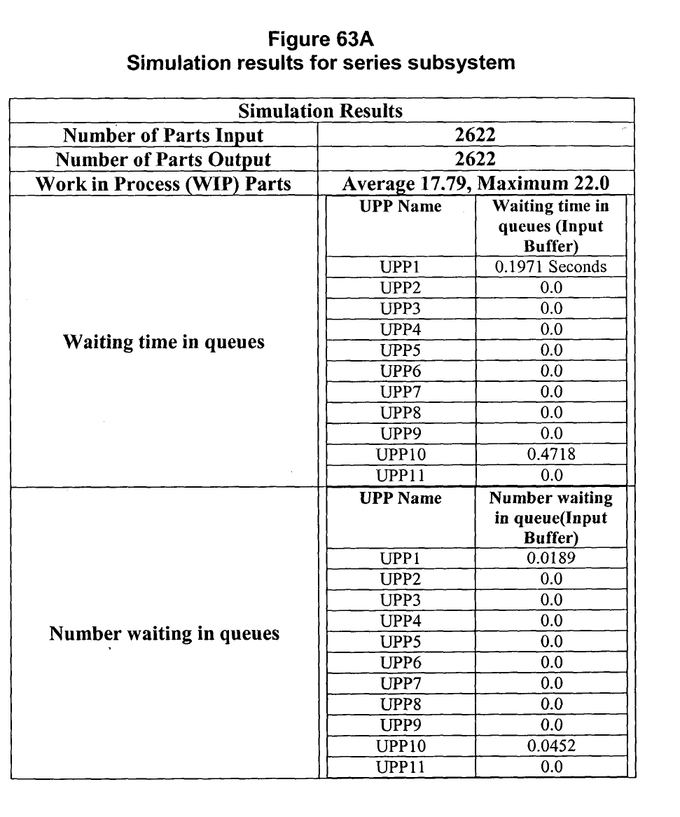

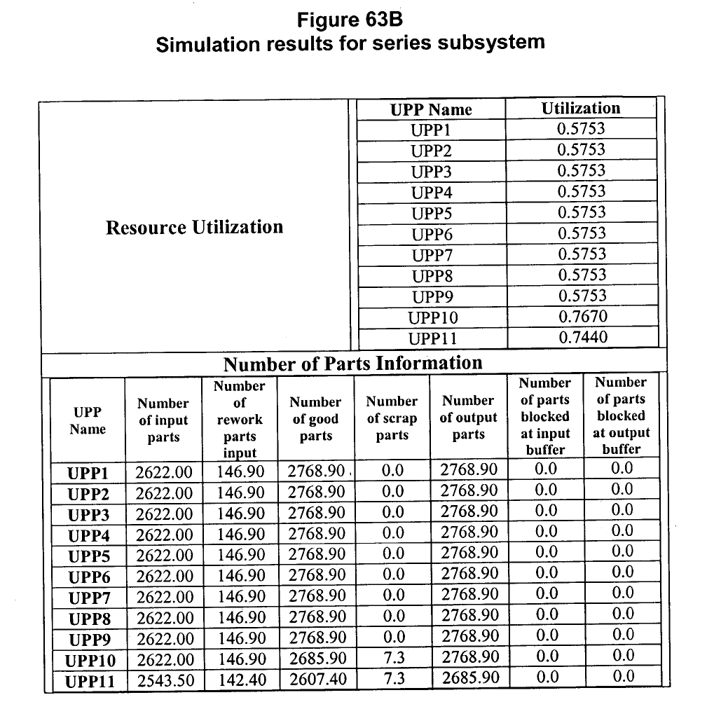

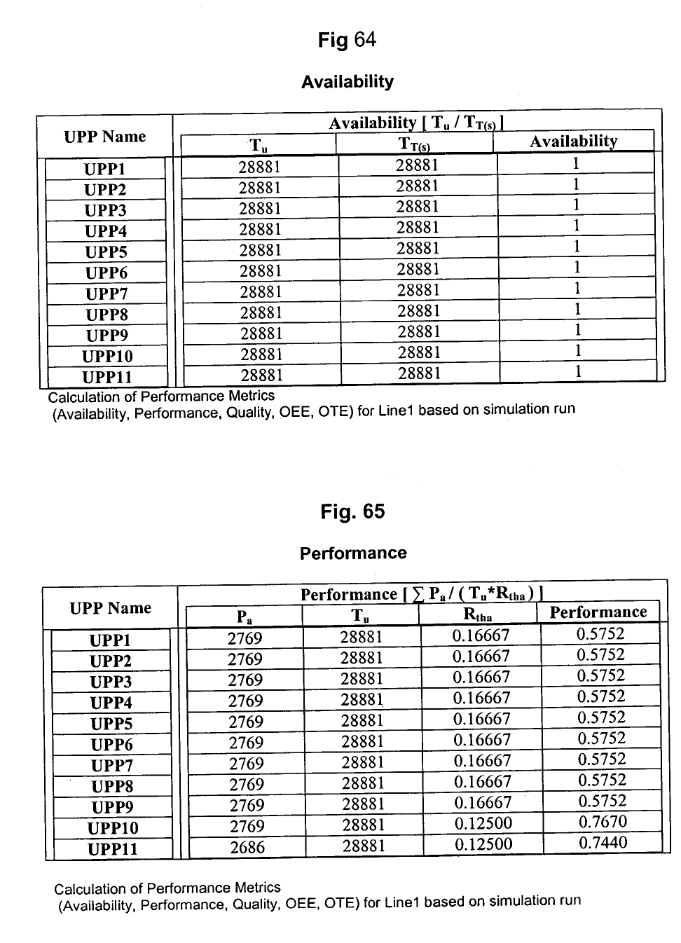

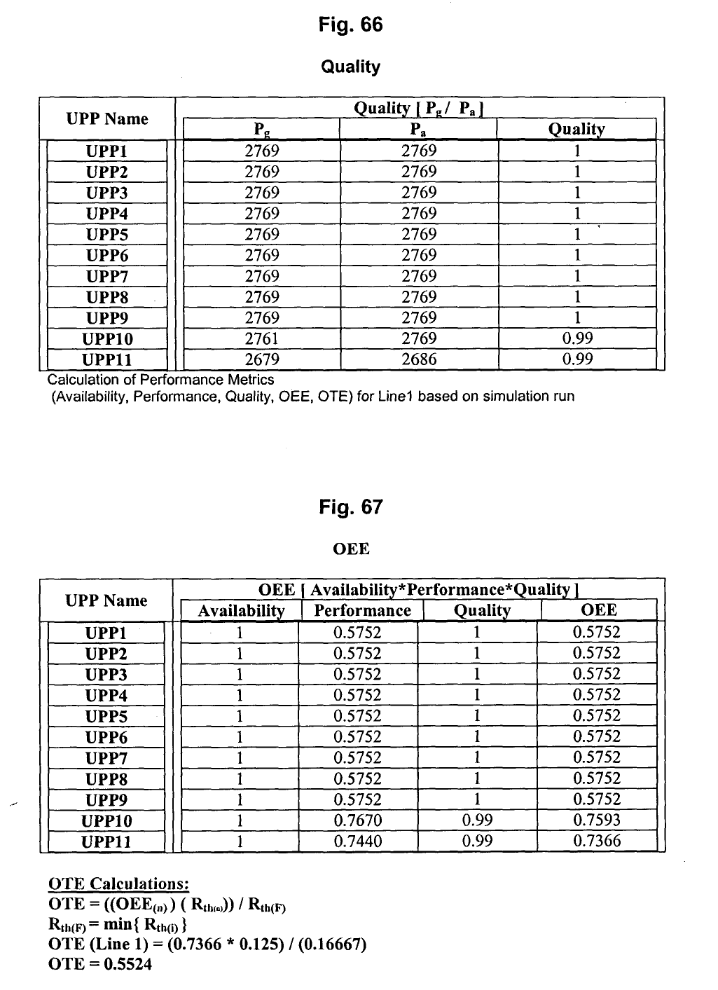

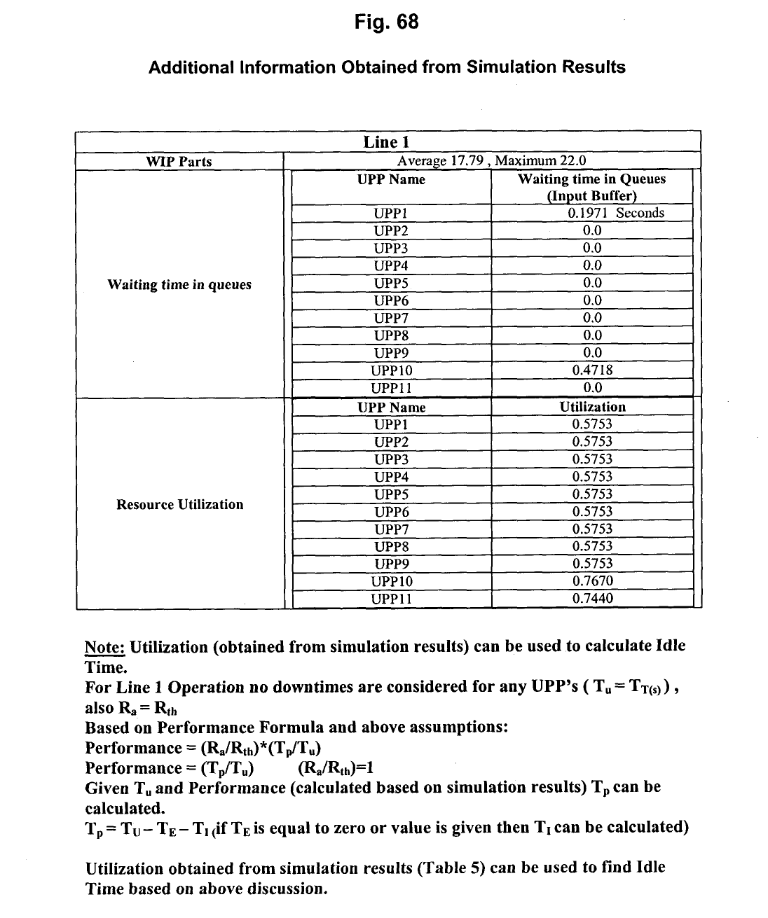

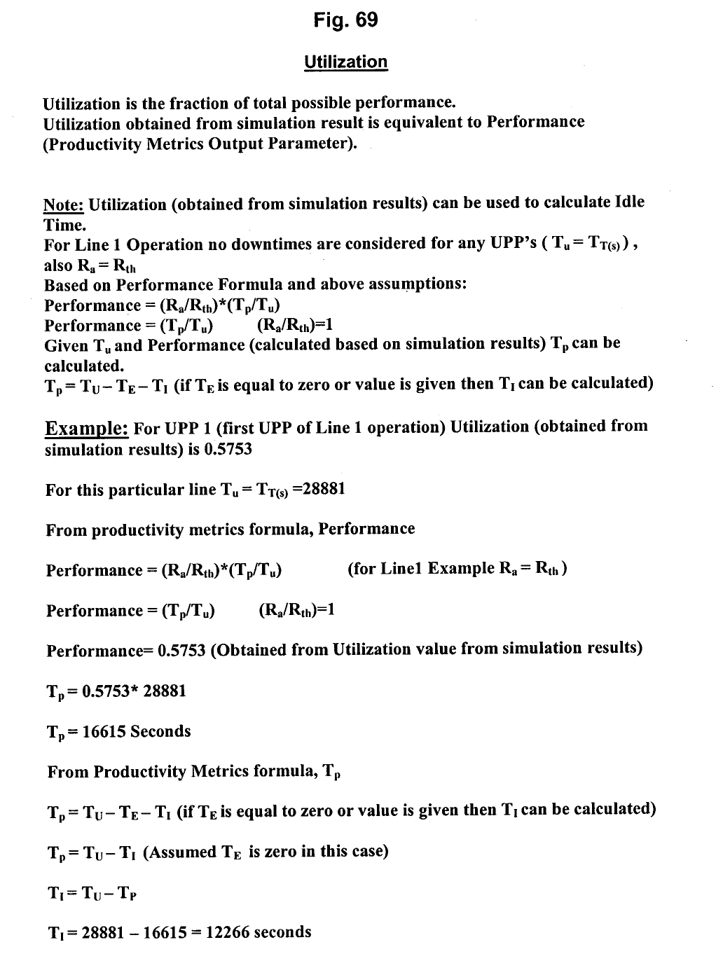

The methodology is explained with an example for series subsystem which consists of eleven regular UPP's arranged in series. For this example simulation run length is assumed to be eight hours and no downtimes are considered for any UPP. Using EFCMPT user flowchart the factory model, provide interconnectivity information and input parameters required for metrics calculations and simulation, as shown in FIGS. 60-61. This information is exported to Arena template model to automatically build equivalent factory flowchart in Arena, as shown in FIG. 62. Now the simulation model is run for an eight-hour shift, for example. Simulation results are represented in FIG. 63. Based on these simulation results metrics calculations are done, as shown in the tables in FIGS. 64-69. Also additional information obtained as result of simulation can be used to find some parameters required for productivity metrics calculations.

The illustrated example represents series subsystem. However, the method can be applied similarly to parallel, expansion, assembly and flexible subsystem also.

The example shown in FIG. 60 represents a series manufacturing operation. In this manufacturing setup, eleven UPP's are connected in series to represent a coating operation. The end user provides a layout of the factory using EFCPMT and supplies the required parameters for metrics calculations and simulation. If the end user decides to simulate the manufacturing operation, then the interconnectivity information of the manufacturing system and its intrinsic performance characteristics are exported to a suitable simulation software package, as shown in FIGS. 61 and 62. Once the factory model with the input parameters are exported to the simulation software package, the simulation can be done, as shown in FIG. 63A. The results are then available for analysis and calculation of metrics in EFCPMT, as shown in FIGS. 64-69.

In the third methodology, a custom simulation package is designed and built with advantageous features of simpler code and substantially reduced running time. First, the custom package eliminates most of the templates which are currently required to implement simulation using arena, and thus implements a system which is fairly close to the generic UPP model, which only has a few UPP types (e.g., regular, assembly, expansion). Second, with this custom built simulation, we optimize the simulator for simulation of product flow through a manufacturing system.

The benefits of the third methodology can be further understood by comparing it with the second methodology. In the second methodology, a description of the system architecture is exported from the analysis module, and is imported into the Arena environment, where UPPs are constructed from templates to model the factory layout based upon the imported specification. As described above, fifteen Arena templates are currently required to implement the model of a UPP. When more functionality is added, the number of templates to implement the UPPs grows further. This number of templates is necessary because of the way that Arena requires input into, output from, and rerouting through, the simulated system to be handled. This is a property of Arena and most of the discrete event simulation software packages, and not a property of the generic UPP model which is presented here. A custom simulation package requires only few UPP templates.

This custom built simulation package therefore eliminates much of the overhead that a generic simulation package, such as Arena, must incur. Currently, a simulation of a single production line over a year period with 10 replications would require approximately 3 days to complete. While useful, this is too long for most users. Thus, the custom discrete event simulation package of this invention in a high level language such as C++ or Java implements the generic UPP model presented here and achieves a significant improvement in performance by eliminating most of the unnecessary features of Arena. An optimized simulation package offers improvements in performance which allow the user to run multiple simulations over a year's worth of data, and receive results from the simulation within times of approximately one hour.

14. Flexible-Sequence Cluster Tools

A cluster tool is a manufacturing system made up of integrated processing modules (machines) mechanically linked together. There are two classes of clusters tools used in the semiconductor industry: fixed-sequence cluster tools and flexible-sequence cluster tools. Because instances of flexible-sequence cluster tools tend to be among the most complicated instances of semiconductor manufacturing equipment, at present there is no well defined and proven analysis techniques and models for measuring overall cluster tool performance.

The present invention provides a method for a systematic analysis of overall flexible-sequence cluster tool performance, based on rigorous application of unit-based OEE at the chamber level, for accurate material conservation. Productivity measurements of a model flexible-sequence cluster tool system utilizing these metrics provide insights into the dynamics of production essential for achieving both near term improvements and long term optimization.

The present invention provides more accurate OEE calculation for cluster tool chambers, independent of yield, and for the first time identifies a rigorously defined overall throughput effectiveness (OTE) for the tool, analogous to chamber level OEE.

14.1. Introduction

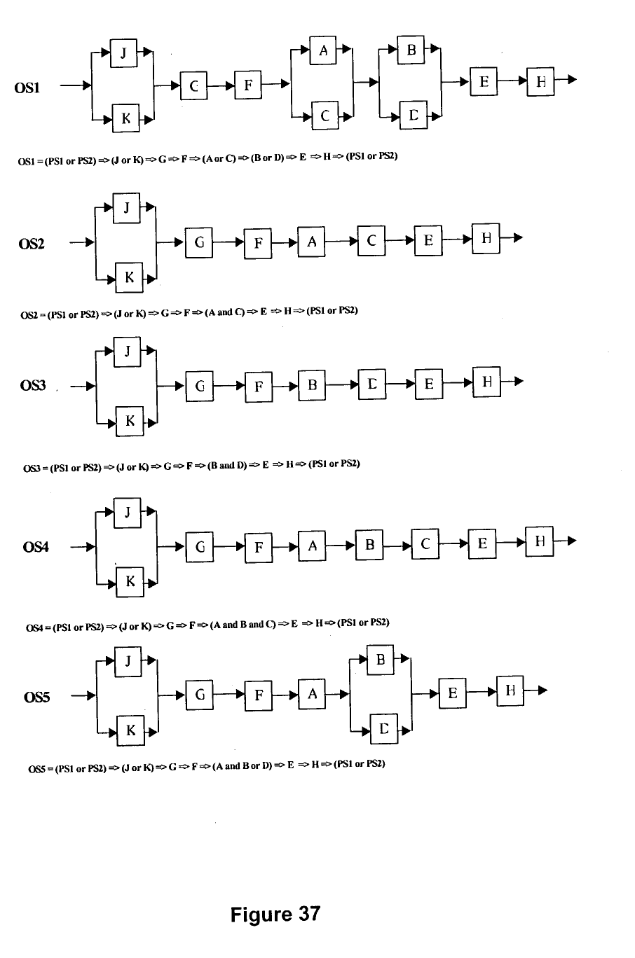

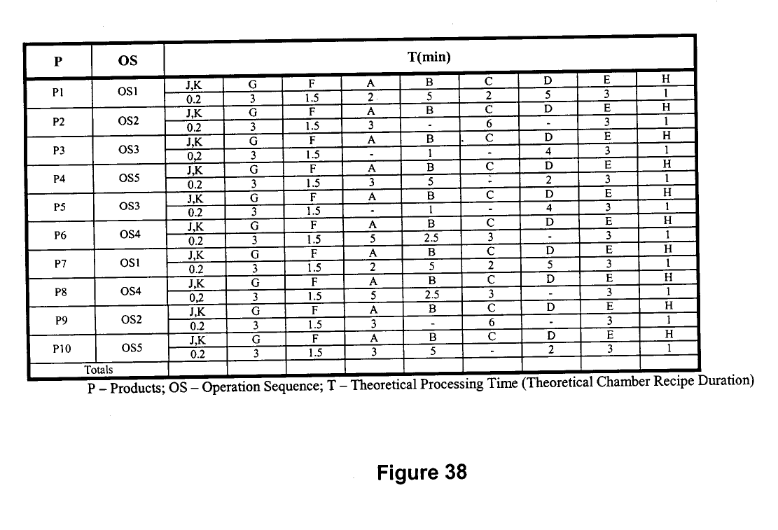

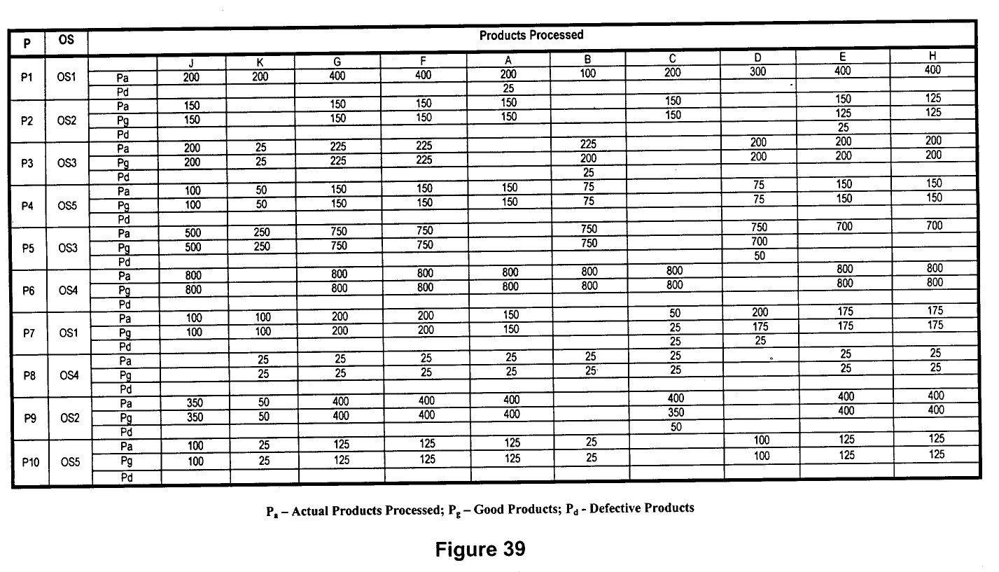

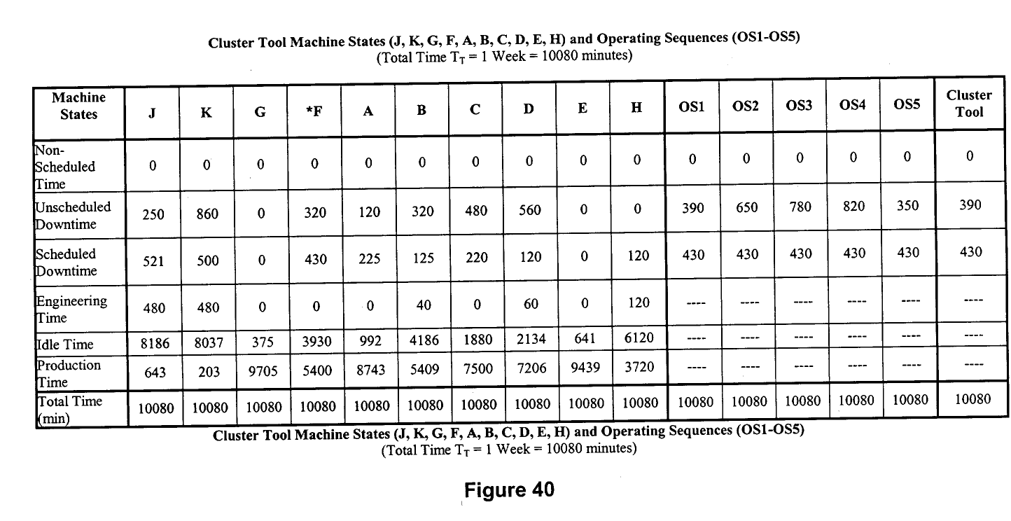

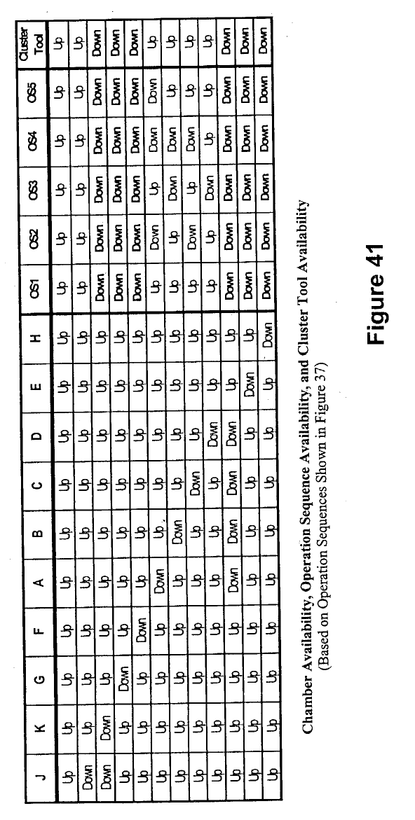

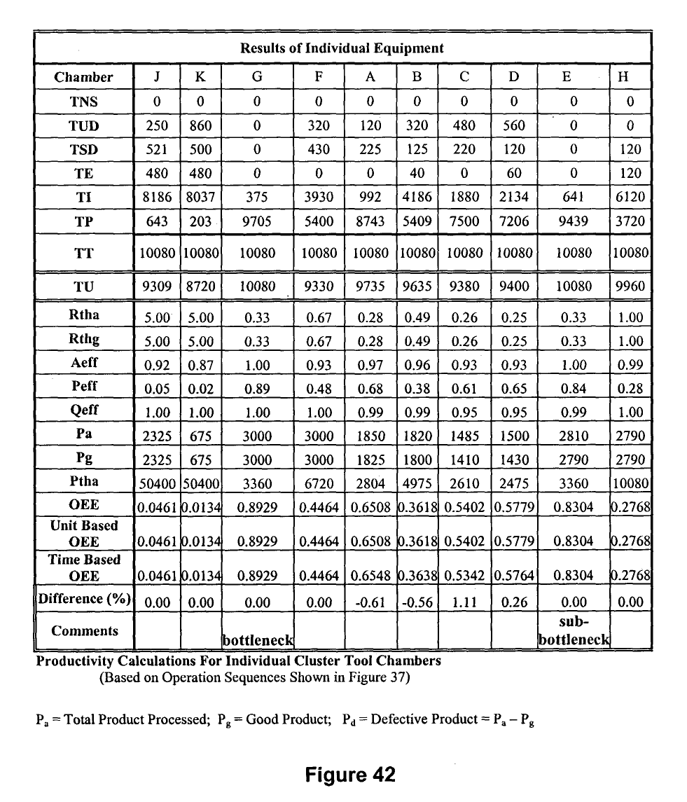

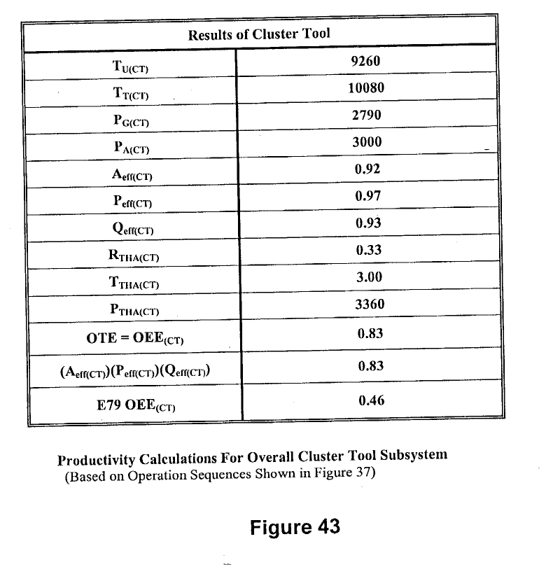

The cluster tool system analyzed and illustrated schematically in FIG. 36 (Configuration) and FIG. 37 (Operation Sequences) is representative of a cluster tool and is in wide-spread use throughout the semiconductor industry. It consists of 10 machines (chambers), which are named A through K, respectively. During the example observation period T_{T} (1 week=10080 minutes), a batch of ten different types of products (wafers), P1 through P10, is processed. There are five operation sequences (equipment sequences) which process the ten different products. These are designated OS1-OS5 in FIG. 37 and FIGS. 38-40. FIG. 38 lists the products, operation sequences, and theoretical processing times (theoretical chamber recipe duration) of a product at different machines. FIG. 39 lists the quantity of actual products processed, good products output, and defective product output of each machine. The data is contrived, but representative of what one could find in manufacturing conditions, except for the low quality numbers that are exaggerated to demonstrate their impact on yield and OEE.

FIG. 40 lists the time parameters for the cluster tool machine states, the operating sequences and the overall cluster tool subsystem. Note: F is the chamber all types of products processed in the Cluster Tool must go through. The “Uptime” of F chamber is only 9330 min. From the Aeff Table, if F is “Down” then the whole Cluster Tool is “Down” (Assume that each time a chamber is “Down”, the “Downtime” should be greatly longer than the processing time of any chambers in the Cluster Tool which is true for most manufacturing systems). This means that maximum “Uptime” for all 5 operation sequences and the Cluster Tool is 9330 min. Since the G chamber is the bottleneck of all 5 operation sequences (as described above, how to determine the bottleneck for each operation sequence and the average theoretical processing rate/time for the Cluster Tool) and the Cluster Tool, this implies that the minimum theoretical processing time of the Cluster Tool is 3 min. To better understand this conclusion, suppose there is a production line consisting of two machines (A and B). All products processed in the production line must go through the line from A to B. The total time observed is 1000 min., the Uptime for A is 1000 min. and for B is 500 min. The theoretical processing time for A is 5 min. and for B is 2 min. If each machine is analyzed in isolation, it looks like A can process 200 units and B 250 units. However, if B is “Down” then the whole line will be “Down” (remember that all products must go through A and B), the production time for B might not be more than 500 min. This implies that during the 1000 min., the throughput of the whole production line might not exceed 100 units. Therefore, during the 9330 min. “Uptime”, the Cluster Tool might not process more than 3110 units, which is less than the 3225 units from original data. This is the time constraint for the whole Cluster Tool, which may not be easily identified by analyzing chamber in isolation.

FIG. 41 summarizes the availability (up or down) of each chamber, operation sequence and the cluster tool.

FIG. 42 shows the measured times of machines at each of the six equipment states.

The model cluster tool calculations shed further insight into cluster tool productivity issues, including:

illustrating a typical operation of a cluster tool,

discovering bottleneck operations (chambers and operation sequences) as basis for improvement,

calculating the OEE of each chamber and compare the results based on unit based OEE methodology with that calculated for time based OEE (E79 methodology),

determining overall productivity of the cluster tool as a subsystem, by calculating a theoretically sound “cluster tool effectiveness” value, analogous to OEE for a chamber, designated as Overall Throughput Effectiveness, OTE.

14.2. System Configuration

The flexible-sequence Cluster Tool system configuration is shown in FIG. 36. It consists of 10 chambers, which are named A through K respectively, two product storages PS1 and PS2, and two transport module. During the observation period T_{T}, a batch of ten different types of products (wafers), P1 through P10 is processed. There are five operation sequences (equipment sequence) which would have been observed to process the ten different products and are shown in FIG. 37. For each operation sequence, different types of products (wafers) may be processed in either type-sequentia mode, in which all of the processing operations of one type are started before any processing operations of other types are allowed to begin or in type-parallel mode, in which processing operations from different types of products may be performed simultaneously. It is assumed that the two product storages and the two transport modules are operated so efficiently (transport times<<chamber times), during the observation period T_{T}, that they are not the bottleneck and have negligible impact on the performance of the 10 processing chambers.

14.3. Overall Cluster Tool Subsystem Productivity: Overall Throughput Effectiveness (OTE_{(CT)})

Metrics for measuring overall Cluster Tool productivity can be derived by extending the concept of unit-based OEE (see below), as a basis for metrics development at the overall cluster tool level.

By looking at the whole Cluster Tool as a higher level subsystem, which is an aggregate of its operation sequences, the overall throughput effectiveness (OTE_{(CT)}) of a Cluster Tool during the period of T_{T} can be defined as,

OTE_{(CT)}=[P_{g(CT)}]/[P_{a(CT)}^{(th)}] (1b)

where

P_{g(CT)} is the “total good product output (units) from the Cluster Tool during the period of T_{T}”; and

P_{a(CT)}^{(th)} is the “theoretical total product output (units) from the Cluster tool in a total time T_{T}”.

This OTE metric measures the true productivity of cluster tool system, because it is based on a correct calculation of average theoretical processing rate of the Cluster Tool. In Equation (1b), P_{a(CT)}^{(th)} is given as,

P_{a(CT)}^{(th)}=(R_{avg(CT)}^{(th)})(T_{T}) (2b)

where R_{avg(CT)}^{(th)} is defined as the average theoretical processing rate for total product output from the Cluster Tool during the period of T_{T}. As shown in Equation (2b), if R_{avg(CT)}^{(th)} can be calculated then the overall throughput effectiveness (OTE) of a Cluster Tool can be calculated directly from the measured P_{g(CT)} and calculated P_{a(CT)}^{(th)} without the use of any other factors. The next section will illustrate how to calculate the average theoretical processing rate for each operation sequence and R_{avg(CT)}^{(th)}.

14.4 Methodology for Calculating Average Theoretical Processing Rates

To be able to calculate the Cluster Tool OTE, the average theoretical processing rate (R_{avg(CT)}^{(th)}) for actual product output from the Cluster Tool and the average theoretical processing rate for actual product output from each operation sequence must be uniquely calculated. However, due to the complex nature of flexible-sequence Cluster Tool, accurately determining the average theoretical processing rate for flexible-sequence Cluster Tool is a challenge since there is no published standard or common understanding on how to accomplish this. Here, a methodology is proposed for calculating the average theoretical processing rate (R_{avg(CT)}^{(th)}) for actual product output from the Cluster Tool and the average theoretical processing rate for actual product output from each operation sequence. The methodology is summarized by the following steps:

1) Identify all operation sequences used to process products during the observation period T_{T}. Each operation sequence will consist of some combination of Series-Connected and Parallel-Connected subsystems (refer to Su et al., 2002 for detail) and each Series-Connected or Parallel-Connected subsystem consists of some chambers and pseudo-chambers as shown in FIG. 37. The pseudo-chamber in an operation sequence is defined as a chamber that is shared by more than one operation sequence.

2) Calculate the “isolated” average theoretical processing rates of chamber and pseudo-chambers in Series-Connected subsystem for all operation sequences by using the following equation.

$${R}_{iso ( ij )}^{S ( th )} = \frac{{P}_{a ( i )}}{{\sum }_{i} \frac{{P}_{a ( i )}}{{R}_{avg ( ij )}^{( th )}}} \qquad ( 3 b )$$

where R_{iso(g)}^{S(th)} is the “isolated” average theoretical processing rate of operation sequence i and chamber j in Series-Connected subsystem; R_{avg(ij)}^{(th)} is the average theoretical processing rate of operation sequence i and chamber j; and Pₐ₍ᵢ₎ is the total product output/processed (units) from operation sequence i in a total time T_{T}.

Note that the “isolated” average theoretical processing rate of a pseudo-chamber is the average theoretical processing rate for the actual product output from the pseudo-chamber in an operation sequence as if its operation were completely separated or independent from other operation sequences.

3) Calculate the “isolated” average theoretical processing rates of chamber and pseudo-chambers in Parallel-Connected subsystem for all operation sequences by using the following equation.

$${R}_{iso ( ij )}^{P ( th )} = \frac{{P}_{ath ( ij )}}{{\sum }_{i} \frac{{P}_{ath ( ij )}}{{R}_{avg ( ij )}^{( th )}}} \qquad ( 4 b )$$

where Rᵢₛₒ₍ᵢⱼ₎^{P(th)} is the “isolated” average theoretical processing rate of operation sequence i and chamber j in Parallel-Connected subsystem; and Pₐₜₕ₍ᵢⱼ₎ is the total theoretical product output/processed (units) from operation sequence i and chamber j in a total time T_{T} and can be determined by

$${P}_{ath ( ij )} = \frac{( {P}_{a ( i )} ) ( {R}_{avg ( ij )}^{( th )} )}{{\sum }_{j ∈ Par ( i )} {R}_{avg ( ij )}^{( th )}} \qquad ( 5 b )$$

where Par₍ᵢ₎ represents a Parallel-Connected subsystem in operation sequence i.

4) Calculate the “isolated” average theoretical processing rate of each operation sequence (refer to Su et al., 2002 for detail).

Note that the “isolated” average theoretical processing rate of an operation sequence is the average theoretical processing rate for the actual product output from the operation sequence as if its operation were completely separated or independent from other operation sequences.

Finally, sum up the “isolated” average theoretical processing rate of each operation sequence to obtain the average theoretical processing rate of Cluster Tool (R_{avg(CT)}^{(th)}).

14.5 Alternate Calculation of OTE_{CT}

Calculating OTE of a Cluster Tool, as described above, provides a general overview of the productivity status of the higher level sub-system without quantifying the “efficiency” components that contributed to the result. No accurate methodology is published in literature for determining the availability efficiency, performance efficiency, and quality efficiency of a Cluster Tool. Efficiency computations, such as in E79, consider averaging the components from each equipment to provide aggregate results.

Since the present invention there is now a methodology for determining the average theoretical processing rate of Cluster Tool, it is possible to calculate availability, performance, and quality efficiencies of Cluster Tool.

14.5.1 Cluster Tool Availability Efficiency (A_{eff(CT)})

By extending the E10 definition of “Up” for equipment, that is “when the equipment is in a condition to perform its intended function”, an operation sequence is “Up” when its chambers or psuedo-chambers are in a condition that allow the operation sequence to perform its intended function, and a Cluster Tool is “Up” when its operation sequences are in a condition to perform its intended function (see FIG. 40), the availability efficiency of the Cluster Tool would be defined as

$${A}_{eff ( CT )} = \frac{{T}_{U ( CT )}}{{T}_{T}} \qquad ( 6 b )$$

where T_{U(CT)} is the uptime for the Cluster Tool during the period of T_{T}.

FIG. 41 demonstrates how to determine the “Up” states for the five operation sequences described in FIG. 37 and the Cluster Tool shown in FIG. 36. Note that as long as at least one of the five operation sequences is “Up”, the Cluster Tool is “Up” and the productivity loss due to the loss of some operation sequences (no all of them) is reflected in performance efficiency rather than the availability efficiency. The uptime for the Cluster Tool during the period of T_{T} can also be calculated by

T_{U(CT)}=T_{T}−T_{D(CT)}−T_{NS(CT)} (7b)

where T_{D(CT)} is the downtime (including scheduled and unscheduled downtime) for the Cluster Tool during the period of T_{T}; and T_{NS(CT)} is the nonscheduled time for the Cluster Tool during the period of T_{T}. FIG. 40 provides the data used in this example.

14.5.2 Cluster Tool Performance Efficiency (P_{eff(CT)})

By extending the concept of the conventional OEE for individual equipment (i.e. chamber) to the subsystem level (i.e. cluster tool), the performance efficiency of the Cluster Tool would be defined as,

$${P}_{eff ( CT )} = \frac{{P}_{a ( CT )}}{{R}_{avg ( CT )}^{th} {T}_{U ( CT )}} , \qquad ( 8 b )$$

where P_{a(CT)} is the total actual product (units) processed by the Cluster Tool during the period of T_{T}.

14.5.3 Cluster Tool Quality Efficiency (Q_{eff(CT)})

By extending the concept of the conventional OEE for individual equipment (i.e. chamber) to the subsystem level (i.e. cluster tool), the quality efficiency of the Cluster Tool would be defined as

$${Q}_{eff ( CT )} = \frac{{P}_{g ( CT )}}{{P}_{a ( CT )}} \qquad ( 9 b )$$

14.6. Calculation of Cluster Tool Subsystem (OTE_{(CT)})

The availability efficiency, performance efficiency, quality efficiency and OEE of each chamber (J, K, G, F, A, B, C, D, E, and H) of the cluster tool are calculated and shown in FIG. 42. Continuing with the extension of the concept of the conventional OEE for individual equipment (i.e. chamber) to the subsystem level (i.e. cluster tool), the overall throughput effectiveness of the Cluster Tool can be defined as,

OTE_{(CT)}=(A_{eff(CT)})(P_{eff(CT)})(Q_{eff(CT)}) (10b)

or,

OTE_{CMS}=A_{(CMS)}·P_{(CMS)}·Q_{(CMS)}

which will be applied in the analysis of overall cluster tool subsystem performance in the next section.

14.7. Cluster Tool Productivity Analysis

14.7.1 Productivity and OEE of Process Chambers

The availability efficiency, performance efficiency, quality efficiency and OEE of each chamber (J, K, G, F, A, B, C, D, E, and H) of the cluster tool are calculated and shown in FIG. 42. The Unit Based OEE (see below) which is the basis for overall cluster tool analysis, is equal to conventional OEE. Unit Based OEE (OEE_{UB}) is equal to Time Based OEE (OEE_{TB}) for Chambers J, K, G, F, E, and H. There is a difference between these two quantities for Chambers A, B, C, and D, for which the Q differs from 100%. Although these differences are small, when yields are reduced to the order of 80%, then very substantial differences in OEE_{UB} and OEE_{TB} occur because OEE is defined as an effective ratio of product output, not as a ratio of times. By inspection, Chamber G is the bottleneck chamber, and Chamber E is a sub-bottleneck.

14.7.2 Productivity and OTE of Cluster Tool

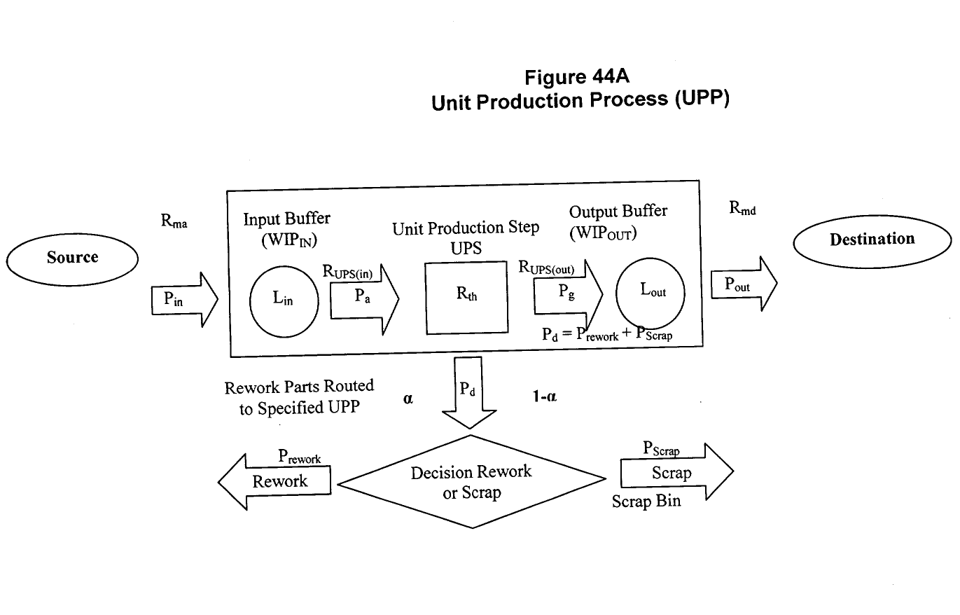

The results of the overall cluster tool analysis, shown in FIG. 43, are based on the methodology described and on the Sematech E79 Standard (E79 Rev. 2000).

The overall cluster tool A_{eff(CT)}, P_{eff(CT)}, and Q_{eff(CT)} are calculated from equations (7b), (8b) and (9b) as discussed above. The value of OTE=OEE_{(CT)} is calculated from Equation (1b),

OTE_{(CT)}=[P_{g(CT)}/P_{THA(CT)}].

This value, 0.83, can be seen to be equal to that calculated as the product of cluster tool availability, performance and quality.

The E79 OEE_{(CT)} is calculated as an average of the OEE values for each of the chambers, per the E79 specification. This value, calculated as 0.46, provides some indication of productivity. However it lacks a rigorous quantitative underpinning, and thus does not give the correct relation between good product output and the subsystem level processing rate of the cluster tool.

The total products processed during total time T_{T} are 3000 units, the total good product output is 2790 units, the total “Uptime” of the Cluster Tool is 9260 minutes. To find out how to calculate the “Uptime” of the Cluster Tool, refer to Aeff Table (FIG. 41) and Machine States Table (FIG. 42).

The present invention provides an analytical approach to get insight into the complex nature of the flexible-sequence Cluster Tool by theoretically analyzing the average theoretical process rate/time (R_{THA(CT)}/T_{THA(CT)}), the Availability Efficiency (A_{eff(CT)}), the Performance Efficiency (P_{eff(CT)}), and the Quality Efficiency (Q_{eff(CT)}) for the whole Cluster Tool. After comparing OTE to E79 OEE_{(CT)}, there is a significant difference between OTE and E79 OEE_{(CT)} (about 45%). By using the Availability Efficiency (A_{eff(CT)}) and the quality Efficiency (Q_{eff(CT)}) (these two metrics should not have significant difference between OTE and E79), the E79 Performance Efficiency may be about 0.54. If more products are loaded into the Cluster Tool (trying to keep Cluster Tool as busy as possible to improve the performance for a stand-alone equipment) then the Cluster Tool would have processed more products and had more good product throughput (assume it is not known the G is the bottleneck for whole Cluster Tool). However, under current product mix this would be impossible unless the capacity of chamber G is increased.

14.8 Unit Based OEE Compared to Time Based OEE

The value of Unit Based OEE, which is indeed equal to conventional OEE defined by,

Conventional OEE=A_{eff}*P_{eff}*Q_{eff}≦1,

has been described above. The OEE_{UB} has proved very sound and useful in algorithms and metrics for measuring subsystem level and factory level productivity, in particular the Overall Throughput Effectiveness (OTE) which might also be termed “factory level OEE”, since it measures the fraction of the theoretical factory throughput which is achieved. Unit Based OEE can be defined as,

OEE_{UB}=P_{g}/Pₜₕₐ, where Pₜₕₐ=(Rₜₕₐ)(T_{T}) is the theoretical actual product output units in T_{T}. Time Based OEE can be defined as,

OEE_{TB}=T_{g}/T_{T} where T_{g}=P_{g}/R_{thg}.

In this equation P_{g} is the good product output units, and R_{thg} is the average theoretical processing rate for good product. The two metrics are mathematically related by the expression,

$$\frac{OEE ( Unit Based )}{OEE ( Time Based )} = \frac{{R}_{thg}}{{R}_{tha}} .$$

As the names indicate, the difference between unit-based and time-based OEE lies in the emphasis on mass-balanced product throughput (unit-based) or on time utilization (time-based). To illustrate this, the three factors composing OEE are examined: Availability, Performance and Quality. Availability and Performance efficiency are the same for both unit-based and time-based definitions. Quality, however, is defined differently. Unit-based Quality efficiency is simply the ratio of total good parts produced to total parts produced, and hence

$$Q = \frac{{\sum }_{j = 1}^{k} {P}_{g ( j )}}{{\sum }_{j = 1}^{k} {P}_{a ( j )}}$$

correctly represents material balance: P_{g}=Pₐ−P_{d}.

Time-based quality efficiency, on the other hand, weights each part type processed in the machine by the individual processing rate for each part, so that it represents a ratio of times.

$$Q = \frac{{\sum }_{j = 1}^{k} \frac{{P}_{g ( j )}}{{R}_{th ( j )}}}{{\sum }_{j = 1}^{k} \frac{{P}_{a ( j )}}{{R}_{th ( j )}}}$$

Since OEE is the product of the three factors (A, P and Q), it follows that OEE in general will have two different values depending on whether unit-based or time-based quality definition is used.

Note, however, that unit-based OEE and time-based OEE are mathematically identical if any one of the following four special conditions is obeyed:

Condition 1. Only one product type is being processed by the UPP during time T_{T},

Condition 2. The theoretical raw processing rates are equal for all product types processed by the UPP during time T_{T}, Rₜₕ₍₁₎=Rₜₕ₍₂₎= . . . Rₜₕ₍ⱼ₎=Rₜₕ₍ₖ₎

Condition 3. The Quality Efficiency (Q) of all product types is equal

$$\frac{{P}_{g ( 1 )}}{{P}_{a ( 1 )}} = \frac{{P}_{g ( 2 )}}{{P}_{a ( 2 )}} = \frac{{P}_{g ( j )}}{{P}_{a ( j )}} = Λ = \frac{{P}_{g ( k )}}{{P}_{a ( k )}}$$

Condition 4. The yield of all product types during time T_{T} is 100%, i.e. P_{g}=Pₐ.

15. PLABC Costing: Introduction and Background for Historical Development of Activity Based Costing (ABC) Concept.

The traditional cost accounting (TCA) methodology [67,84] used during most of the 20^{th} Century represented the manufacturing cost of a product as the sum of direct costs (labor and material) and indirect costs or overhead (the sum of all other factory and company costs). In spite of a simplistic allocation of overhead or indirect costs to a product based on direct labor hours, the TCA methodology, FIG. 71, provided a reasonably accurate product cost for simple organizations producing only one product. However, for today's complex industrial organizations producing multiple products with smaller amounts of direct labor, it does not provide an accurate or true product cost. In this case, indirect costs often exceed direct costs, and the methodology of allocating indirect costs to products in proportion to direct labor costs leads to serious errors (from +200% to −1000%) in calculated product cost [81]. Hence TCA systems in the current complex, worldwide competitive environment can lead to erroneous management decisions regarding optimum product and pricing strategy [49,54,72-73,82,84,87].

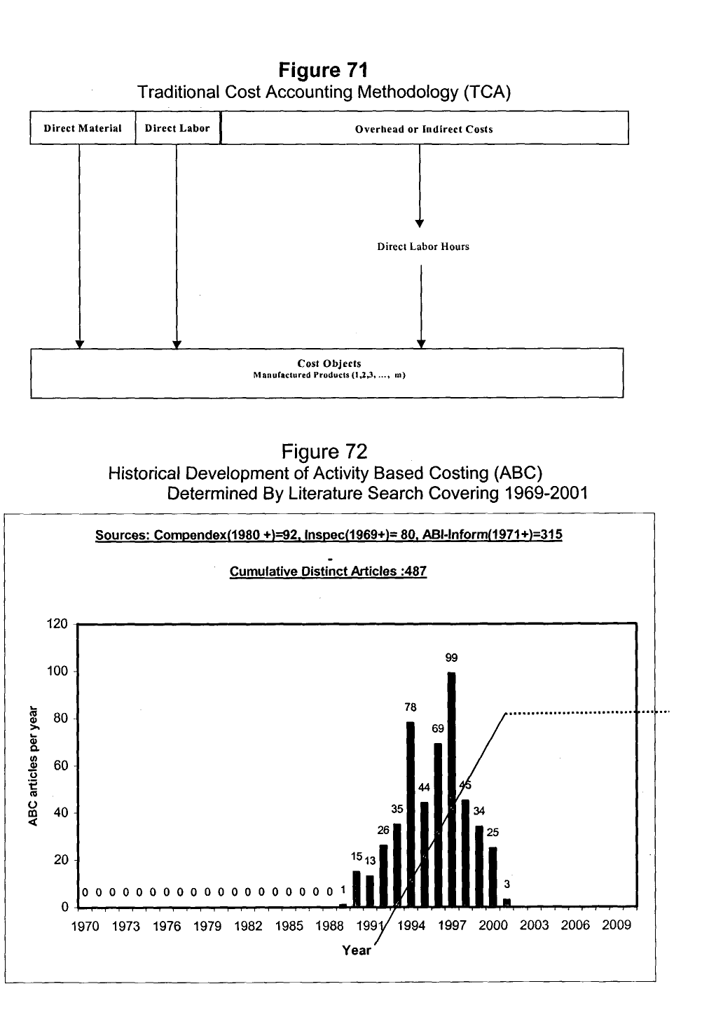

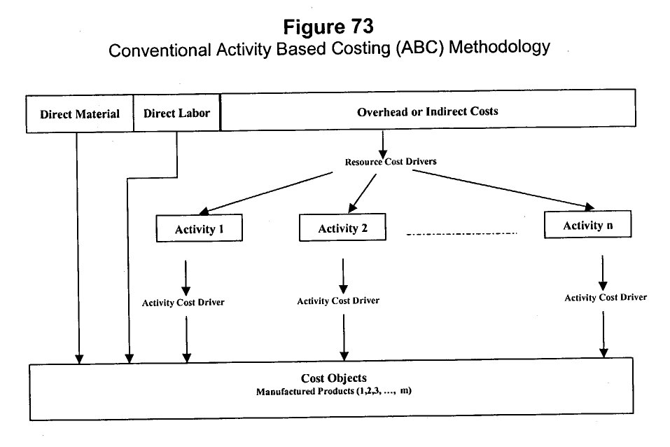

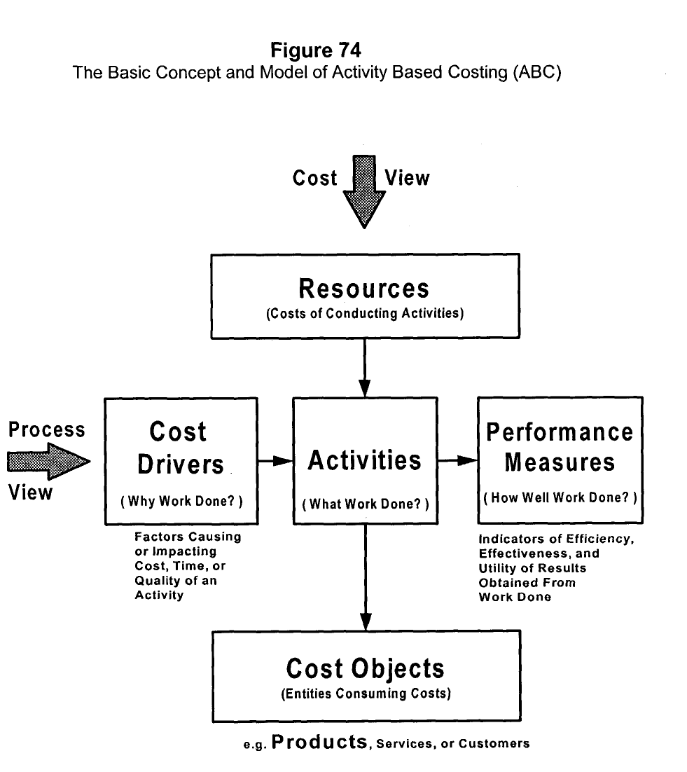

FIG. 72 documents the increased academic research and industrial application of activity based costing (ABC), as measured by the large number (458) of journal and book publications from 1989 to 2001. The Reference list [38, 42-88] includes approximately 50 of the key journal publications and books dealing with ABC theory, development and application. The first publication appeared in 1989, followed by an increase to 99 publications in 1997, and a decrease to an average of 34/year in the years 1998-2000. This literature indicates that the ABC methodology is finding increased usage in manufacturing industries because if properly implemented, it can accurately calculate the true cost of a product based on the sum of direct and indirect costs [49,54,72-73,81,84]. To do this, the conventional ABC methodology, FIG. 73, first uses resource cost drivers to correctly allocate overhead or indirect costs to activities performing the work. It then uses activity cost drivers to correctly relate costs at each activity to each manufactured product type. FIG. 74 describes in more detail the basic concept and model of ABC, showing in the vertical “Cost View” direction the relation of Resources to Activities to Cost Objects/Products, and in the horizontal “Process View” direction the relation of Cost Drivers to Activities to Performance Measures. In addition to more accurately allocating consumed resources (i.e. costs) to products, the ABC methodology provides for the use of performance measures to determine how well the work was done.

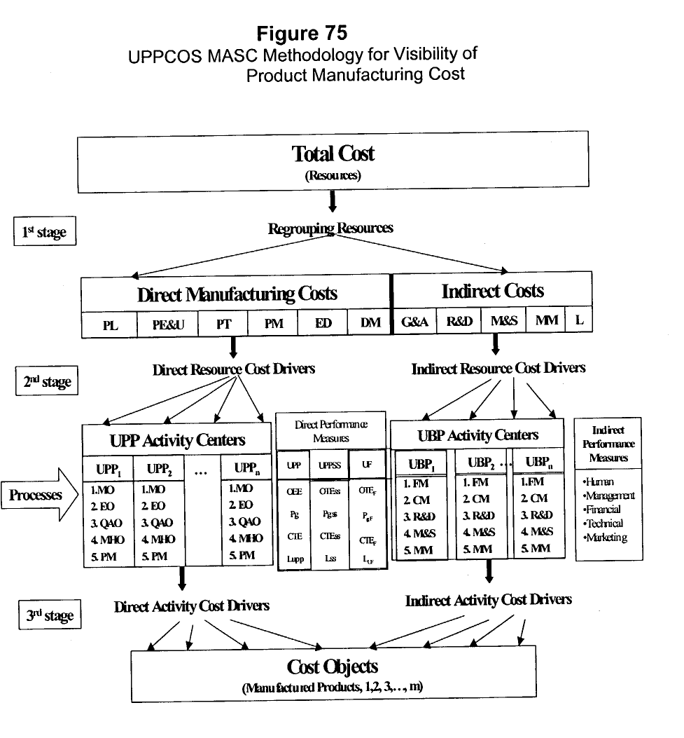

Existing ABC methodologies have provided a better understanding of true product cost, but have not thus far quantitatively linked manufacturing productivity and organizational productivity to true product cost in such a way that the dependence of product cost on performance can be mathematically modeled. This invention illustrates a UPPCOS MASC Methodology (FIG. 75) to accomplish this linking both for direct manufacturing cost and for indirect cost, and thereby enable improved understanding of the relation of performance measures (FIG. 74) to productivity. In this methodology, total cost is defined as the sum of direct manufacturing cost and indirect cost.

15.1 Direct Manufacturing Cost

The approach to integrate manufacturing productivity measurement [37-39,41] with the direct manufacturing cost component of a product, consistent with ABC principles, is based on:

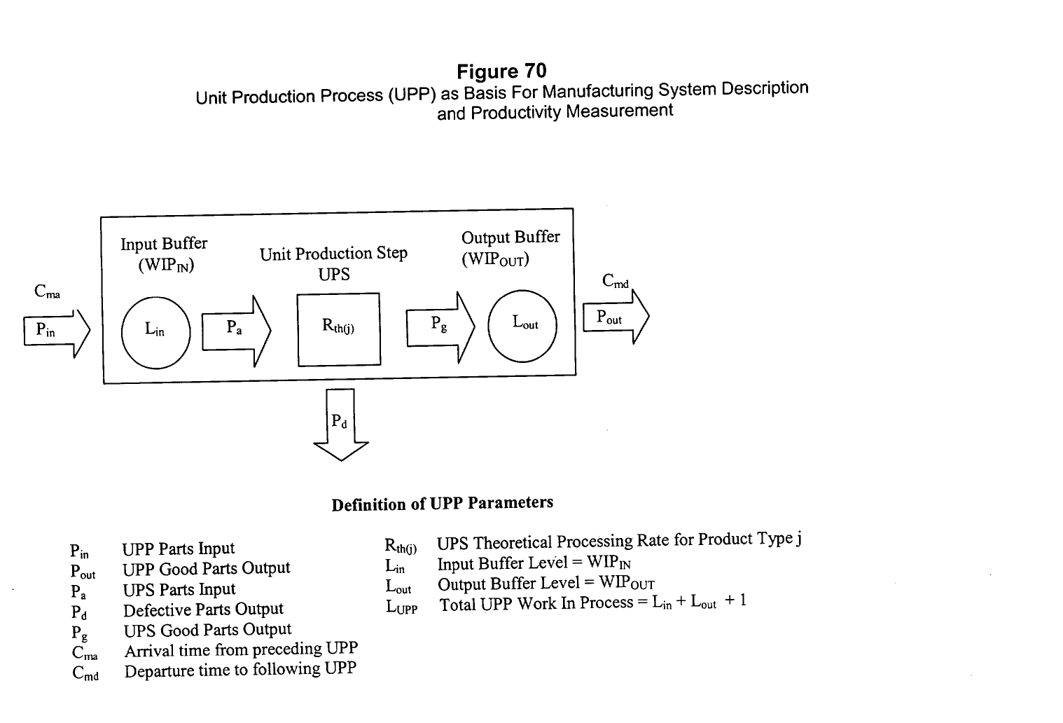

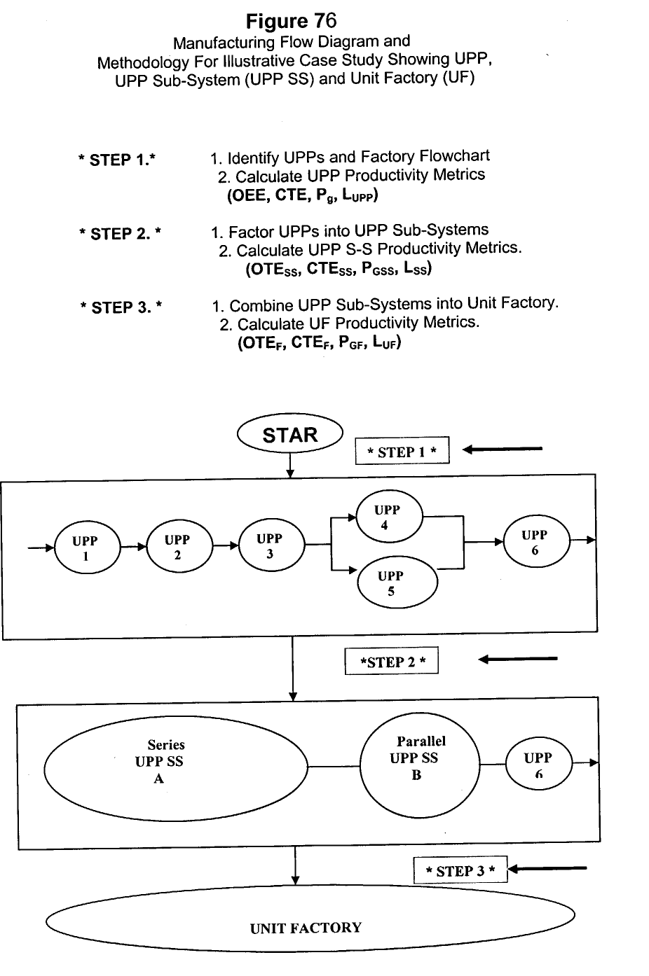

1. Flow charting the manufacturing system to establish the material flow relation between each UPP (FIG. 70) in the factory, combined with factoring the factory architecture into standard configurations or UPP Sub-Systems (UPP SS) for improved productivity representation. This example applies the method to production data for an illustrative example of a model factory flow-charted in FIG. 76.

2. Developing a methodology for quantitative measurement of product direct manufacturing cost by using appropriate cost drivers to trace direct manufacturing costs first to UPP activity centers, and then to the products. This portion of the approach is also described in the illustrative example of the model factory flow-charted in FIG. 76.

15.2 Indirect Cost

The approach to integrate organizational productivity measurement with the indirect cost component of a product, consistent with ABC principles, is based on:

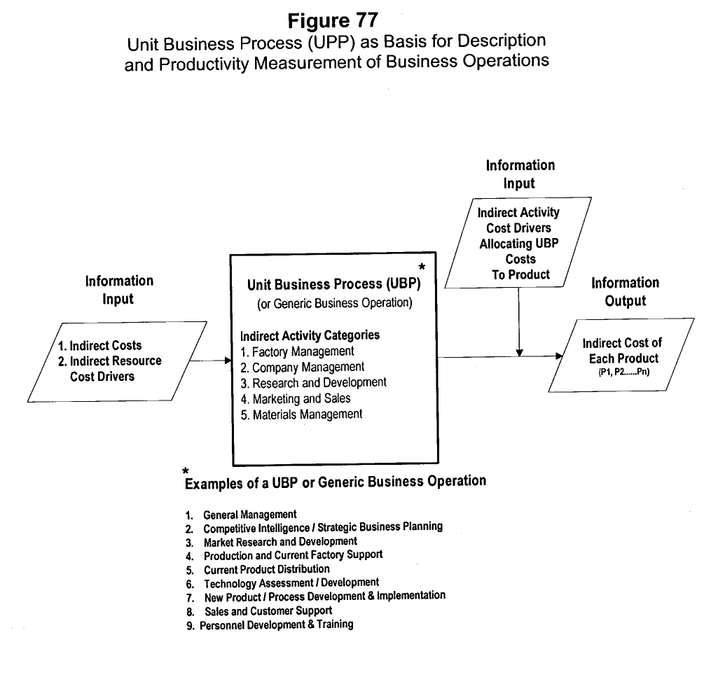

1. Flow charting the business processes in the factory and company operations to establish the flow of cost and information through each Unit Business Process (UBP) responsible for consuming the indirect or overhead costs. FIG. 77 shows an illustration of a UBP.

2. Developing a methodology for quantitative measurement of indirect cost, first by using resource cost drivers to trace indirect costs to various UBP activity centers, followed by the use of activity cost drivers to trace indirect costs of activities at each UBP to each product.

The following sections provide a detailed description of the overall framework for the UPPCOS MASC Methodology and its application in an illustrative example.

15.3 Structure of the UPPCOS MASC Methodology

15.3.1 Overview of the Methodology

The approach to integrating the UPP and UBP concepts with ABC principles to determine true product cost is graphically illustrated in FIG. 74, where the factory and company total costs (resources) first are obtained from accounting for the time period T_{T} of interest. The differences between direct manufacturing costs and indirect costs are that the direct manufacturing costs are resources used in manufacturing that are directly consumed by UPP activity centers (FIG. 70) and indirect costs are resources of factory and company business operations that are consumed by UBP activity centers (FIG. 77). It should be noted that the magnitude of total cost, direct manufacturing cost, and indirect cost as well as the respective cost drivers will be factory, company and industry and time dependent. Different companies and industries might use varying versions fitting their preference of the different nature of manufacturing and other functions. The overall framework developed is capable of adjustment to any company or industry, by properly measuring and assigning costs appropriately during the period of study selected, T_{T}. The cost of each direct manufacturing cost component can be calculated based on factory data for the actual consumption of the UPP activity centers during the time period, T_{T}. The cost of each indirect cost component initially will be estimated from quantities budgeted by the manufacturing organization on an appropriate time basis (e.g. daily or annually), and these cost will be updated to reflect actual data once these data become available.

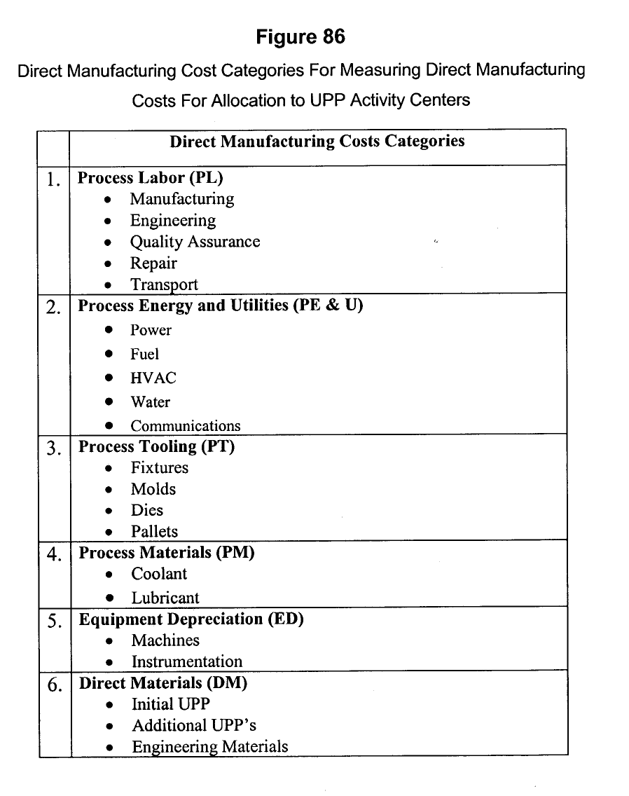

Each UPP or UBP in a factory is treated as a UPP or UBP activity center, which performs a set of specific activities such as 1) set-up, machining, and engineering for a UPP, and 2) market analysis, customer surveys, and test marketing for a UBP. For example, if the manufacturing operation of a UPP activity center is flexible machining, then the set of activities may be set-up, machining, or engineering. If the business operation of a UBP activity center is market research, then the set of activities may be market analysis, customer surveys, and test marketing. Each UPP or UBP activity center consumes a portion of factory total resource costs. Similarly, each product manufactured in factory consumes a portion of costs of a UPP and UBP activity center. The calculation techniques are discussed below, with detailed tables (FIGS. 86-95).

As illustrated in FIG. 75, total costs for a time T_{T} are first regrouped based on factory and company knowledge into direct manufacturing costs and indirect costs:

1) The Table in FIG. 86 shows a detailed list of direct manufacturing costs of factory and company operations in the six generic categories, summarized here:

Process Labor (PL)

Process Energy and Utilities (PE & U)

Process Tooling (PT)

Process Materials (PM)

Equipment Depreciation (ED)

Direct Materials (DM)

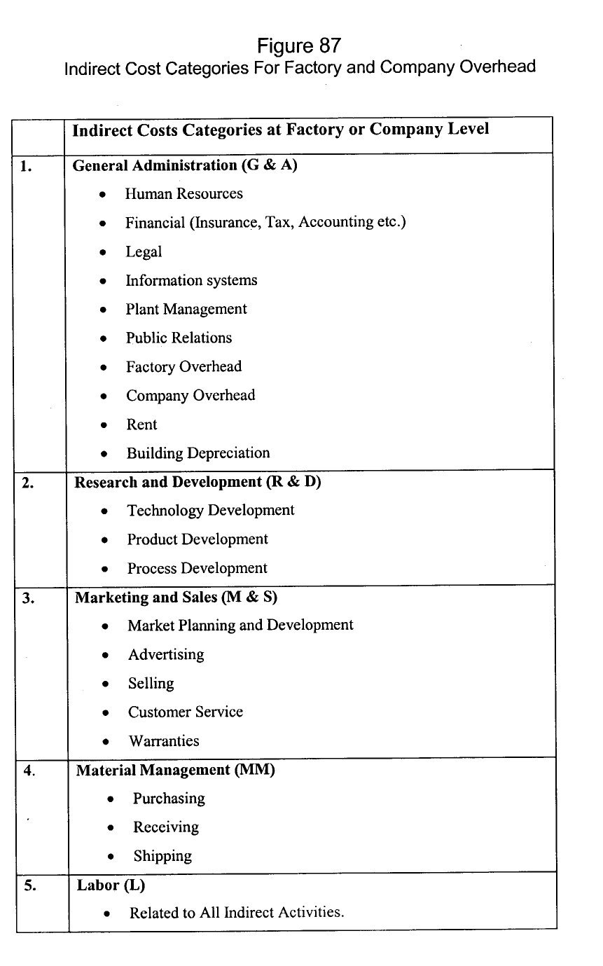

2. The Table in FIG. 87 shows a detailed list of indirect or overhead costs of factory and company operations in the five generic categories, summarized here:

General Administration (G & A)

Research and Development (R & D)

Marketing and Sales (M & S)

Material Management (MM)

Labor (L)

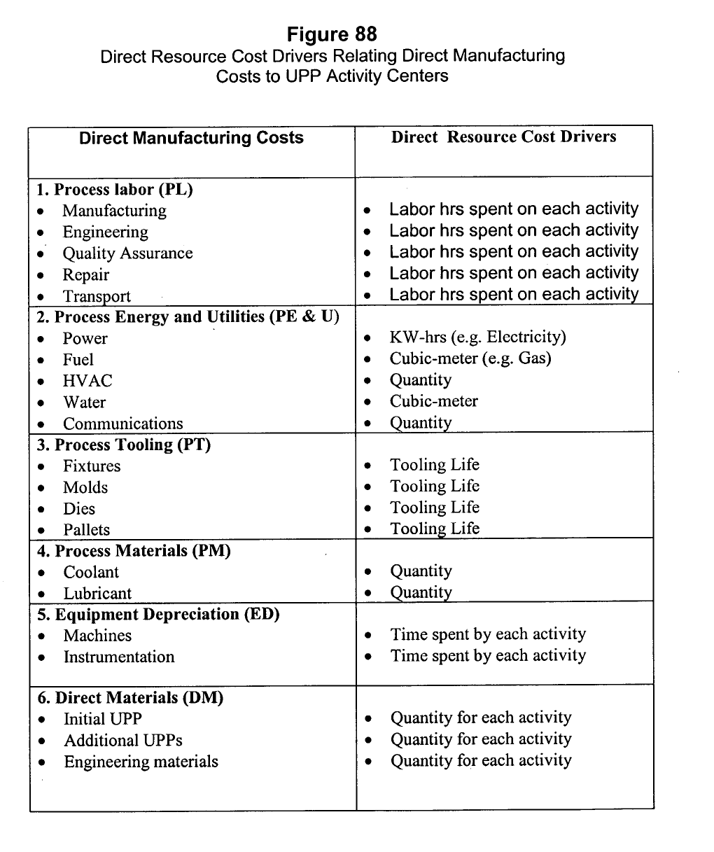

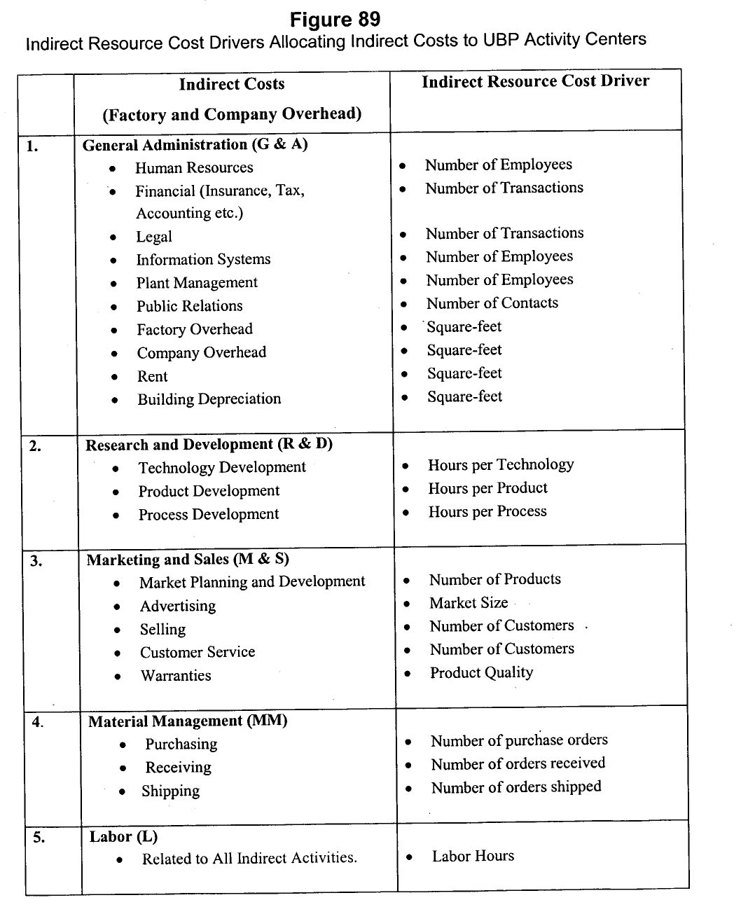

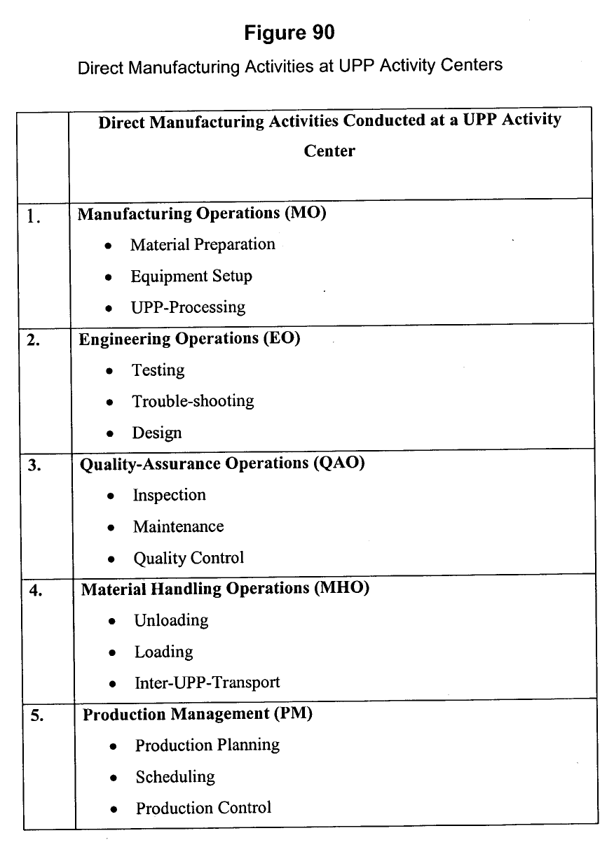

Next, direct resource cost drivers (FIG. 88) are applied to relate direct manufacturing costs to UPP activity centers, and indirect resource cost drivers (FIG. 89) are applied to allocate indirect costs to UBP activity centers. The Table in FIG. 90 shows details for a list of five direct manufacturing activities at the UPP level, summarized here:

Manufacturing Operations (MO)

Engineering Operations (EO)

Quality Assurance Operations (QAO)

Material Handling Operations (MHO)

Production Management (PM)

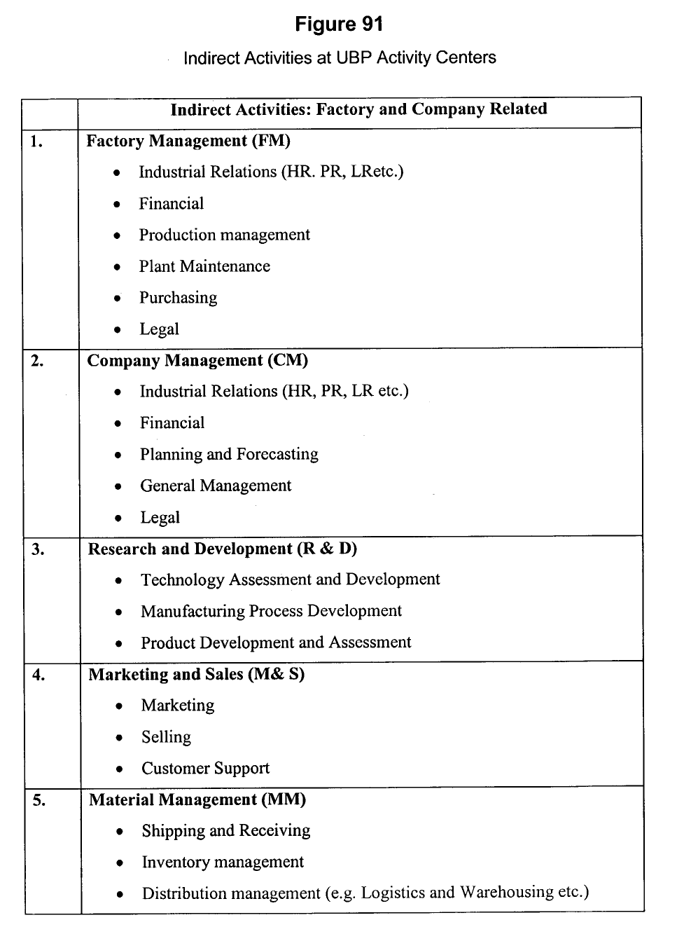

The Table in FIG. 91 shows details for a list of five indirect activities at the UBP level, summarized here:

Factory Management (FM)

Company Management (CM)

Research and Development (R & D)

Marketing and Sales (M&S)

Material Management (MM)

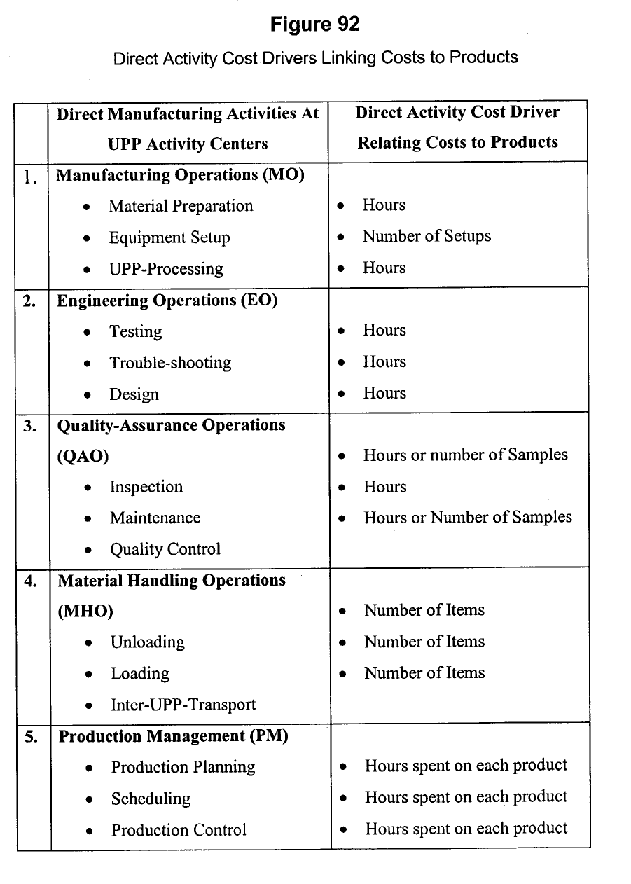

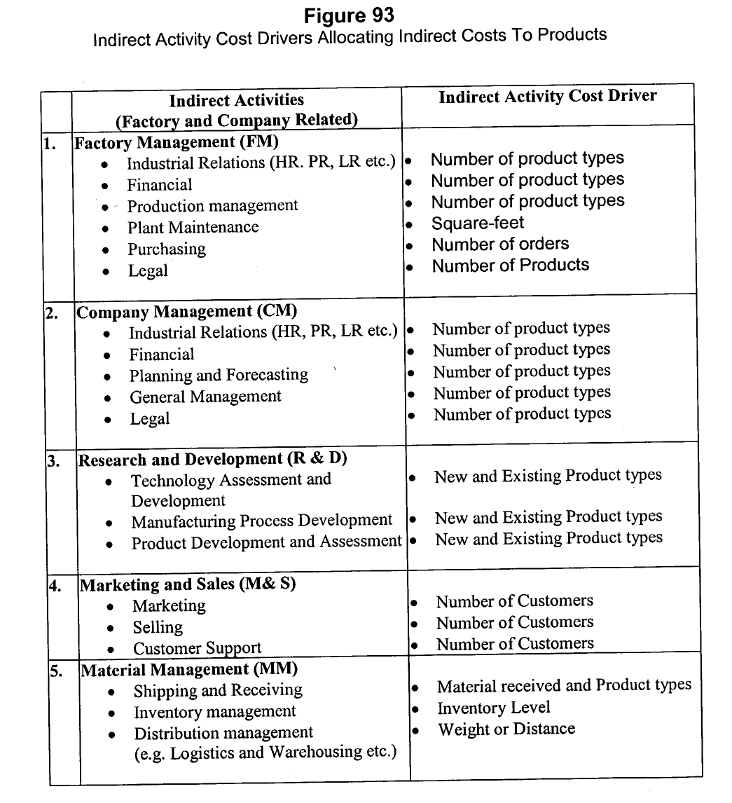

Then, a set of direct cost drivers (FIG. 92) is employed to link direct manufacturing cost from the UPP activity centers to individual products, and a set of indirect cost drivers (FIG. 93) is used to link indirect or overhead costs from the UBP activity centers to individual products.

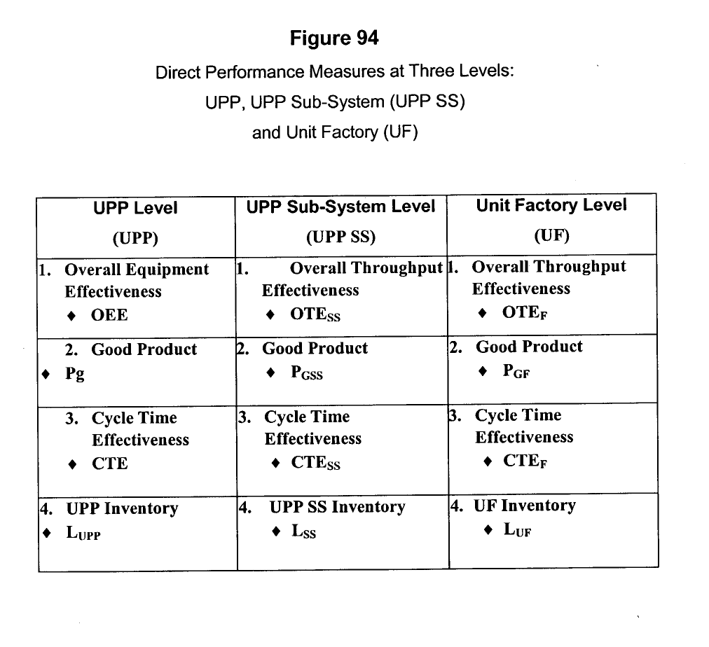

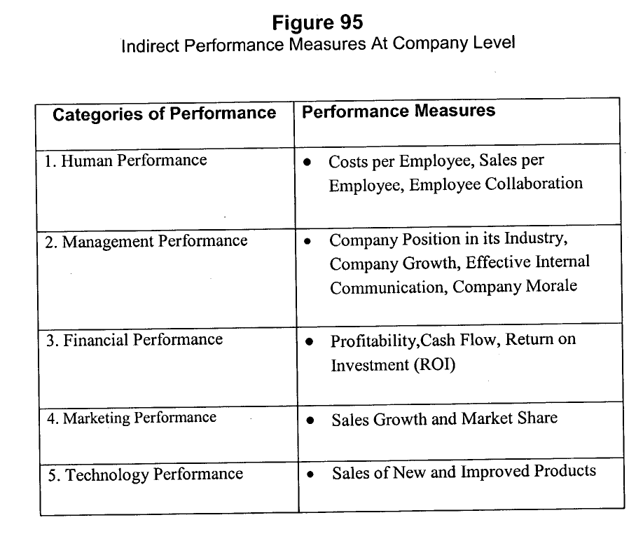

Finally, sets of direct performance measures of manufacturing operations (FIG. 94) and sets of indirect performance measures (FIG. 95) are defined. Algorithms relating direct performance measures to product direct manufacturing cost are developed. Algorithms for indirect performance measures are also developed.

Algorithms are used to express the direct manufacturing cost of a unit of good product on an ABC basis as a function of the direct performance metric, OTE, of a model factory in FIG. 76 made up of six UPP activity centers are developed. Indirect performance metrics and algorithms linking indirect cost of a unit of good product on an ABC basis to these metrics are thus developed. As mentioned above, the direct manufacturing costs and indirect costs will be obtained from accounting with assistance of personnel knowledgeable of factory and company costs.

15.3.2 Total Product Cost at the Factory Level

According to the methodology of the present invention, the total cost of a good product for product type k can be determined, at the end of the factory, as

TCₖ=TDMCₖ+TICₖ (15-1)

where

TCₖ=total cost of a good product for product type k

(at the end of the factory)

TDMCₖ=total direct manufacturing cost of a good product for product type k

(at the end of the factory)

TICₖ=total indirect cost of a good product for product type k

(at the end of the factory)

15.3.3 Direct Manufacturing Cost of Product at the Factory Level

On the assumption that the direct resource cost drivers and the direct activity cost drivers have been identified, the activity costs associated with each UPP activity center in the factory during the period, T_{T} can be determined from Equations (15-2) and (15-3) as,

$$\begin{matrix}A {C}_{ij}^{UPP} = {\sum }_{k} {DMC}_{k} \times {DCD}_{ijk} & ( 15 \text{-} 2 ) \\ A {C}_{i}^{UPP} = {\sum }_{j} A {C}_{ij}^{UPP} = {\sum }_{j} {\sum }_{k} {DMC}_{k} \times {DCD}_{ijk} & ( 15 \text{-} 3 )\end{matrix}$$

where

AC^{UPP}ᵢⱼ=the jth activity cost component contributed to UPP activity center i

AC^{UPP}ᵢ=total activity cost of UPP activity cost center

DMCₖ=kth direct manufacturing cost component

DCDᵢⱼₖ=direct resource cost driver which allocates kth direct manufacturing cost to jth activity component of UPP activity center i

The total direct manufacturing cost of product at the end of the factory can be calculated based on the manufacturing processes of the product types and the performance of UPP activity centers. Note that the input and output of a UPP activity center is material flow of a product type. Assume during the period, T_{T}, a batch of product type k is manufactured in factory. The number of good product units output from the factory is P_{g} and the number of actual product units input into the factory is Pₐ. The operation sequence for this type of product is OP={i|UPPs}, specified, for the illustrative example herein, by the model factory flow chart shown in FIG. 76.

Thus, the total direct manufacturing cost of a unit of good product for product type k during the period, T_{T} can be determined from Equations (154),

$${TDMC}_{k} = \frac{{\sum }_{i ∈ OP} {\sum }_{j} A {C}_{ij}^{UPP} \times {ACD}_{ijk}}{{P}_{g ( k )}} \qquad ( 15 \text{-} 4 )$$

and the total direct manufacturing cost of a unit of good product averaged over all product types, k, during the period, T_{T}, can be determined from Equations (15-5),

$$\begin{matrix}{TDMC}_{AVG} = \frac{{\sum }_{k} {\sum }_{i ∈ OP} {\sum }_{j} A {C}_{ij}^{UPP} \times {ACD}_{ijk}}{{\sum }_{k} {P}_{g ( k )}} \\ = \frac{{\sum }_{k} {\sum }_{i ∈ OP} {\sum }_{j} A {C}_{ij}^{UPP} \times {ACD}_{ijk}}{OTE \times {R}_{avg ( F )}^{( th )} \times {T}_{T}}\end{matrix}$$

(15-5)

where

ACDᵢⱼₖ=activity center cost driver, which traces the jth activity cost of UPP activity center i to product type k.

OTE=unit-based overall throughput effectiveness of the factory

R^{(th)}_{avg(F)}=theoretical average processing rate in time T_{T} for products through the factory

OEE/OTE [37], OTE is defined for:

a single part type, and

for the average of multiple part types,

but not separately, i.e. OTEₖ for each part type when processing multiple part types.

Further development of the theory is in process to implement concepts required to determine how best to define and represent OTEₖ. This feature enables establishing a link between UPP total direct manufacturing costs and the TDMC of each product k.

Similarly, OEE is currently defined for a single part type, and for the average of multiple part types, but not separately, i.e. OEEₖ for each part type when processing multiple part types. Likewise, further development of OEE/OTE theory allows one to define how best to represent and calculate OEEₖ. In addition, since OEE for a UPP in a factory describes the manufacture of a semi-finished product, not the final product sold to the customer, the use of OEEₖ provides a link between UPP productivity and the final “semifinished” product from a UPP. As shown above, OTE is required to correlate factory productivity with the factory average product cost.

15.3.4 Indirect Cost of Product

Similarly, the total indirect cost of a good product may be determined according to the business process associated with the product type and the performance of UBP activity centers, FIG. 77. Thus, the activity costs listed under each UBP activity center during the period, T_{T} can be determined from Equations (15-8) and (15-9) as,

$$\begin{matrix}A {C}_{ij}^{UBP} = {\sum }_{k} {IC}_{k} \times {ICD}_{ijk} & ( 15 \text{-} 8 ) \\ A {C}_{i}^{UBP} = {\sum }_{j} A {C}_{ij}^{UBP} = {\sum }_{j} {\sum }_{k} {IC}_{k} \times {ICD}_{ijk} & ( 15 \text{-} 9 )\end{matrix}$$

where

AC^{UBP}ᵢⱼ=the jth activity cost component contributed to UBP activity center i

AC^{UBP}ᵢ=total activity cost of UBP activity cost center i

ICₖ=kth indirect cost component

ICDᵢⱼₖ=direct resource cost driver which allocates kth indirect cost to jth activity component of UBP activity center i

For each UBP activity center (or generic business operation), information inputs for a time T_{T} consisting of the indirect costs and indirect resource cost drivers provide a basis for linking indirect costs to each of the generic indirect activity categories, FIG. 91 and FIG. 77, for the particular UBP.

Examples of UBP activity centers or generic business operations include:

General Management

Competitive Intelligence/Strategic Business Planning

Market Research and Development

Production and Current Factory Support

Current Product Distribution

Technology Assessment/Development

New Product/Process Development and Implementation

Sales and Company Support

Personnel Development and Training

Then, based on additional input of the indirect activity cost drivers for allocating costs of the UBP activities to each of the products (P1, P2, . . . Pn), the indirect cost of each product may be calculated as an output.

15.4 Illustrative Example Illustrating the Calculation of Productivity and Product Direct Manufacturing Cost for a Model Factory Defined in FIG. 76

15.4.1 Productivity of Model Factory for 3 Part Types

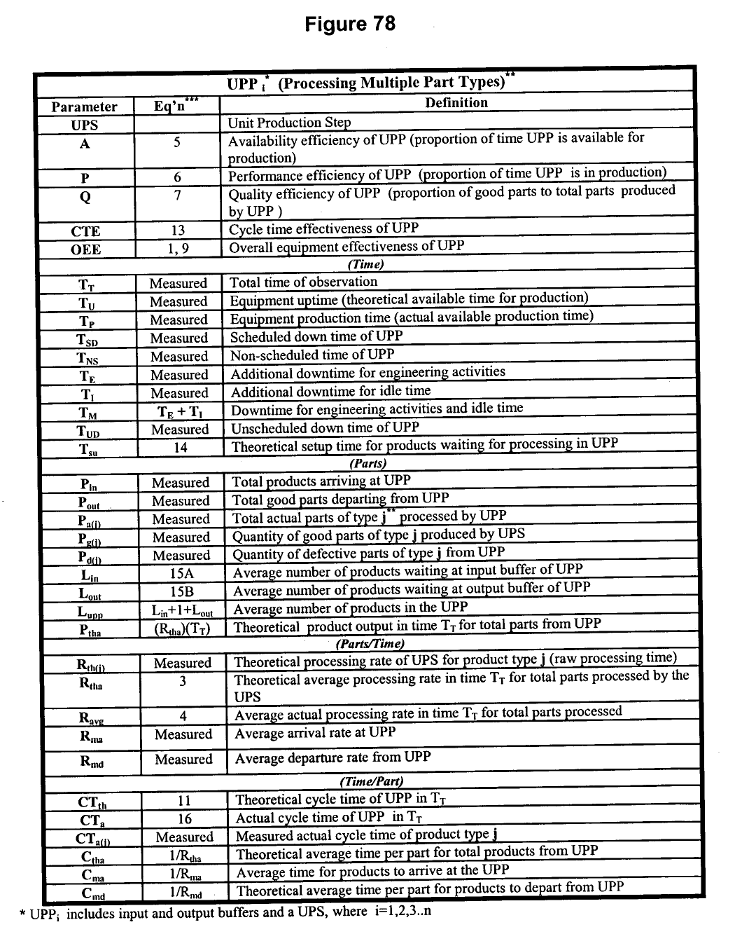

The illustrative example is based on a model factory flowcharted in FIG. 76, made up of UPP₁, UPP₂ and UPP₃ in series, followed by UPP₄ and UPP₅ in parallel, followed by UPP₆ in series. Generic definitions of production parameters and direct performance metrics (OEE, CTE, P_{g}. L_{UPP}) at the UPP level are shown in FIG. 78 for the analysis of multiple products as described in Reference [37]. Data and calculations of production parameters and direct performance metrics for the illustrative example of 3 part types are shown in FIG. 29, for each unit production process (UPP₁ through UPP₆) in the model factory.

Values of OEE range from 0.32 to 0.55, and values of CTE range from 0.80 to 0.98. Values of P_{g} range from 84 to 198 for the sum of 3 product types. Values of Pgx range from 43 to 99, values of Pgy range from 19 to 49, and values of P_{gz} range from 18 to 50. Values of Lᵢₙ and Lₒᵤₜ are assumed to be zero, and values of L_{UPP} are assumed to be 1.

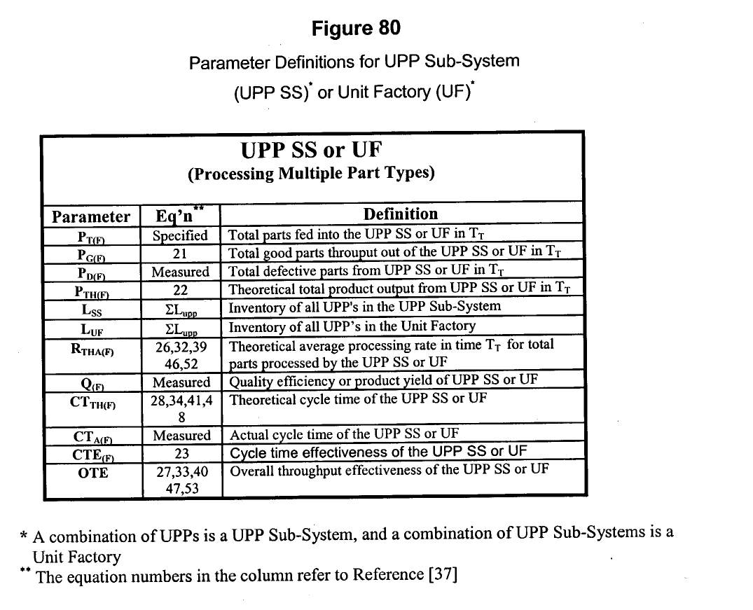

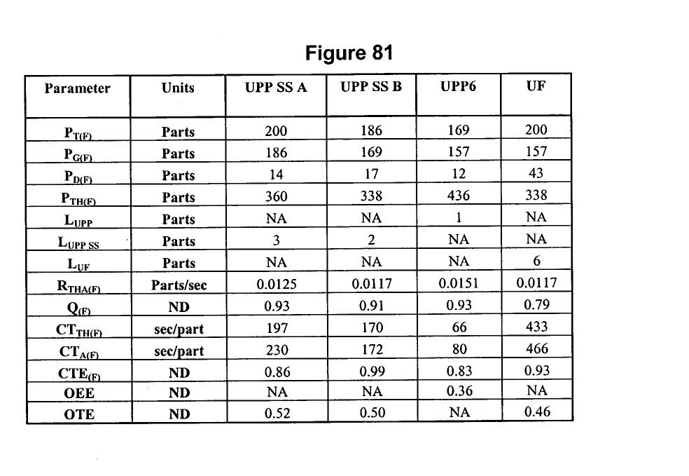

Generic definitions of production parameters and direct performance metrics (OTE_{F}, CTE_{F}, P_{G(F)} and L_{F}) at the Unit Factory (UF) level as well as at the UPP Sub-System (UPP SS) level are shown in FIG. 80 for the analysis of multiple products, in this case 3 part types, as described in Reference [1]. Data and calculations of production parameters and direct performance metrics for the illustrative example are shown in FIG. 81, for each UPP SS and for the unit factory (UF). Values of OTE_{F}, CTE_{F} and P_{G(F)} are 0.46, 0.93 and 157 parts (85+34+38), respectively, for the time period T_{T}.

15.4.2 Product Direct Manufacturing Cost Study of a Model Factory

This section discusses a six-step approach for calculation of direct manufacturing cost of a product for the model factory shown in FIG. 76 for each of the three product types.

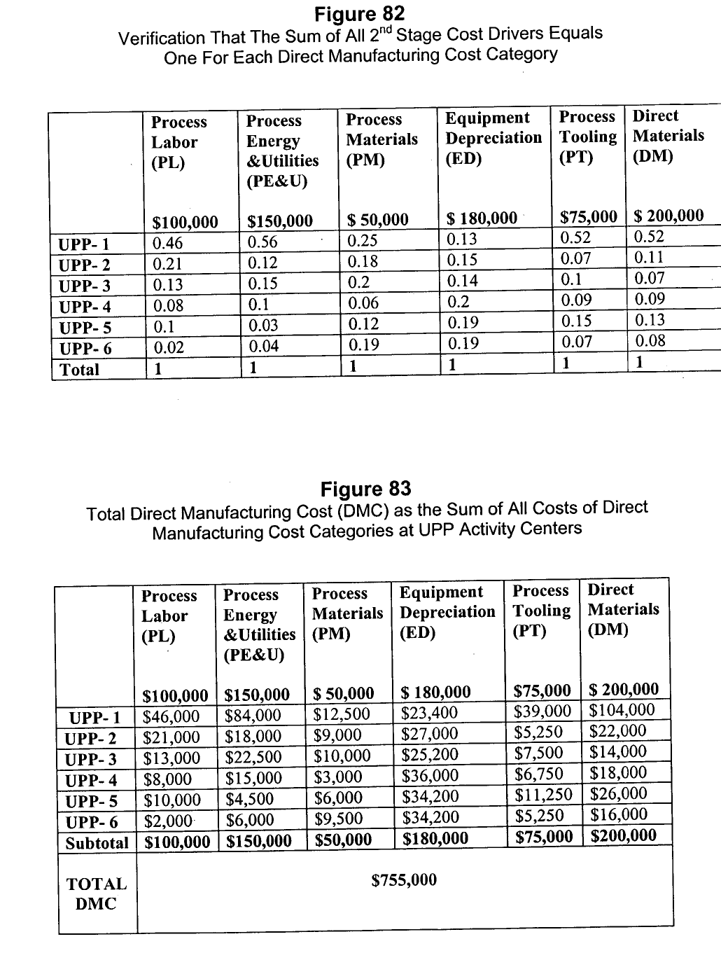

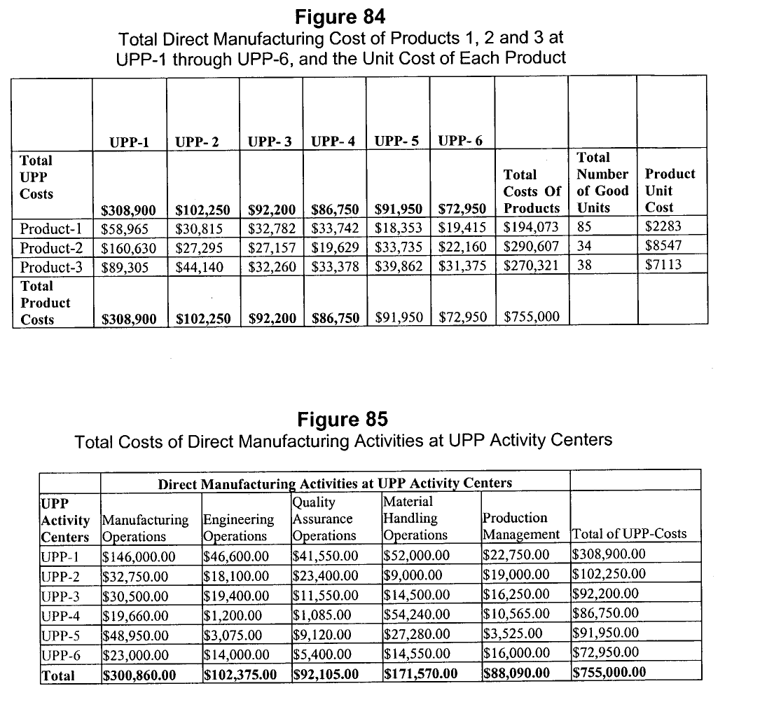

The Tables in FIGS. 82, 83, 84, and 85 summarize the overall validation of the cost-study carried out in the Excel calculations.

Step 1:

The initial step is to collect the total costs of a company through the general ledger or income statement of the company. In the illustrative example, it is assumed that:

Total Costs (TC)=Direct Manufacturing Costs (DMC)+Indirect Costs (IC)=$1,000,000

DMC=$755,000 based on a re-grouping factor of 0.755 for direct manufacturing costs.

In this illustrative example, the subdivision of costs was done arbitrarily.

In a real case, DMC would have been obtained directly from company data.

IC=$1,000,000−DMC=$245,000.

For this Illustrative example, the chart below sub-divides the DMC into 6 (six) cost categories and shows that their sum equals $755,000.

CHART Sub-Dividing DMC Into 6 Cost Categories

| Direct Manufacturing Cost Categories | Direct Manufacturing Costs ($) |
|---|---|
| Process Labor (PL) | $100,000 |
| Process Energy & Utilities (PE & U) | $150,000 |
| Process Materials (PM) | $50,000 |
| Equipment Depreciation (ED) | $180,000 |
| Process Tooling (PT) | $75,000 |
| Direct Materials (DM) | $200,000 |
| Total Direct Manufacturing Costs | $755,000 |

Step 2:

In this step, the direct manufacturing activities at each UPP activity center are defined (see also FIG. 90):

1. Manufacturing Operations (MO)

2. Engineering Operations (EO)

3. Quality Assurance Operations (QAO)

4. Material Handling Operations (MHO)

5. Production Management (PM)

Step 3:

In this step, the DMC from each of the set of 6 (six) DMC Categories are allocated to each of the 5 direct manufacturing activities (defined in Step 2) at the respective UPP activity centers based on second stage cost driver factors. The Cost Driver Factors can be obtained in three ways [21]

1. Educated Guess

2. Analytical Hierarchical Process (AHP)

3. Actual Data Collection.

In this illustrative example the cost driver factors are determined from “hypothetical actual data”. For example, in FIG. 96, 0.2 is the cost driver factor used for allocating the cost of Process Labor (PL) to the manufacturing operations activity of UPP-1. It is calculated as follows:

$$\frac{\begin{matrix}Process Labor Hrs spent on \\ Manufacturing Operations of UPP \text{-} 1\end{matrix}}{Total Process labor Hours of All the 6 UPP ' s} = \frac{200}{1000}$$

Step 4:

The dollar value of the costs of each of the activities of the respective UPP-activity center is obtained from Equations (15-2) and (15-3),

$$\begin{matrix}A {C}_{ij}^{UPP} = {\sum }_{k} {DMC}_{k} \times {DCD}_{ijk} & ( 15 \text{-} 2 ) \\ A {C}_{i}^{UPP} = {\sum }_{j} A {C}_{ij}^{UPP} = {\sum }_{j} {\sum }_{k} {DMC}_{k} \times {DCD}_{ijk} & ( 15 \text{-} 3 )\end{matrix}$$

where

AC^{UPP}ᵢⱼ=the jth activity cost component contributed to UPP activity center i

AC^{UPP}ᵢ=total activity cost of UPP activity cost center

DMCₖ=kth direct manufacturing cost component

DCDᵢⱼₖ=direct resource cost driver which allocates kth direct manufacturing cost to jth activity component of UPP activity center i.

The following values are obtained from FIGS. 97, 99, 101, 103, 105 and 107 in the Excel calculation.

AC^{UPP}₁=$308,900.

AC^{UPP}₂=$102,250.

AC^{UPP}₃=$92,200.

AC^{UPP}₄=$86,750.

AC^{UPP}₅=$91,950

AC^{UPP}₆=$72,950.

Total=$755,000

Step 5:

In this step, the costs of each of the five general sets of activities of the respective UPP-activity center are allocated to three products based on third stage cost-driver factor. These factors are obtained through the same analysis as that of Second-Stage Cost Driver Factor mentioned above. For example, in FIG. 108, 0.2 is the factor used for allocating the Manufacturing Operations Activity of UPP-1 to Product 0.1. It is calculated as follows:

$$\frac{Manufacturing Operations Labor Hrs of UPP \text{-} 1 on Product \text{-} 1}{Total Manufacturing Operations Labor Hours for All 6 UPP ' s} = \frac{200}{1000}$$

Step 6:

In this step, the total unit direct manufacturing cost (TDMCₖ, $/unit) for each product type, k, is obtained from Equation (15-4), where the numerator represents the total dollar cost of product contributed by each UPP activity center, and P_{g(k)} represents the number of good product units of product type k.

$${TDMC}_{k} = \frac{{\sum }_{i ∈ OP} {\sum }_{j} A {C}_{ij}^{UPP} \times {ACD}_{ijk}}{{P}_{g ( k )}} \qquad ( 15 \text{-} 4 )$$

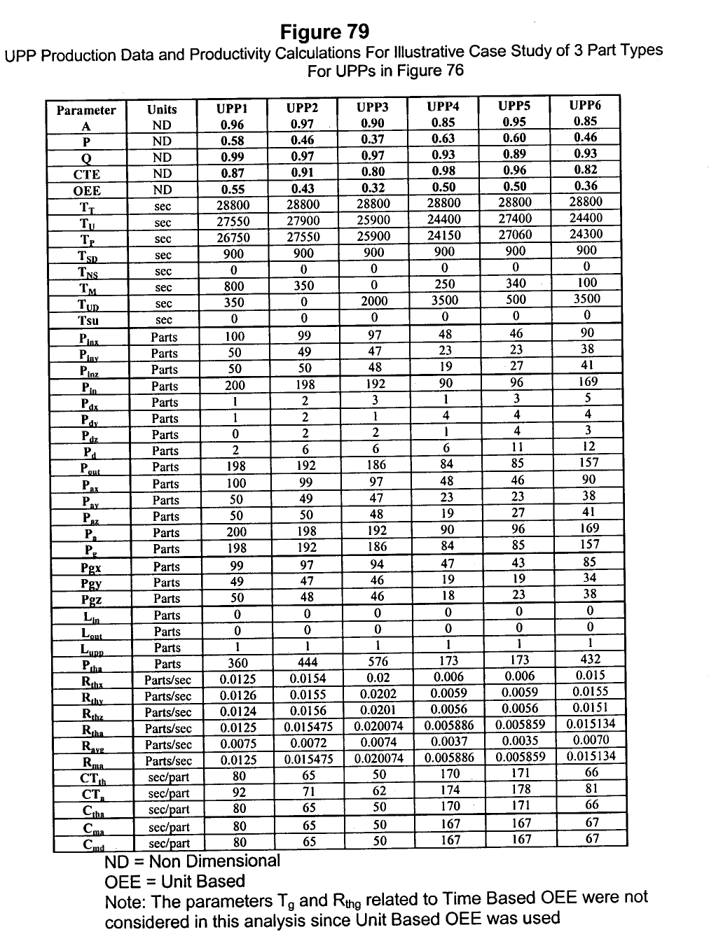

Based on the number of good product units calculated herein, FIG. 79, for each of these 3 product types, the calculations below show the unit direct manufacturing cost for product types 1, 2, and 3 treated in this illustrative example.

TDMC₁=$194073/85=$2283/Unit of Product 1.

TDMC₂=$290607/34=$8547/Unit of Product 2.

TDMC₃=$270321/38=$7113/Unit of Product 3.

It should be noted that Step 6 enables the exact calculation of the direct manufacturing cost/unit of each product type k. But, since OEE and OTE are not defined for each product type k, but for the sum of all product types k, additional work is needed if the unit cost of each product type, k, is to be related to productivity.

Nevertheless, the total direct manufacturing cost of a unit of good product averaged over all product types, k, during the period, T_{T}, can be determined from Equations 15-(5),

$$\begin{matrix}{TDMC}_{AVG} = \frac{{\sum }_{k} {\sum }_{i ∈ OP} {\sum }_{j} A {C}_{ij}^{UPP} \times {ACD}_{ijk}}{{\sum }_{k} {P}_{g ( k )}} \\ = \frac{{\sum }_{k} {\sum }_{i ∈ OP} {\sum }_{j} A {C}_{ij}^{UPP} \times {ACD}_{ijk}}{OTE \times {R}_{avg ( F )}^{( th )} \times {T}_{T}}\end{matrix} \qquad ( 15 \text{-} 5 )$$

where

ACDᵢⱼₖ=activity center cost driver, which traces the jth activity cost of UPP activity center i to product type k.

OTE=unit-based overall throughput effectiveness of the factory

R^{(th)}_{avg(F)}=theoretical average processing rate in time T_{T} for products through the factory

Hence, for this example, TDMC_{AVG}=$755,000/157=$4808/unit averaged over the 3 product types. Note that this can also be expressed as:

TDMC_{AVG}=$755,000/OTE×R_{avg(F)}^{(th)}×T_{T},

thereby establishing a relation of the average product cost to productivity (OTE).

15.4.3 Productivity Dependence of Product Direct Manufacturing Cost for a Model Factory

As pointed herein, OEE/OTE [37], OTE is defined for a single part type, and for the average of multiple part types, but not separately, i.e. OTEₖ for each part type when processing multiple part types. How OTEₖ can be further defined is necessary in order to develop a link between UPP total direct manufacturing costs and the TDMC of each product k.

Similarly, OEE is currently defined for a single part type, and for the average of multiple part types, but not separately, i.e. OEEₖ for each part type when processing multiple part types. Likewise, how OEEₖ can be further defined is needed to apply OEE/OTE. In addition, the issue needs to be addressed that OEE for a UPP in a factory describes the manufacture of a semi-finished product, not the final product sold to the customer. Hence, the use of OEEₖ would provide a link between UPP productivity and the final “semifinished” product from a UPP, not the final product.

### 13.5 CONCLUSIONS

The unique UPPCOS MASC Methodology defined herein is the first ABC technique designed to quantitatively link both direct manufacturing costs and indirect costs to products in such a way to facilitate improvement of existing manufacturing systems and design of new manufacturing systems. The methodology is a systematic approach for quantifying costs, and relating them first to activities at UPP and UBP activity centers, and then to each product.

The example herein illustrates the calculation, based on ABC principles, of direct manufacturing productivity, and direct manufacturing cost for a model factory made up of six UPPs. Algorithms developed to relate the direct manufacturing cost component of total product cost to manufacturing productivity metrics (e.g. OEE, OTE) demonstrate feasibility to quantitatively analyze product direct manufacturing cost as a function of manufacturing performance.

### 16. INDUSTRIAL APPLICABILITY

The present invention finds utility in businesses and industries requiring the quantitative measurement and analysis of data describing the processing or manufacture of products in production systems, including product lines, factories and supply chains. Real time productivity assessment of manufacturing operations from the equipment level to the production system level are of increasing importance to companies striving to improve and optimize performance and cost for worldwide competitiveness. In one aspect of this invention there is development of systematic metrics and methodologies for calculation, analysis and rapid simulation of equipment and system performance, based on processing multiple product types or single product types, using unit based OEE as the basis for productivity definition.

Productivity analysis at the equipment level follows from the concept (FIG. 5) of a Unit Production Process (UPP), which includes a unit process step, input and output buffers, and product flow to and out of the unit process step. Four performance metrics from the UPP analysis methodology provide useful information on productivity. The first of these is Overall Equipment Effectiveness (OEE), which represents the actual versus ideal equipment performance. The general definition reflects the six major losses from the TPM paradigm, described as the product of: availability efficiency, performance efficiency and quality efficiency, which reduces to:

$$OEE = A * P * Q = OEE = [ \frac{{T}_{U}}{{T}_{T}} ] [ \frac{\sum {P}_{a}}{{R}_{tha} {T}_{U}} ] [ \frac{\sum {P}_{g}}{\sum {P}_{a}} ] = \frac{\sum {P}_{g}}{( {R}_{tha} ) ( {T}_{T} )} = \frac{{P}_{g}}{{P}_{tha}}$$

Where Tu/Tt=A, Σ2 Pa/Rtha*Tu=P, ΣPg/ΣPa=Q

Two general definitions of OEE are recognized, unit-based OEE and time-based OEE, which differ solely in the definition of the quality efficiency, and are mathematically related by the expression:

$$\frac{OEE ( Unit Based )}{OEE ( Time Based )} = \frac{{R}_{thg}}{{R}_{tha}} .$$

The unit-based OEE definition is used as one preferred embodiment, because OEE is based on exact material balance (e.g. input=output+scrap) of materials and components being processed, and hence provides a sound basis for defining and quantifying system level as well as equipment level productivity metrics. This is not generally the case for time based OEE, which adopts the forced definition of quality or yield as a time ratio based on industrial engineering preferences for analysis of production in terms of time parameters.

The second equipment performance metric is the output of good product, which is a function of the OEE and theoretical processing rate, during a fixed total time (T_{T}),

P_{g}=(OEE)(Rₜₕₐ)(T_{T}).

The third equipment performance metric is the Cycle Time Effectiveness (CTE), which is the ratio of theoretical to actual cycle time for processing a unit of product through the UPP,

$$CTE = \frac{{CT}_{th}}{{CT}_{a}} .$$

The fourth performance metric at the equipment level is the equipment level inventory or work in process,

L_{UPP}=L_{IN}+L_{UPS}+L_{OUT},

which is useful in calculating the business metric of inventory turns, P_{g}/L_{UPP}.

These four equipment level metrics provide a quantitative measurement of the 1) equipment effectiveness, 2) good product output in a measured total time, 3) the cycle time effectiveness for processing one or a group of parts through the UPP, and 4) the effectiveness of handling work-in-process inventory at the equipment level. Thus, they provide a basis for conducting root cause analysis to understand various manufacturing productivity problems and for making productivity improvements for equipment.

Productivity analysis at the production system or factory level follows from the concept (FIG. 6) of a system, i.e., Unit Factory (UF), based on a specific architectural arrangement of UPPs making up the manufacturing system.

Thus, in one aspect of the invention relates to the development and application of the novel topological concept that any system (UF) can be factored into a unique set of interconnected UPP sub-systems, primarily the “series”, “parallel”, “assembly”, “expansion” and “complex” configurations shown schematically in FIG. 7, with the provision for “rework” as illustrated for the “series” configuration in FIG. 10. To analyze the productivity of a real system, therefore, first calculate productivity metrics for each UPP and each UPP subsystem of which the overall system is composed. Then, combine the various sub-systems according to the overall manufacturing system architecture, and apply the appropriate algorithms to calculate the overall productivity of the system. These four basic performance metrics from the system level analysis methodology provide useful information on system productivity. The first of these is Overall Throughput Effectiveness (OTE), which represents the actual versus ideal system or factory performance,

$$\begin{matrix}OTE = \frac{{P}_{G ( F )}}{{P}_{TH ( F )}} \\ = \frac{Good Product Output ( Units ) from System ( Factory )}{\begin{matrix}Theoretical Actual Product Output ( Units ) from \\ System ( Factory ) in Total Time\end{matrix}}\end{matrix}$$

or,

OTE_{CMS}=A_{(CMS)}·P_{(CMS)}·Q_{(CMS)}

The second system level metric is total output of good product from the factory, which is a function of the OTE and system theoretical processing rate, during a total time (T_{T}),

P_{G(F)}=(OTE_{F})(R_{THA(F)})(T_{T})

The third system level metric is the Cycle Time Effectiveness (CTE_{(F)}), which is the ratio of theoretical to actual cycle time for processing a unit of product through the UF,

$$\begin{matrix}{CTE}_{( F )} = \frac{{CT}_{TH ( F )}}{{CT}_{A ( F )}} \\ = \frac{Theoretical Cycle Time of System ( Factory )}{Actual Cycle Time of System ( Factory )}\end{matrix}$$

The fourth performance metric at the system level is the system or factory level inventory or work in process,

L_{UF}=Σ_{LUPP},

which is useful in calculating the business metric of inventory turns for the factory, P_{G(F)}/L_{UF}, or P_{G(F)}/Σ(L_{UPP}).

These four metrics provide quantitative measurement of: 1) overall throughput effectiveness, 2) good product output in a measured total time, 3) cycle time effectiveness for processing single or multiple product types through the Unit Factory (UF), and 4) the effectiveness of handling work in process inventory at the system level. This overall assessment provides understanding of dynamics of production and of the various loss factors at the system level in terms of the OEE and other parameters at the UPP level, the UPP sub-systems used to factor the system, and the overall UPP arrangements (architecture) of the system.

The productivity metrics presented are used to measure the effectiveness of a manufacturing system in terms of productivity, and are also used to identify opportunities for productivity improvement and optimization.

One example for applying these metrics to achieve manufacturing excellence for an existing production facility (manufacturing system) is described as follows. Mechanisms (data collection and analysis) are set up to measure equipment as well as factory level productivity metrics and inventory levels. In a steady state production environment, lower and upper bounds are established for these metrics where they are “in control,” i.e., productivity is fluctuating within an allowable range as determined by the company either through rigorous mathematical analysis or heuristic best practices. When any productivity metric is out of control, the problem UPP and UPP subsystem is quickly identified. A analysis of the problem cause allows steps to be taken to rectify the problem. In the event that changes in the production facility are desirable, e.g., the addition of new machines or change of scheduling policy, simulation is then rapidly carried out to evaluate their effects on productivity. The scenario that results in the highest OTE and CTE should be implemented. This will allow a manufacturing company to achieve the goal of “do things right the first time”.

In another aspect of the present invention, the method is useful for other applications through combining analysis at the UPP level with that of the UPP subsystem level, and at the system level, and by further extending it to the supply chain, which includes transportation links between factories. At the UPP level, contributions are made to improving the new product development and technology transfer process 1) by expressing the rate (or cycle time) parameters of OEE and CTE as functions of the underlying science and the engineering dynamics of the UPP, based on its configuration and applicable physical laws including heat and mass transfer, and 2) by incorporating costs on an “activity based costing” basis at each UPP activity center. This provides insight into the ultimate potential of particular UPP's as they progress from the discovery stage to eventual maturity. At the production system or factory level, systematic analysis of the relationships between individual UPP productivity, UPP sub-system productivity, and overall system productivity can be expected to yield design rules for factory and supply claim optimization as a function of overall architecture.

The method of the present invention provides understanding of the production dynamics of each UPP, each UPP sub-system, and of the overall system. The assessment identifies the various loss factors at the factory level in terms of the OEE and other parameters at the UPP level, the UPP sub-systems of which the system is composed, and of the overall production system architecture, including processing and transportation steps. Therefore, the method provides insight and guidance essential for making near term improvements or long-term optimization of the performance of complex production systems.

While the present invention has been particularly been described with reference to the embodiments described herein, it should be readily understood to those of ordinary skill in the art that changes and modifications in form and detail can be made without departing form the spirit and scope of the invention. For example, the methods described above may be implemented in software including different languages. Also any suitable hardware may be used.

The following references are fully incorporated herein by reference.

### REFERENCES

1. S. Nakajima, “Introduction to TPM: Total Productive Maintenance,” Productivity Press, Portland, Oreg., 7-49, 1988.

2. N. Fujikoshi, “Training for TPM: A Manufacturing Success Story,” Productivity Press, Cambridge, Mass., 5-31, 1990.

3. E. H. Hartmann, “Successfully Installing TPM in a Non-Japanese Plant: Total Productive Maintenance”, TPM Press, Inc., Allison Park, Pa., 1992.

4. T. Suzuki, “TPM in Process Industries,” Productivity Press, Portland, Oreg., 21-44, 1994.

5. C. J. Robinson, A. P. Ginder, “Implementing TPM: The North American Experience,” Productivity Press, Portland, Oreg., 125-149, 1995.

6. JIPM, “TPM—Total Productive Maintenance Encyclopedia,” JIPM, Atlanta, Ga., 1996.

7. K. E. McKone, R. G. Schroeder, and K. O. Cua, “Total Productive Maintenance: A Contextual View”, Journal of Operations Management, Vol. 17, Issue 2, 123-144, 1999.

8. V. A. Ames, J. Gililland, J. Konopka, and R. Schnabl, SEMATECH; K. Barber, Rockwell, “Semiconductor Manufacturing Productivity, Overall Equipment Effectiveness (OEE) Guidebook,” SEMATECH Revision 1.0, Technology Transfer 95032745A-GEN, Apr. 13, 1995.

9. J. M. Konopka, “Improvement Output in Semiconductor Manufacturing Environments,” PhD Thesis, Arizona State University, Tempe, Ariz., 1996.

10. M. J. D'Elia, T. F. Alfonso, “Optimizing process and equipment efficiency using integrated methods,” Process, Equipment, and Materials Control in Integrated Circuit Manufacturing II, Austin, Tex., USA, 125-134, Oct. 16-17, 1996.

11. Giegling, S., Verdini, W. A., Haymon, T., and Konopka, J. M., “Implementation of Overall Equipment Effectiveness (OEE) System at a Semiconductor Manufacturer,” Proceedings of 1997 IEMT Symposium, Austin, Tex., USA, 93-8, 1997.

12. Ziemerink, R. A. and Bodenstein, C. P., “Utilizing a LonWorks control network for factory communication to improve overall equipment effectiveness”, Proceedings of the 1998 IEEE International Symposium on Industrial Electronics ISIE. Part 2 (of 2), Pretoria, S Africa, 684-689, Jul. 7-10, 1998.

13. R. C., Leachman, “Closed-Loop Measurement of Equipment Efficiency and Equipment Capacity”, IEEE Transactions on Semiconductor Manufacturing, Vol. 10, No. 1, February 1997, 84-97.

14. International SEMATECH, “Standard For Definition And Measurement of Equipment Productivity,” SEMI E79-299 (Draft), 1999.

15. J. Bonal, C. Ortega, L. Rios, S. Aparicio, M. Fernandez, M. Rosendo, A. Sanchez and S. Malvar, “Overall Fab Efficiency,” Proceedings of the 1996 7^{th} Annual IEEE/SEMI Advanced Semiconductor Manufacturing Conference, ASMC 96, Cambridge, Mass., USA, 49-52, Nov. 12-14, 1996.

16. A. Slettehaugh and A. London, “Impact Of Lot Buffering On Overall Equipment Effectiveness”, Semiconductor International, Vol. 21(8), 153-160, 1998.

17. Dismukes, J. P., Vonderembse, M. A., S. Chandrasekaran, Bennett, R. J., Chen, F. F., Gerhardinger, P. F., Okkerse, R. F., and Caldwell, W. P., “University-Industry Collaboration For Radical Innovation in Flat Glass Manufacturing,” Proceedings of the PICMET'99 Conference, Portland, Oreg., Jul. 25-29, 1999.

18. Chandrasekaran, S., “Productivity Analysis in Flat Glass Manufacturing,” MS Thesis, The University of Toledo, December, 1999.

19. Dismukes, J. P., Vonderembse, M. A., S. Chandrasekaran, Hudspeth, Lonnie, and Caldwell, W. P., “Opportunities For Radical Innovation in Flat Glass Production Operations,” Proceedings of the 60^{th} Conference on Glass Problems, Oct. 19-20, 1999.

20. Ge Wang, John P. Dismukes, Samuel H. Huang and Sriram Chandrasekaran, Manufacturing Productivity Assessment Using Overall Equipment Effectiveness (OEE), Proceedings of the 2000 Japan-USA Symposium on Flexible Automation, Jul. 23-26, 2000.

21. “OEE For Operators”, Productivity Inc., 541 NE 20th Street, Portland, Oreg. 97232, www.ppress.com

22. “OEE Toolkit”, A Software Package from Productivity Inc., 541 NE 20^{th} Street, Portland, Oreg. 97232, www.ppress.com

23. “EASI OEE”, A Software Package from IPC Fab Automation GmbH, Kreuzbergweg 1a, 93133 Burglengenfeld, Germany, www.ipc-fabautomation.com

24. “Scoope Project”, A Software Package from ABB, Hoge Wei 27, B-1930 Zaventem, Belgium, www.scoope.com

25. A. Cheng-Leong, K. L. Pheng, and G. R. K. Leng, “IDEF*: A Comprehensive Modeling Methodology for the Development of Manufacturing Enterprise Systems”, International Journal of Production Research, Vol. 37, 3839-3858, 1999.

26. F. Mason, “Mapping a Better Process”, Management Engineering, 58-68, April 1997.

27. J. L. Burbidge, “Production Control: A Universal Conceptual Framework,” Production Planning and Control, Vol. 1(1), 3-16, 1990.

28. J. L. Burbidge, “Change to Group Technology: Process Organization is Obsolete”, Int. J. of Production Research, Vol. 30, n. 5, 1209-1219, 1992.

29. J. L. Burbidge, “The Use of Period Batch Control (PBC) in the Implosive Industries,” Production Planning and Control, Vol. 5(1), 97-102, 1994.

30. D. J. Miller, “The Role of Simulation in Semiconductor Logistics”, Proceedings of the 1994 Winter Simulation Conference, 885-891, 1994.

31. D. Kayton, T. Teyner, C. Schwartz, and R. Uzsoy, “Focusing Maintenance Improvement Efforts in a Wafer Fabrication Facility Operating Under The Theory of Constraints”, Production and Inventory Management Journal, 4^{th} Quarter 1997, 51-61.

32. H. William Dettner, “Goldratt's Theory of Constraints”, ASQC Quality Press, Milwaukee, 1997.

33. D. P. Martin, The Advantages of Using Short Cycle Time Manufacturing (SCM) Instead of Continuous Flow Manufacturing (CFM), IEEE/SEMI Advanced Semiconductor Manufacturing Conference, 4349, 1998.

34. O. Ruelle, Continuous Flow Manufacturing: The Ultimate Theory of Constraints, IEEE/SEMI Advanced Semiconductor Manufacturing Conference, 216-221, 1997.

35. D. Scott and R. Pisa, “Can Overall Factory Effectiveness Prolong Moore's Law?”, Solid State Technology, 75-82, 1998.

36. D. Scott, “Can CIM Improve Overall Factory Effectiveness?”, Pan Pacific Microelectronics Symposium, Proceedings of the Technical Program, Hawaii, Feb. 2-5, 1999.

37. Su, Q., Dismukes, J. P., Huang, S. H., Razzak, M, “Factory Level Metrics for Manufacturing Productivity”, submitted May 2001 to IEEE Transactions on Robotics and Automation.

38. Huang, S. H., Dismukes, J. P., Su, Q., Razzak, M., Bodhale, R., and Robinson, D. E. (Pilkington), “Manufacturing Productivity Improvement Using Effectiveness Metrics and Simulation Analysis”, submitted July 2001 to International Journal of Production Research.

39. Huang, S. H., Dismukes, J. P., Su, Q., Wang, G., Razzak, M., Robinson, D. E. (Pilkington), “Manufacturing System Modeling for Productivity Improvement”, submitted August 2001 to Journal of Manufacturing Systems.

40. Roztocki, Narcyz, “Activity-Based Costing for E-Commerce,” IERC, Proceeding of Industrial Engineering Research Conference, Dallas, Tex., May 21-23, 2001.

41. Dismukes, J. P., Su, Q., Huang, S. H., Razzak, M. “Hierarchical Methodology for Productivity and Improvement of Production Systems”, PCT/US01/49332.

42. Von Beck, U., and Nowak, J., “The Merger of Discrete Event Simulation with Activity Based Costing for Cost Estimation in Manufacturing Environments,” Winter Simulation Conf. Proc. 2000.

43. Locascio, A., “Manufacturing Cost Modeling for Product Design,” The International Journal of Flexible Manufacturing Systems, Vol. 12, 207-217, 2000, Boston.

44. Dekker, R. and Hoog, R. “The Monetary Value of Knowledge Assets: A Micro Approach,” Expert Systems with Applications vol. 18, 111-124, 2000.

45. Degraeve, Z. and Roodhooft, F., “A Mathematical Programming Approach for Procurement Using Activity Based Costing,” Journal of Business Finance Accounting, vol.27 no (1) & (2), January/March 2000.

46. Bukovinsky, D., Sprohge, H., and Talbott, J., “Activity-Based Costing for Sales and Administrative Costs,” The CPA Journal vol.70, no.4, April 2000.

47. Tatsiopoulos, I. and Panayiotou, N. “The Integration of Activity Based Costing and Enterprise Modeling for Re-engineering Purposes”, International Journal of Production Economics vol.66, 33-44, 2000.

48. Kee, R., “A Comparative Analysis of utilizing Activity-based costing and the Theory of Constraints for making Product-mix Decisions”, International Journal Of Production Economics, vol. 63, 1-17, 2000.

49. Oliver, L., “The Cost Management Toolbox,” American Management Association, New York, 2000.

50. Greasley, A. “Effective uses of Business Process Simulation,” Simulation Conference, 2000. Proceedings winter, vol.1 2004-2009, 2000.

51. Rasmussen, R; Savory, P., Williams, R., “Integrating Simulation with Activity-Based Management to evaluate Manufacturing Cell Part Sequencing,” Computers and Industrial Engineering vol.37, 757-768, 1999.

52. Cooper, R., and Slagmulder, R., “Activity-Based Cost Management System Architecture,” Institute of Management Accountants, vol.81, no.4, and 12-14, 1999.

53. Shapiro, J., “On the Connections among Activity-based Costing, Mathematical Programming Models for analyzing Strategic Decisions, and the resource-based view of the firm”, European Journal of Operational Research, vol.118, 295-314, 1999.

54. Nair, M., “Activity Based Information Systems: An Executive's Guide to Implementation,” John Wiley & Sons Inc, New York 1999.

55. Raz, T. and Elnathan, D. “Activity-Based Costing for Projects,” International Journal Of Project Management vol. 17, no 1, 61-67, 1999.

56. Currie, W. “Revisiting Management Innovation and change Programs,” Omega vol.27, 647-660, 1999.

57. Roztocki, N., Valenzuela; J., Porter J., Monk, R., Needy, K., “A Procedure for smooth implementation of activity based costing in Small Companies,” ASEM national Conference Proceedings, Virginia Beach, 279-288, Oct. 21-23, 1999.

58. Lebas, M., “Which ABC? Accounting based on causality rather than Activity-Based Costing”, European Management Journal vol. 17, No 5, 501-511, 1999.

59. Delen, D., Benjamin, P., Erraguntla, M., “An Integrated Toolkit for Enterprise Modeling and Analysis,” Proceedings of the 1999 Winter Simulation Conference.

60. Spedding, T. and Sun, G. “Application of Discrete Event Simulation to the Activity based Costing of Manufacturing Systems”, International Journal of Production economics, vol. 58 289-301, 1999.

61. Lelke, C. and Kress, S., “Strategic Re-orientation of the Chemical Industry with Activity-based Costing under a Value-Oriented Management System,” Management of engineering and Technology, 1999. Technology and Innovation Management, PICMET '99, Portland International Conference, vol.1, pp.373, 1999.

62. Limaye, K and Caudill, R. “System Simulation and Modeling Of Electronics Demanufacturing Facilities,” Electronics and the Environment, ISEE-1999, Proc. of the 1999 International Symposium, 238-243, 1999.

63. Hawtin, J. and. Chung, P. “Concurrent Engineering System for supporting STEP based Activity Model”, Computers Chem. Eng. Vol.22, 781-784, 1998.

64. Boons, A., “Product costing for Complex Manufacturing Systems”, International Journal of Production Economics vol.55, 241-255, 1998.

65. Schneeweiss, Ch. “On the Applicability of Activity Based Costing as a Planning Instrument,” International Journal of Production Economics, vol.54, 277-284, 1998.

66. Sohal, A., “Activity Based Costing in Manufacturing: Two Case Studies on Implementation,” Integrated manufacturing systems, vol. 9, no.3, 1998.

67. Kaplan, R. and Cooper, R., “Cost & Effect Using Integrated Cost Systems to Drive Profitability and Performance,” Harvard Business School Press, Boston, Mass., 1998.

68. Takakuawa, S., “The Use of Simulation in Activity based Costing for Flexible Manufacturing Systems, “Proceedings of the 1997 Winter Simulation Conference.

69. No, J., and Kleiner, B., “How to Implement Activity-based Costing,” Logistics Information Management vol.10, no.2, 1997.

70. Esculier, G., “Using Improper costing methods may lead to losses”, The TQM Magazine, vol.9, no.3, 228-230, 1997.

71. Schniederjans, M., and Garvin, T.,” Using the Analytic Hierarchy Process and multi-objective programming for the selection-of cost-drivers in activity based costing “, European Journal of Operation research vol.100, 72-80, 1997.

72. Cokins, G., “Activity-Based Cost Management Making It Work: A Manager's guide to implementing and sustaining an Effective ABC System,” Boston, Mass., McGraw Hill, 1996.

73. Miller, J., Implementing Activity based Management in Daily Operations,” John Wiley & Sons NY, 1996.

74. Vadgama, A. and Trybula, W., “Activity based Enterprise Analysis through Modeling,” Electronics Manufacturing Technology Symposium, Nineteenth IEEE/CPMT, 123-129, 1996.

75. Park, C., and Kim, G., “An Economic Evaluation Model for Advanced Manufacturing systems using activity based costing”, Journal Of Manufacturing Systems vol. 14, no 6, 1995.

76. Dahlen, P. and Wernersson. “Human Factors in the Economic Control Of Industry,” International Journal of Industrial Ergonomics vol.15, 215-221, 1995.

77. Malik, S. and Sullivan, W., “Impact of ABC Information on Product Mix and Costing Decisions,” Engineering Management, IEEE Transactions, vol.42, no.2, 171-176, 1995.

78. Park, C. and Kim, G. “An Economic Evaluation Model for Advanced Manufacturing Systems Using Activity Based Costing,” Journal of Manufacturing Systems, vol.14, no.6, 439-451, 1995.

79. Sharman, P., “Activity and Driver Analysis to implement ABC”, CMA Magazine, 13-16, July 1994.

80. Gardner, L., Grant, M., Roltson, L., “using Simulation to Benchmark Traditional VS. Activity Based Costing in Product Mix Decisions,” Simulation Conference Proc. 1050-1057, Winter, 1994.

81. Lewis, R. J., 1993, Activity-Based Costing for Marketing and Manufacturing”, Westport, Conn.: Quorum Books.

82. Babad, M. and Balachandaran, B. “Cost Driver Optimization in Activity-Based Costing,” Accounting Review, 563-575, July 1993.

83. Dopuch, N. “A Perspective on Cost Drivers,” Accounting Review, 615-620, July 1993.

84. Cokins, G., Stratton, A., and Helbling, J., “An ABC Manager's Primer”, Institute of Management Accountants. Montvale, N.J., 1992.

85. Novin, A., “Applying Overhead: How to find right bases and rates”, Management Accounting, 40-43, March 1992.

86. Roth, H., and Borthick, A., “Are you Distorting costs by Violating ABC Assumptions,” Management Accounting, Vol. 73, 39-42, November 1991.

87. Herman, E, “Multi-Level Cost-Management for Manufacturing,” North American Die casting Association, Rosemont, Ill. (U.S.A), 1991.

88. Cooper, R., “The Rise of Activity Based Costing—Part three:—How many cost drivers do you need and How do you select them? ” Journal of Cost Management, Vol.2, No.4, 34-36, 1989.

89. Razzak, M., Daley, G., Dismukes, J. P., “TPM²: An integrated support paradigm for productivity improvement using simulation”, MESM 2002 proceedings, UAE, Sep. 28, 2002.

90. Razzak, M., Daley, G., Dismukes, J. P., “Factory Level Metrics: Basis for productivity improvement”, MASM 2002 proceedings, Apr. 10-12, 2002, Tempe, Ariz.

91. Law, A, McComas, M., “Simulation of manufacturing system”, proceedings of the 1999 winter simulation conference.

92. Mehta, A., “Smart Modeling: Basic methodology and advanced tools”, proceedings of the 200 winter simulation conference.

93. Banks, J., “The future of simulation software: A Panel discussion”, proceedings of the 1998 winter simulation conference.

94. Kelton, W., Sandowski, R., Sandowski, D., “Simulation with Arena”, A Text book on Arena Simulation.

We claim:

1. A hierarchical method for causally relating productivity to a production system to provide an integrated productivity analysis of the system, comprising:
a) identifying an array of production operations including any one or more of the following: process, transportation, storage, cost, building of simulation model, and time;
b) modeling the system as an interconnected array of unit production processes (UPP) reflecting actual or desired material flow sequence through the system;
c) applying at least one set of UPP interconnections to factor the system into at least one set of UPP complex manufacturing subsystems (CMS) for description and analysis;
d) assessing each UPP and each subsystem (CMS) to calculate at least one productivity metric of each UPP, UPP subsystem (CMS) and the system;
e) determining a quantity of Operating Sequences (OSs) describing the material flow sequence of products through the complex manufacturing subsystem (CMS);
f) determining product throughout or input, Pₐ, good product output, P_{g}, and defective product, Pₐ-P_{g}, for a total time, T_{T}, of measurement or simulation;
g) determining each OS in the complex manufacturing subsystem (CMS), and determining Overall Equipment Effectiveness (OEE) for each of the UPPs;
h) determining availability efficiency (A_{eff}) or yield of each UPP; and
i) determining Overall Throughput Effectiveness (OTE) of the complex manufacturing subsystem (CMS) by the relations,
OTE_{CMS}=[P_{th(CMS)}/P_{tha(CMS)}] and P_{tha(CMS)}=R_{thavg(CMS)}*T_{T}
where, quantity P_{tha(CMS)} is theoretical actual product output units from the complex manufacturing subsystem (CMS) in total time, and R_{thavg(CMS)} is defined as the average theoretical processing rate for total product output from the complex manufacturing subsystem (CMS) during the period of total time T_{T}, and, optionally
j) collecting the total costs the system including at least one of Direct Manufacturing Costs (DMC): Process Labor (PL), Process Energy and Utilities (PE & U), Process Tooling (PT), Process Materials (PM), Equipment Depreciation (ED), and Direct Materials (DM);
k) defining all direct manufacturing activities at each UPP activity, including at least one of: Manufacturing Operations (MO), Engineering Operations (EO), Quality Assurance Operations (QAO), Material Handling Operations (MHO), and Production Management (PM);
l) allocating the DMC from each of the set of 6 (six) DMC Categories in step j) above to each of the 5 direct manufacturing activities defined in step k) at the respective UPP activity centers based on second stage cost driver factors;
m) obtaining a dollar value of costs of each of the activities of the respective UPP-activity center using Equations (15-2) and (15-3),
$$\begin{matrix}A {C}_{ij}^{UPP} = {\sum }_{k} {DMC}_{k} \times {DCD}_{ijk} & ( 15 \text{-} 2 ) \\ A {C}_{i}^{UPP} = {\sum }_{j} A {C}_{ij}^{UPP} = {\sum }_{j} {\sum }_{k} {DMC}_{k} \times {DCD}_{ijk} & ( 15 \text{-} 3 )\end{matrix}$$
where
AC^{UPP}ᵢⱼ=the jth activity cost component contributed to UPP activity center i
AC^{UPP}ᵢ=total activity cost of UPP activity cost center
DMCₖ=kth direct manufacturing cost component
DCDᵢⱼₖ=direct resource cost driver which allocates kth direct manufacturing cost to jth activity component of UPP activity center i;
n) allocating the costs of each of the five general sets of activities of the respective UPP-activity center to three products based on third stage cost-driver factor as follows:
$$\frac{\text{Manufacturing Operations Labor Hrs of} \text{UPP} \text{-1 on Product-1}}{\text{Total Manufacturing Operations Labor Hours for All} \text{UPP} \text{'s}} = xx$$
and,
o) determining the total unit direct manufacturing cost (TDMCₖ, $/unit) for each product type, k, from Equation (15-4), where the numerator represents the total dollar cost of product contributed by each UPP activity center, and P_{g(k)} represents the number of good product units of product type k
$${TDMC}_{k} = \frac{{\sum }_{i ∈ OP} {\sum }_{j} A {C}_{ij}^{UPP} \times {ACD}_{ijk}}{{P}_{g ( k )}} \qquad ( 15 \text{-} 4 )$$
and further optionally,
p) determining the total direct manufacturing cost of a unit of good product averaged over all product types, k, during the period, T_{T}, from Equation 15-(5),
$$\begin{matrix}{TDMC}_{AVG} = \frac{{\sum }_{k} {\sum }_{i ∈ OP} {\sum }_{j} A {C}_{ij}^{UPP} \times {ACD}_{ijk}}{{\sum }_{k} {P}_{g ( k )}} \\ = \frac{{\sum }_{k} {\sum }_{i ∈ OP} {\sum }_{j} A {C}_{ij}^{UPP} \times {ACD}_{ijk}}{OTE \times {R}_{avg ( F )}^{( th )} \times {T}_{T}}\end{matrix} \qquad ( 15 \text{-} 5 )$$
where
ACDᵢⱼₖ=activity center cost driver, which traces the jth activity cost of UPP activity center i to product type k
OTE=unit-based overall throughput effectiveness of the factory
R^{(th)}_{avg(F)}=theoretical average processing rate in time T_{T} for products through the factory,
thereby establishing a relation of the average product cost to productivity (OTE).

2. The method of claim 1, in which the manufacturing subsystem comprises a plurality of integrated processing modules linked together.

3. The method of claim 2, in which the manufacturing subsystem comprises fixed-sequence cluster tools.

4. The method of claim 2, in which the manufacturing subsystem comprises flexible-sequence cluster tools.

5. The method of claim 2, in which each UPP comprises input transport rates from an upstream UPP, and output transport rates to a downstream UPP, input and output storage buffers for work in process, and a unit process step.

6. The method of claim 1, in which algorithms are applied to calculate the productivity metrics of unit based overall equipment effectiveness (OEE), cycle time effectiveness (CTE), production throughput of good product (P_{g}) and UPP inventory level (Lᵤₚₚ), based on any one or more of the following: factory data for equipment time parameters, theoretical cycle time, actual cycle time, arrival and departure rates, and input and output buffer levels.

7. The method of claim 1, in which algorithms are applied to calculate UPP subsystem and/or system level productivity metrics of overall throughput effectiveness (OTE_{F}), cycle time effectiveness (CTE_{F}), production throughput of good product (P_{G(F)}) and UPP subsystem or factory inventory level (L_{F}), based on factory data and the productivity metrics for each UPP.

8. The method of claim 1, in which measurement, monitoring and quantitative calculation of the productivity metrics for the UPPs, the UPP subsystems, and/or production system is conducted using spreadsheet analysis tools which represent an actual factory architecture or the system.

9. The method of claim 8, in which measurement, monitoring and quantitative calculation of the productivity metrics for the UPPs, the UPP subsystems, and systems is conducted using a flowchart tool and a graphical user interface for data input and metrics output in appropriate spreadsheet or chart format.

10. The method of claim 9, comprising:
creating UPPs required to represent the generic subsystem types,
creating data input and metrics output boxes for standard input and output of data and results,
linking the UPPs to represent the experimental material flow sequence, or system architecture, with recognition algorithms applied to identify generic subsystem types, and
calculating productivity metrics for each UPP, UPP subsystem, and the overall system.

11. The method of claim 10, in which the UPPs include regular, assembly and expansion.

12. The method of claim 1, further comprising building an automated simulation model comprising importing data in spreadsheet form from a flowcharting and measurement tool, and representing interconnectivity of the system and actual and theoretical performance characteristics.

13. The method of claim 12, in which the simulation model comprises a rapid what-if scenario analysis of existing production facilities or systems, wherein specific changes needed for bottleneck removal and productivity improvement are identified.

14. The method of claim 13, in which the scenario analysis is linked to market demand.

15. The method of claim 13, in which the simulation model comprises rapid assessment and development of new factory designs optimized for specific manufacturing performance.

16. The method of claim 1, wherein the UPP includes any one or more of the following: equipment, subsystem, product line, factory, transportation system, and supply chain (which includes transportation systems and manufacturing systems).

17. The method of claim 1, wherein measurement and analysis of the system are conducted using a spreadsheet analysis and a visual flowcharting and measurement tool coded with the algorithms for unit-based productivity measurement at the equipment, subsystem and system level.

18. The method of claim 17, wherein the measurement and analysis of the system is conducted for single and/or multiple product types.

19. The method of claim 17, wherein data representing interconnectivity of the system and intrinsic performance characteristics are transferred from the flowcharting and measurement tool via at least one or more spreadsheets to set up an equivalent manufacturing array in a discrete event simulation software package.

20. The method of claim 19, wherein development and implementation of a dynamic simulation is used to assess scenarios for eliminating bottlenecks and tailoring performance, and to develop new designs optimized for specific requirements in the production system.

21. The method of claim 19, wherein the production system includes any one or more of the following: equipment, subsystem, product line, manufacturing process, factory, transportation system, and supply chains (which includes transportation systems and manufacturing systems).

22. The method of claim 1, wherein the method is used to analyze overall equipment effectiveness.

23. A method for hierarchical representation of a production system for measuring, monitoring, analyzing and/or simulating production performance of the production system based on a common set of productivity metrics for throughput effectiveness, cycle time effectiveness, overall throughput effectiveness, and inventory, comprising:
a) identifying an array of production operations including any one or more of the following: process, transportation, storage, cost, building of simulation model, and time;
b) providing a description of the production system as an interconnected array of unit production processes (UPP) reflecting an actual material flow sequence through the system;
c) applying at least one set of UPP complex manufacturing subsystems (CMS) to factor an overall system flowchart into UPP complex manufacturing subsystems (CMS), and combining the subsystems to represent the overall production system;
d) analyzing productivity metrics of each UPP, each UPP complex manufacturing subsystem (CMS), and the overall system;
e) determining a quantity of Operating Sequences (OSs) describing the material flow sequence of products through the complex manufacturing subsystem;
f) determining product throughout or input, Pₐ, good product output, P_{g}, and defective product, Pₐ-P_{g}, for a total time, T_{T}, of measurement or simulation;
g) determining each OS in the complex manufacturing subsystem (CMS), and determining Overall Equipment Effectiveness (OEE) for each of the UPPs;
h) determining availability efficiency (A_{eff}) or yield of each UPP; and
i) determining Overall Throughput Effectiveness (OTE) of the complex manufacturing subsystem (CMS) by the relations,
OTE_{CMS}=[P_{tha(CMS)}/P_{tha(CMS)}] and P_{tha(CMS)}=R_{thavg(CMS)}*T_{T}
or,
OTE_{CMS}=A_{(CMS)}·P_{(CMS)}·Q_{(CMS)}
where, quantity P_{tha(CMS)} is theoretical actual product output units from the complex manufacturing subsystem (CMS) in total time, and R_{thavg(CMS)} is defined as the average theoretical processing rate for total product output from the complex manufacturing subsystem (CMS) during the period of total time T_{T}, and converting the overall system flowchart to a discrete event simulation description, and enabling comparative performance assessment of various production scenarios useful for performance improvement and system design and, optionally
j) collecting the total costs the system including at least one of Direct Manufacturing Costs (DMC): Process Labor (PL), Process Energy and Utilities (PE & U), Process Tooling (PT), Process Materials (PM), Equipment Depreciation (ED), and Direct Materials (DM);
k) defining all direct manufacturing activities at each UPP activity, including at least one of: Manufacturing Operations (MO), Engineering Operations (EO), Quality Assurance Operations (QAO), Material Handling Operations (MHO), and Production Management (PM);
l) allocating the DMC from each of the set of 6 (six) DMC Categories in step j) above to each of the 5 direct manufacturing activities defined in step k) at the respective UPP activity centers based on second stage cost driver factors;
m) obtaining a dollar value of costs of each of the activities of the respective UPP-activity center using Equations (15-2) and (15-3),
$$\begin{matrix}A {C}_{ij}^{UPP} = {\sum }_{k} {DMC}_{k} \times {DCD}_{ijk} & ( 15 \text{-} 2 ) \\ A {C}_{i}^{UPP} = {\sum }_{j} A {C}_{ij}^{UPP} = {\sum }_{j} {\sum }_{k} {DMC}_{k} \times {DCD}_{ijk} & ( 15 \text{-} 3 )\end{matrix}$$
where
AC^{UPP}ᵢⱼ=the jth activity cost component contributed to UPP activity center i
AC^{UPP}ᵢ=total activity cost of UPP activity cost center
DMCₖ=kth direct manufacturing cost component
DCDᵢⱼₖ=direct resource cost driver which allocates kth direct manufacturing cost to jth activity component of UPP activity center i;
n) allocating the costs of each of the five general sets of activities of the respective UPP-activity center to three products based on third stage cost-driver factor as follows:
$$\frac{\text{Manufacturing Operations Labor Hrs of} \text{UPP} \text{-1 on Product-1}}{\text{Total Manufacturing Operations Labor Hours for All} \text{UPP} \text{'s}} = xx$$
and,
o) determining the total unit direct manufacturing cost (TDMCₖ, $/unit) for each product type, k, from Equation (15-4), where the numerator represents the total dollar cost of product contributed by each UPP activity center, and P_{g(k)} represents the number of good product units of product type k
$${TDMC}_{k} = \frac{{\sum }_{i ∈ OP} {\sum }_{j} A {C}_{ij}^{UPP} \times {ACD}_{ijk}}{{P}_{g ( k )}} \qquad ( 15 \text{-} 4 )$$
and further optionally,
p) determining the total direct manufacturing cost of a unit of good product averaged over all product types, k, during the period, T_{T}, from Equation 15-(5),
$$\begin{matrix}{TDMC}_{AVG} = \frac{{\sum }_{k} {\sum }_{i ∈ OP} {\sum }_{j} A {C}_{ij}^{UPP} \times {ACD}_{ijk}}{{\sum }_{k} {P}_{g ( k )}} \\ = \frac{{\sum }_{k} {\sum }_{i ∈ OP} {\sum }_{j} A {C}_{ij}^{UPP} \times {ACD}_{ijk}}{OTE \times {R}_{avg ( F )}^{( th )} \times {T}_{T}}\end{matrix} \qquad ( 15 \text{-} 5 )$$
where
ACDᵢⱼₖ=activity center cost driver, which traces the jth activity cost of UPP activity center i to product type k
OTE=unit-based overall throughput effectiveness of the factory
R^{(th)}_{avg(F)}=theoretical average processing rate in time T_{T} for products through the factory,
thereby establishing a relation of the average product cost to productivity (OTE).

24. The method of claim 23, in which the manufacturing subsystem comprises a plurality of integrated processing modules linked together.

25. The method of claim 24, in which the manufacturing subsystem comprises fixed-sequence cluster tools.

26. The method of claim 24, in which the manufacturing subsystem comprises flexible-sequence cluster tools.

27. The method of claim 23, in which each UPP comprises input transport rates from an upstream UPP, and output transport rates to a downstream UPP, input and output storage buffers for work in process, and a unit process step.

28. The method of claim 23, in which algorithms are applied to calculate the productivity metrics of unit based overall equipment effectiveness (OEE), cycle time effectiveness (CTE), production throughput of good product (P_{g}) and UPP inventory level (Lᵤₚₚ), based on any one or more of the following: factory data for equipment time parameters, theoretical cycle time, actual cycle time, arrival and departure rates, and input and output buffer levels.

29. The method of claim 23, in which algorithms are applied to calculate UPP subsystem and/or system level productivity metrics of overall throughput effectiveness (OTE_{F}), cycle time effectiveness (CTE_{F}), production throughput of good product (P_{G(F)}) and UPP subsystem or factory inventory level (L_{F}), based on factory data and the productivity metrics for each UPP.

30. The method of claim 23, in which measurement, monitoring and quantitative calculation of the productivity metrics for the UPPs, the UPP subsystems, and/or production system is conducted using spreadsheet analysis tools which represent an actual factory architecture or the system.

31. The method of claim 30, in which measurement, monitoring and quantitative calculation of the productivity metrics for the UPPs, the UPP subsystems, and systems is conducted using a flowchart tool and a graphical user interface for data input and metrics output in appropriate spreadsheet or chart format.

32. The method of claim 31, comprising:
creating UPPs required to represent the generic subsystem types,
creating data input and metrics output boxes for standard input and output of data and results,
linking the UPPs to represent the experimental material flow sequence, or system architecture, with recognition algorithms applied to identify generic subsystem types, and
calculating productivity metrics for each UPP, UPP subsystem, and the overall system.

33. The method of claim 32, in which the UPPs include regular, assembly and expansion.

34. The method of claim 23, further comprising building an automated simulation model comprising importing data in spreadsheet form from a flowcharting and measurement tool, and representing interconnectivity of the system and actual and theoretical performance characteristics.

35. The method of claim 23, in which the simulation model comprises a rapid what-if scenario analysis of existing production facilities or systems, wherein specific changes needed for bottleneck removal and productivity improvement are identified.

36. The method of claim 23, in which the scenario analysis is linked to market demand.

37. The method of claim 23, in which the simulation model comprises rapid assessment and development of new factory designs optimized for specific manufacturing performance.

38. The method of claim 23, wherein the UPP includes anyone or more of the following: equipment, subsystem, product line, manufacturing process, factory, transportation system, and supply chains (which includes transportation systems and manufacturing systems).

39. The method of claim 23, wherein measurement and analysis of the system are conducted using a spreadsheet analysis and a visual flowcharting and measurement tool coded with the algorithms for unit-based productivity measurement, for single or multiple product types, at the equipment, subsystem and system level.

40. The method of claim 39, wherein the measurement and analysis of the system is conducted for single and multiple product types.

41. The method of claim 39, wherein data representing interconnectivity of the system and intrinsic performance characteristics are transferred from the flowcharting and measurement tool via at least one spreadsheet to set up an equivalent manufacturing array in a discrete event simulation software package.

42. The method of claim 41, wherein development and implementation of a dynamic simulation used to assess scenarios for eliminating bottlenecks and tailoring performance, and to develop new designs optimized for specific requirements in the production system.

43. The method of claim 23, wherein the production system includes any one or more of the following: equipment, subsystem, product line, manufacturing process, factory, transportation system, and supply chains (which includes transportation systems and manufacturing systems).

44. The method of claim 23, wherein the method is used to analyze overall equipment effectiveness.

45. The method of claim 23, wherein the system layout or architecture is determined by factoring the system into unique combinations of UPP subsystems.

46. A method for analysis of system level productivity comprising:
a) establishing a unique layout or architecture for arranging at least one set of unit production processes (UPPs) in a complex manufacturing subsystem;
b) calculating overall equipment effectiveness (OEE) and, optionally, other parameters of individual UPP's;
c) calculating overall throughput effectiveness (OTE_{F}) of the UPP complex manufacturing subsystems and the system;
d) calculating good production output (P_{G(F)}) of the UPP complex manufacturing subsystem and the system;
e) calculating cycle time efficiency (CTE_{F}) of the UPP complex manufacturing subsystem and the system; and
f) calculating factory level inventory (L_{F}) of the UPP complex manufacturing subsystem and the system,
g) determining each OS in the complex manufacturing subsystem (CMS), and determining Overall Equipment Effectiveness (OEE) for each of the UPPs;
h) determining availability efficiency (A_{eff}) or yield of each UPP; and
i) determining Overall Throughput Effectiveness (OTE) of the complex manufacturing subsystem (CMS) by the relations,
OTE_{CMS}=[P_{tha(CMS)}/P_{tha(CMS)}] and P_{tha(CMS)}=R_{thavg(CMS)}*T_{T}
where, quantity P_{tha(CMS)} is theoretical actual product output units from the complex manufacturing subsystem (CMS) in total time, and R_{thavg(CMS)} is defined as the average theoretical processing rate for total product output from the complex manufacturing subsystem (CMS) during the period of total time T_{T}, and, optionally
j) collecting the total costs the system including at least one of Direct Manufacturing Costs (DMC): Process Labor (PL), Process Energy and Utilities (PE & U), Process Tooling (PT), Process Materials (PM), Equipment Depreciation (ED), and Direct Materials (DM);
k) defining all direct manufacturing activities at each UPP activity, including at least one of: Manufacturing Operations (MO), Engineering Operations (EO), Quality Assurance Operations (QAO), Material Handling Operations (MHO), and Production Management (PM);
l) allocating the DMC from each of the set of 6 (six) DMC Categories in step j) above to each of the 5 direct manufacturing activities defined in step k) at the respective UPP activity centers based on second stage cost driver factors;
m) obtaining a dollar value of costs of each of the activities of the respective UPP-activity center using Equations (15-2) and (15-3),
$$\begin{matrix}A {C}_{ij}^{UPP} = {\sum }_{k} {DMC}_{k} \times {DCD}_{ijk} & ( 15 \text{-} 2 ) \\ A {C}_{i}^{UPP} = {\sum }_{j} A {C}_{ij}^{UPP} = {\sum }_{j} {\sum }_{k} {DMC}_{k} \times {DCD}_{ijk} & ( 15 \text{-} 3 )\end{matrix}$$
where
AC^{UPP}ᵢⱼ=the jth activity cost component contributed to UPP activity center i
AC^{UPP}ᵢ=total activity cost of UPP activity cost center
DMCₖ=kth direct manufacturing cost component
DCDᵢⱼₖ=direct resource cost driver which allocates kth direct manufacturing cost to jth activity component of UPP activity center i;
n) allocating the costs of each of the five general sets of activities of the respective UPP-activity center to three products based on third stage cost-driver factor as follows:
$$\frac{\text{Manufacturing Operations Labor Hrs of} \text{UPP} \text{-1 on Product-1}}{\text{Total Manufacturing Operations Labor Hours for All} \text{UPP} \text{'s}} = xx$$
and,
o) determining the total unit direct manufacturing cost (TDMCₖ, $/unit) for each product type, k, from Equation (15-4), where the numerator represents the total dollar cost of product contributed by each UPP activity center, and P_{g(k)} represents the number of good product units of product type k
$${TDMC}_{k} = \frac{{\sum }_{i ∈ OP} {\sum }_{j} A {C}_{ij}^{UPP} \times {ACD}_{ijk}}{{P}_{g ( k )}} \qquad ( 15 \text{-} 4 )$$
and further optionally,
p) determining the total direct manufacturing cost of a unit of good product averaged over all product types, k, during the period, T_{T}, from Equation 15-(5),
$$\begin{matrix}{TDMC}_{AVG} = \frac{{\sum }_{k} {\sum }_{i ∈ OP} {\sum }_{j} A {C}_{ij}^{UPP} \times {ACD}_{ijk}}{{\sum }_{k} {P}_{g ( k )}} \\ = \frac{{\sum }_{k} {\sum }_{i ∈ OP} {\sum }_{j} A {C}_{ij}^{UPP} \times {ACD}_{ijk}}{OTE \times {R}_{avg ( F )}^{( th )} \times {T}_{T}}\end{matrix} \qquad ( 15 \text{-} 5 )$$
where
ACDᵢⱼₖ=activity center cost driver, which traces the jth activity cost of UPP activity center i to product type k
OTE=unit-based overall throughput effectiveness of the factory
R^{(th)}_{avg(F)}=theoretical average processing rate in time T_{T} for products through the factory,
thereby establishing a relation of the average product cost to productivity (OTE).

47. The method of claim 46, wherein the system layout or architecture is determined by factoring the complex system into unique combinations of UPP subsystems.

48. The method of claim 47, in which the manufacturing subsystem comprises a plurality of integrated processing modules linked together.

49. The method of claim 48, in which the manufacturing subsystem comprises fixed-sequence cluster tools.

50. The method of claim 48, in which the manufacturing subsystem comprises flexible-sequence cluster tools.

51. The method of claim 46, in which each UPP comprises input transport rates from an upstream UPP, and output transport rates to a downstream UPP, input and output storage buffers for work in process, and a unit process step.

52. The method of claim 46, in which algorithms are applied to calculate the productivity metrics of unit based overall equipment effectiveness (OEE), cycle time effectiveness (CTE), production throughput of good product (P_{g}) and UPP inventory level (Lᵤₚₚ), based on any one or more of the following: factory data for equipment time parameters, theoretical cycle time, actual cycle time, arrival and departure rates, and input and output buffer levels.

53. The method of claim 46, in which algorithms are applied to calculate UPP subsystem and/or system level productivity metrics of overall throughput effectiveness (OTE_{F}), cycle time effectiveness (CTE_{F}), production throughput of good product (P_{G(F)}) and UPP subsystem or factory inventory level (L_{F}), based on factory data and the productivity metrics for each UPP.

54. The method of claim 46, in which measurement, monitoring and quantitative calculation of the productivity metrics for the UPPs, the UPP subsystems, and/or production system is conducted using spreadsheet analysis tools which represent an actual factory architecture or the system.

55. The method of claim 54, in which measurement, monitoring and quantitative calculation of the productivity metrics for the UPPs, the UPP subsystems, and systems is conducted using a flowchart tool and a graphical user interface for data input and metrics output in appropriate spreadsheet or chart format.

56. The method of claim 55, comprising:
creating UPPs required to represent the generic subsystem types,
creating data input and metrics output boxes for standard input and output of data and results,
linking the UPPs to represent the experimental material flow sequence, or system architecture, with recognition algorithms applied to identify generic subsystem types, and
calculating productivity metrics for each UPP, UPP subsystem, and the overall system.

57. The method of claim 56, in which the UPPs include regular, assembly and expansion.

58. The method of claim 46, further comprising building an automated simulation model comprising importing data in spreadsheet form from a flowcharting and measurement tool, and representing interconnectivity of the system and actual and theoretical performance characteristics.

59. The method of claim 46, in which the simulation model comprises a rapid what-if scenario analysis of existing production facilities or systems, wherein specific changes needed for bottleneck removal and productivity improvement are identified.

60. The method of claim 46, in which the scenario analysis is linked to market demand.

61. The method of claim 46, in which the simulation model comprises rapid assessment and development of new factory designs optimized for specific manufacturing performance.

62. The method of claim 46, wherein the UPP includes any one or more of the following equipment, subsystem, product line, manufacturing process, factory, transportation system, and supply chains (which includes transportation systems and manufacturing systems).

63. The method of claim 46, wherein measurement and analysis of the system are conducted using a spreadsheet analysis and a visual flowcharting and measurement tool coded with the algorithms for unit-based productivity measurement at the equipment, subsystem and system level.

64. The method of claim 46, wherein the measurement and analysis of the system is conducted for single and/or multiple product types.

65. The method of claim 63, wherein data representing interconnectivity of the system and intrinsic performance characteristics are transferred from the flowcharting and measurement tool via at least one or more spreadsheets to set up an equivalent manufacturing array in a discrete event simulation software package.

66. The method of claim 65, wherein development and implementation of a dynamic simulation is used to assess scenarios for eliminating bottlenecks and tailoring performance, and to develop new designs optimized for specific requirements in the production system.

67. The method of claim 46, wherein the production system includes any one or more of the following: equipment, subsystem, product line, manufacturing process, factory, transportation system, and supply chains (which includes transportation systems and manufacturing systems).

68. The method of claim 46, wherein the method is used to analyze overall equipment effectiveness.

69. The method of claim 46, wherein the system layout or architecture is determined by factoring the system into unique combinations of UPP subsystems.

70. A computer system for relating productivity to a production system to provide an integrated productivity analysis of the system comprising:
a) identifying an array of production operations including any one or more of the following: process, transportation, storage, cost, building of simulation model, and times;
b) modeling the system as an interconnected array of unit production processes (UPP) reflecting actual or desired material flow sequence through the system;
c) applying at least one set of UPP interconnections to factor the system into at least one set of UPP complex manufacturing subsystems for description and analysis;
d) assessing each UPP and each complex manufacturing subsystem to calculate at least one productivity metric of each UPP, UPP complex manufacturing subsystem and the system;
e) determining a quantity of Operating Sequences (OSs) describing the material flow sequence of products through the complex manufacturing subsystem;
f) determining product throughout or input, Pₐ, good product output, P_{g}, and defective product, Pₐ-P_{g}, for a total time, T_{T}, of measurement or simulation;
g) determining each OS in the complex manufacturing subsystem (CMS), and determining Overall Equipment Effectiveness (OEE) for each of the UPPs;
h) determining availability efficiency (A_{eff}) or yield of each UPP; and
i) determining Overall Throughput Effectiveness (OTE) of the complex manufacturing subsystem (CMS) by the relations,
OTE_{CMS}=[P_{tha(CMS)}/P_{tha(CMS)}] and P_{tha(CMS)}=R_{thavg(CMS)}*T_{T}
where, quantity P_{tha(CMS)} is theoretical actual product output units from the complex manufacturing subsystem (CMS) in total time, and R_{thavg(CMS)} is defined as the average theoretical processing rate for total product output from the complex manufacturing subsystem (CMS) during the period of total time T_{T} and, optionally
j) collecting the total costs the system including at least one of Direct Manufacturing Costs (DMC): Process Labor (PL), Process Energy and Utilities (PE & U), Process Tooling (PT), Process Materials (PM), Equipment Depreciation (ED), and Direct Materials (DM);
k) defining all direct manufacturing activities at each UPP activity, including at least one of: Manufacturing Operations (MO), Engineering Operations (EO), Quality Assurance Operations (QAO), Material Handling Operations (MHO), and Production Management (PM);
l) allocating the DMC from each of the set of 6 (six) DMC Categories in step j) above to each of the 5 direct manufacturing activities defined in step k) at the respective UPP activity centers based on second stage cost driver factors;
m) obtaining a dollar value of costs of each of the activities of the respective UPP-activity center using Equations (15-2) and (15-3),
$$\begin{matrix}A {C}_{ij}^{UPP} = {\sum }_{k} {DMC}_{k} \times {DCD}_{ijk} & ( 15 \text{-} 2 ) \\ A {C}_{i}^{UPP} = {\sum }_{j} A {C}_{ij}^{UPP} = {\sum }_{j} {\sum }_{k} {DMC}_{k} \times {DCD}_{ijk} & ( 15 \text{-} 3 )\end{matrix}$$
where
AC^{UPP}ᵢⱼ=the jth activity cost component contributed to UPP activity center i
AC^{UPP}ᵢ=total activity cost of UPP activity cost center
DMCₖ=kth direct manufacturing cost component
DCDᵢⱼₖ=direct resource cost driver which allocates kth direct manufacturing cost to jth activity component of UPP activity center i;
n) allocating the costs of each of the five general sets of activities of the respective UPP-activity center to three products based on third stage cost-driver factor as follows:
$$\frac{\text{Manufacturing Operations Labor Hrs of} \text{UPP} \text{-1 on Product-1}}{\text{Total Manufacturing Operations Labor Hours for All} \text{UPP} \text{'s}} = xx$$
and,
o) determining the total unit direct manufacturing cost (TDMCₖ, $/unit) for each product type, k, from Equation (154), where the numerator represents the total dollar cost of product contributed by each UPP activity center, and P_{g(k)} represents the number of good product units of product type k
$${TDMC}_{k} = \frac{{\sum }_{i ∈ OP} {\sum }_{j} A {C}_{ij}^{UPP} \times {ACD}_{ijk}}{{P}_{g ( k )}} \qquad ( 15 \text{-} 4 )$$
and further optionally,
p) determining the total direct manufacturing cost of a unit of good product averaged over all product types, k, during the period, T_{T}, from Equation 15-(5),
$$\begin{matrix}{TDMC}_{AVG} = \frac{{\sum }_{k} {\sum }_{i ∈ OP} {\sum }_{j} A {C}_{ij}^{UPP} \times {ACD}_{ijk}}{{\sum }_{k} {P}_{g ( k )}} \\ = \frac{{\sum }_{k} {\sum }_{i ∈ OP} {\sum }_{j} A {C}_{ij}^{UPP} \times {ACD}_{ijk}}{OTE \times {R}_{avg ( F )}^{( th )} \times {T}_{T}}\end{matrix} \qquad ( 15 \text{-} 5 )$$
where
ACDᵢⱼₖ=activity center cost driver, which traces the jth activity cost of UPP activity center i to product type k
OTE=unit-based overall throughput effectiveness of the factory
R^{(th)}_{avg(F)}=theoretical average processing rate in time T_{T} for products through the factory,
thereby establishing a relation of the average product cost to productivity (OTE).

71. The computer system of claim 70, in which the manufacturing subsystem comprises a plurality of integrated processing modules linked together.

72. The computer system of claim 71, in which the manufacturing subsystem comprises fixed-sequence cluster tools.

73. The computer system of claim 71, in which the manufacturing subsystem comprises flexible-sequence cluster tools.

74. A computer system of claim 70, in which each UPP comprises input transport rates from an upstream UPP, and output transport rates to a downstream UPP, input and output storage buffers for work in process, and a unit process step.

75. A computer system of claim 70, in which algorithms are applied to calculate the productivity metrics of unit based overall equipment effectiveness (OEE), cycle time effectiveness (CTE), production throughput of good product (P_{g}) and UPP inventory level (Lᵤₚₚ) based on any one or more of the following: factory data for equipment time parameters, theoretical cycle time, actual cycle time, arrival and departure rates, and input and output buffer levels.

76. A computer system of claim 70, in which algorithms are applied to calculate UPP subsystem and/or system level productivity metrics of overall throughput effectiveness (OTE_{F}), cycle time effectiveness (CTE_{F}), production throughput of good product (P_{G(F)}) and UPP subsystem or factory inventory level (L_{F}), based on factory data and the productivity metrics for each UPP.

77. A computer system of claim 70, in which measurement, monitoring and quantitative calculation of the productivity metrics for the UPPs, the UPP subsystems, and/or production system is conducted using spreadsheet analysis tools which represent an actual factory architecture or the system.

78. A computer system of claim 70, in which measurement, monitoring and quantitative calculation of the productivity metrics for the UPPs, the UPP subsystems, and systems is conducted using a flowchart tool and a graphical user interface for data input and metrics output in appropriate spreadsheet or chart format.

79. A computer system of claim 77, comprising:
creating UPPs required to represent the generic subsystem types,
creating data input and metrics output boxes for standard input and output of data and results,
linking the UPPs to represent the experimental material flow sequence, or system architecture, with recognition algorithms applied to identify the generic subsystem types, and
calculating productivity metrics for each UPP, UPP subsystem, and the overall system.

80. A computer system of claim 78, in which the UPPs include regular, assembly and expansion.

81. A computer system of claim 70, further comprising building an automated simulation model comprising importing data in spreadsheet form from a flowcharting and measurement tool, and representing interconnectivity of the system and actual and theoretical performance characteristics.

82. A computer system of claim 70, in which the simulation model comprises a rapid what-if scenario analysis of existing production facilities or systems, wherein specific changes needed for bottleneck removal and productivity improvement are identified.

83. A computer system of claim 70, in which the scenario analysis is linked to market demand.

84. A computer system of claim 70, in which the simulation model comprises rapid assessment and development of new factory designs optimized for specific manufacturing performance.

85. A computer system of claim 70, wherein the UPP includes any one or more of the following: equipment, subsystem, product line, manufacturing process, factory, transportation system, and supply chains (which includes transportation systems and manufacturing systems).

86. A computer system of claim 70, wherein measurement and analysis of the system are conducted using a spreadsheet analysis and a visual flowcharting and measurement tool coded with the algorithms for unit-based productivity measurement at the equipment, subsystem and system level.

87. A computer system of claim 86, wherein the measurement and analysis of the system is conducted for single and/or multiple product types.

88. A computer system of claim 70, wherein data representing interconnectivity of the system and intrinsic performance characteristics are transferred from the flowcharting and measurement tool via at least one or more appropriate spreadsheets to set up an equivalent manufacturing array in a discrete event simulation software package.

89. A computer system of claim 88, wherein development and implementation of a dynamic simulation is used to assess scenarios for eliminating bottlenecks and tailoring performance, and to develop new designs optimized for specific requirements in the production system.

90. A computer system of claim 70, wherein the production system includes any one or more of the following: equipment, subsystem, product line, manufacturing process, factory, transportation system, and supply chains (which includes transportation systems and manufacturing systems).

91. A computer system of claim 70, wherein the method is used to analyze overall equipment effectiveness.

92. A computer system for hierarchical representation of a production system for measuring, monitoring, analyzing and/or simulating production performance of the production system based on a common set of productivity metrics for throughput effectiveness, cycle time effectiveness, throughput and inventory, comprising:
a) identifying an array of production operations including any one or more of the following: process, transportation, storage, cost, building of simulation model, and time;
b) providing a description of the production system as an interconnected array of unit production processes (UPP) reflecting an actual material flow sequence through the system;
c) applying at least one set of UPP subsystems to factor an overall system flowchart into UPP complex manufacturing subsystems, and combining the subsystems to represent the overall production system;
d) analyzing productivity metrics of each UPP, each UPP complex manufacturing subsystem, and the overall system;
e) determining a quantity of Operating Sequences (OSs) describing the material flow sequence of products through the complex manufacturing subsystem;
f) determining product throughout or input, Pₐ, good product output, P_{g}, and defective product, Pₐ-P_{g}, for a total time, T_{T}, of measurement or simulation;
g) determining each OS in the complex manufacturing subsystem (CMS), and determining Overall Equipment Effectiveness (OEE) for each of the UPPs;
h) determining availability efficiency (A_{eff}) or yield of each UPP; and
i) determining Overall Throughput Effectiveness (OTE) of the complex manufacturing subsystem (CMS) by the relations,
OTE_{CMS}=[P_{tha(CMS)}/P_{tha(CMS)}] and P_{tha(CMS)}=R_{thavg(CMS)}*T_{T}
or,
OTE_{CMS}=A_{(CMS)}·P_{(CMS)}·Q_{(CMS)}.
where, quantity P_{tha(CMS)} is theoretical actual product output units from the complex manufacturing subsystem (CMS) in total time, and R_{thavg(CMS)} is defined as the average theoretical processing rate for total product output from the complex manufacturing subsystem (CMS) during the period of total time T_{T}; and, optionally
j) collecting the total costs the system including at least one of Direct Manufacturing Costs (DMC): Process Labor (PL), Process Energy and Utilities (PE & U), Process Tooling (PT), Process Materials (PM), Equipment Depreciation (ED), and Direct Materials (DM);
k) defining all direct manufacturing activities at each UPP activity, including at least one of: Manufacturing Operations (MO), Engineering Operations (EO), Quality Assurance Operations (QAO), Material Handling Operations (MHO), and Production Management (PM);
l) allocating the DMC from each of the set of 6 (six) DMC Categories in step j) above to each of the 5 direct manufacturing activities defined in step k) at the respective UPP activity centers based on second stage cost driver factors;
m) obtaining a dollar value of costs of each of the activities of the respective UPP-activity center using Equations (15-2) and (15-3),
$$\begin{matrix}A {C}_{ij}^{UPP} = {\sum }_{k} {DMC}_{k} \times {DCD}_{ijk} & ( 15 \text{-} 2 ) \\ A {C}_{i}^{UPP} = {\sum }_{j} A {C}_{ij}^{UPP} = {\sum }_{j} {\sum }_{k} {DMC}_{k} \times {DCD}_{ijk} & ( 15 \text{-} 3 )\end{matrix}$$
where
AC^{UPP}ᵢⱼ=the jth activity cost component contributed to UPP activity center i
AC^{UPP}ᵢ=total activity cost of UPP activity cost center
DMCₖ=kth direct manufacturing cost component
DCDᵢⱼₖ=direct resource cost driver which allocates kth direct manufacturing cost to jth activity component of UPP activity center i;
n) allocating the costs of each of the five general sets of activities of the respective UPP-activity center to three products based on third stage cost-driver factor as follows:
$$\frac{\text{Manufacturing Operations Labor Hrs of} \text{UPP} \text{-1 on Product-1}}{\text{Total Manufacturing Operations Labor Hours for All} \text{UPP} \text{'s}}$$
and,
o) determining the total unit direct manufacturing cost (TDMCₖ, $/unit) for each product type, k, from Equation (15-4), where the numerator represents the total dollar cost of product contributed by each UPP activity center, and P_{g(k)} represents the number of good product units of product type k
$${TDMC}_{k} = \frac{{\sum }_{i ∈ OP} {\sum }_{j} A {C}_{ij}^{UPP} \times {ACD}_{ijk}}{{P}_{g ( k )}} \qquad ( 15 \text{-} 4 )$$
and further optionally,
p) determining the total direct manufacturing cost of a unit of good product averaged over all product types, k, during the period, T_{T}, from Equation 15-(5),
$$\begin{matrix}{TDMC}_{AVG} = \frac{{\sum }_{k} {\sum }_{i ∈ OP} {\sum }_{j} A {C}_{ij}^{UPP} \times {ACD}_{ijk}}{{\sum }_{k} {P}_{g ( k )}} \\ = \frac{{\sum }_{k} {\sum }_{i ∈ OP} {\sum }_{j} A {C}_{ij}^{UPP} \times {ACD}_{ijk}}{OTE \times {R}_{avg ( F )}^{( th )} \times {T}_{T}}\end{matrix} \qquad ( 15 \text{-} 5 )$$
where
ACDᵢⱼₖ=activity center cost driver, which traces the jth activity cost of UPP activity center i to product type k
OTE=unit-based overall throughput effectiveness of the factory
R^{(th)}_{avg(F)}=theoretical average processing rate in time T_{T} for products through the factory,
thereby establishing a relation of the average product cost to productivity (OTE), and, further
q) converting the flowchart to a discrete event simulation description, and enabling comparative performance assessment of various production scenarios useful for performance improvement and system design.

93. The computer system of claim 92, in which the manufacturing subsystem comprises a plurality of integrated processing modules linked together.

94. The computer system of claim 93, in which the manufacturing subsystem comprises fixed-sequence cluster tools.

95. The computer system of claim 93, in which the manufacturing subsystem comprises flexible-sequence cluster tools.

96. A computer program product comprising a program storage device readable by a computer system tangibly embodying a program of instructions executed by the computer system to perform in a process for causally relating productivity to a production system, the process comprising:
a) identifying an array of production operations including any one or more of the following: process, transportation, storage, cost, building of simulation model, and time;
b) modeling the system as an interconnected array of unit production processes (UPP) reflecting actual or desired material flow sequence through the system;
c) applying at least one set of UPP interconnections to factor the system into at least one set of UPP complex manufacturing subsystems for description and analysis;
d) assessing each UPP and each complex manufacturing subsystem type to calculate at least one productivity metric of each UPP, UPP complex manufacturing subsystem and the system; and
e) determining a quantity of Operating Sequences (OSs) describing the material flow sequence of products through the complex manufacturing subsystem;
f) determining product throughout or input, Pₐ, good product output, P_{g}, and defective product, Pₐ-P_{g}, for a total time, T_{T}, of measurement or simulation;
g) determining each OS in the complex manufacturing subsystem (CMS), and determining Overall Equipment Effectiveness (OEE) for each of the UPPs;
h) determining availability efficiency (A_{eff}) or yield of each UPP; and
i) determining Overall Throughput Effectiveness (OTE) of the complex manufacturing subsystem (CMS) by the relations,
OTE_{CMS}=[P_{tha(CMS)}/P_{tha(CMS)}] and P_{tha(CMS)}=R_{thavg(CMS)}*T_{T}
where, quantity P_{tha(CMS)} is theoretical actual product output units from the complex manufacturing subsystem (CMS) in total time, and R_{thavg(CMS)} is defined as the average theoretical processing rate for total product output from the complex manufacturing subsystem (CMS) during the period of total time T_{T} and, optionally
j) collecting the total costs the system including at least one of Direct Manufacturing Costs (DMC): Process Labor (PL), Process Energy and Utilities (PE & U), Process Tooling (PT), Process Materials (PM), Equipment Depreciation (ED), and Direct Materials (DM);
k) defining all direct manufacturing activities at each UPP activity, including at least one of: Manufacturing Operations (MO), Engineering Operations (EO), Quality Assurance Operations (QAO), Material Handling Operations (MHO), and Production Management (PM);
l) allocating the DMC from each of the set of 6 (six) DMC Categories in step j) above to each of the 5 direct manufacturing activities defined in step k) at the respective UPP activity centers based on second stage cost driver factors;
m) obtaining a dollar value of costs of each of the activities of the respective UPP-activity center using Equations (15-2) and (15-3),
$$\begin{matrix}A {C}_{ij}^{UPP} = {\sum }_{k} {DMC}_{k} \times {DCD}_{ijk} & ( 15 \text{-} 2 ) \\ A {C}_{i}^{UPP} = {\sum }_{j} A {C}_{ij}^{UPP} = {\sum }_{j} {\sum }_{k} {DMC}_{k} \times {DCD}_{ijk} & ( 15 \text{-} 3 )\end{matrix}$$
where
AC^{UPP}ᵢⱼ=the jth activity cost component contributed to UPP activity center i
AC^{UPP}ᵢ=total activity cost of UPP activity cost center
DMCₖ=kth direct manufacturing cost component
DCDᵢⱼₖ=direct resource cost driver which allocates kth direct manufacturing cost to jth activity component of UPP activity center i;
n) allocating the costs of each of the five general sets of activities of the respective UPP-activity center to three products based on third stage cost-driver factor as follows:
$$\frac{\text{Manufacturing Operations Labor Hrs of} \text{UPP} \text{-1 on Product-1}}{\text{Total Manufacturing Operations Labor Hours for All} \text{UPP} \text{'s}} = xx$$
and,
o) determining the total unit direct manufacturing cost (TDMCₖ, $/unit) for each product type, k, from Equation (154), where the numerator represents the total dollar cost of product contributed by each UPP activity center, and P_{g(k)} represents the number of good product units of product type k
$${TDMC}_{k} = \frac{{\sum }_{i ∈ OP} {\sum }_{j} A {C}_{ij}^{UPP} \times {ACD}_{ijk}}{{P}_{g ( k )}} \qquad ( 15 \text{-} 4 )$$
and further optionally,
p) determining the total direct manufacturing cost of a unit of good product averaged over all product types, k, during the period, T_{T}, from Equation 15-(5),
$$\begin{matrix}{TDMC}_{AVG} = \frac{{\sum }_{k} {\sum }_{i ∈ OP} {\sum }_{j} A {C}_{ij}^{UPP} \times {ACD}_{ijk}}{{\sum }_{k} {P}_{g ( k )}} \\ = \frac{{\sum }_{k} {\sum }_{i ∈ OP} {\sum }_{j} A {C}_{ij}^{UPP} \times {ACD}_{ijk}}{OTE \times {R}_{avg ( F )}^{( th )} \times {T}_{T}}\end{matrix} \qquad ( 15 \text{-} 5 )$$
where
ACDᵢⱼₖ=activity center cost driver, which traces the jth activity cost of UPP activity center i to product type k
OTE=unit-based overall throughput effectiveness of the factory
R^{(th)}_{avg(F)}=theoretical average processing rate in time T_{T} for products through the factory,
thereby establishing a relation of the average product cost to productivity (OTE).

97. The computer program product of claim 96, in which the manufacturing subsystem comprises a plurality of integrated processing modules linked together.

98. The computer program product of claim 97, in which the manufacturing subsystem comprises fixed-sequence cluster tools.

99. The computer program product of claim 97, in which the manufacturing subsystem comprises flexible-sequence cluster tools.

100. The method of claim 96, in which each UPP comprises input transport rates from an upstream UPP, and output transport rates to a downstream UPP, input and output storage buffers for work in process, and a unit process step.

101. The method of claim 96, in which algorithms are applied to calculate the productivity metrics of unit based overall equipment effectiveness (OEE), cycle time effectiveness (CTE), production throughput of good product (P_{g}) and UPP inventory level (Lᵤₚₚ), based on any one or more of the following: factory data for equipment time parameters, theoretical cycle time, actual cycle time, arrival and departure rates, and input and output buffer levels.

102. The method of claim 96, in which algorithms are applied to calculate UPP subsystem and/or system level productivity metrics of overall throughput effectiveness (OTE_{F}), cycle time effectiveness (CTE_{F}), production throughput of good product (P_{G(F)}) and UPP subsystem or factory inventory level (L_{F}), based on factory data and the productivity metrics for each UPP.

103. The method of claim 96, in which measurement, monitoring and quantitative calculation of the productivity metrics for the UPPs, the UPP subsystems, and/or production system is conducted using spreadsheet analysis tools which represent an actual factory architecture or the system.

104. The method of claim 96, in which measurement, monitoring and quantitative calculation of the metrics for the UPPs, the UPP subsystems, and systems is conducted using a flowchart tool and a graphical user interface for data input and metrics output in appropriate spreadsheet or chart format.

105. The method of claim 101, comprising:
creating UPPs required to represent the generic subsystem types,
creating data input and metrics output boxes for standard input and output of data and results,
linking the UPPs to represent the experimental material flow sequence, or system architecture, with recognition algorithms applied to identify the generic subsystem types, and
calculating productivity metrics for each UPP, UPP subsystem, and the overall system.

106. The method of claim 105, in which the UPPs include regular, assembly and expansion.

107. The method of claim 96, further comprising building an automated simulation model comprising importing data in spreadsheet form from a flowcharting and measurement tool, and representing interconnectivity of the system and actual and theoretical performance characteristics.

108. The method of claim 96, in which the simulation model comprises a rapid what-if scenario analysis of existing production facilities or systems, wherein specific changes needed for bottleneck removal and productivity improvement are identified.

109. The method of claim 96, in which the scenario analysis is linked to market demand.

110. The method of claim 96, in which the simulation model comprises rapid assessment and development of new factory designs optimized for specific manufacturing performance.

111. The method of claim 96, wherein the UPP includes any one or more of the following: equipment, subsystem, product line, manufacturing process, factory, transportation system, and supply chains (which includes transportation systems and manufacturing systems).

112. A computer program of claim 96, wherein measurement and analysis of the system are conducted using a spreadsheet analysis and a visual flowcharting and measurement tool coded with the algorithms for unit-based productivity measurement at the equipment, subsystem and system level.

113. The method of claim 112, wherein the measurement and analysis of the system is conducted for single and/or multiple product types.

114. A computer program of claim 112, wherein data representing interconnectivity of the system and intrinsic performance characteristics are transferred from the flowcharting and measurement tool via at least one or more spreadsheets to set up an equivalent manufacturing array in a discrete event simulation software package.

115. A computer program of claim 114, wherein development and implementation of a dynamic simulation is used to assess scenarios for eliminating bottlenecks and tailoring performance, and to develop new designs optimized for specific requirements in the production system.

116. A computer program of claim 96, wherein the production system includes any one or more of the following: equipment, subsystem, product line, manufacturing process, factory, transportation system, and supply chains (which includes transportation systems and manufacturing systems).

117. A computer program of claim 96, wherein the method used to analyze overall equipment effectiveness.

118. The method of claim 1, wherein step (g) comprises calculating average theoretical processing rates of chamber and pseudo-chambers in a Series-Connected subsystem for all operation sequences (OSs) by using the following equation
$${R}_{iso ( ij )}^{S ( th )} = \frac{{P}_{a ( i )}}{{\sum }_{i} \frac{{P}_{a ( i )}}{{R}_{avg ( ij )}^{( th )}}} \qquad ( 3 b )$$
where Rᵢₛₒ₍ᵢⱼ₎^{S(th)} is an isolated average theoretical processing rate of operation sequence i and chamber j in the Series-Connected subsystem; R_{avg(ij)}^{(th)} is the average theoretical processing rate of operation sequence i and chamber j; and Pₐ₍ᵢ₎ is the total product output/processed (units) from operation sequence i in a total time T_{T},
wherein the “isolated” average theoretical processing rate of the pseudo-chamber is the average theoretical processing rate for the actual product output from the pseudo-chamber in an operation sequence as if its operation were completely separated or independent from other operation sequences;
calculating the “isolated” average theoretical processing rates of chamber and pseudo-chambers in a Parallel-Connected subsystem for all operation sequences (OSs) by using the following equation
$${R}_{iso ( ij )}^{P ( th )} = \frac{{P}_{ath ( ij )}}{{\sum }_{i} \frac{{P}_{ath ( ij )}}{{R}_{avg ( ij )}^{( th )}}} \qquad ( 4 b )$$
where Rᵢₛₒ₍ᵢⱼ₎^{P(th)} is the isolated average theoretical processing rate of operation sequence i and chamber j in the Parallel-Connected subsystem; and Pₐₜₕ₍ᵢⱼ₎ is the total theoretical product output/processed (units) from operation sequence i and chamber j in a total time T_{T} and is determined by
$${P}_{ath ( ij )} = \frac{( {P}_{a ( i )} ) ( {R}_{avg ( ij )}^{( th )} )}{{\sum }_{j ∈ Par ( i )} {R}_{avg ( ij )}^{( th )}} \qquad ( 5 b )$$
where Par₍ᵢ₎ represents a Parallel-Connected subsystem in operation sequence I;
calculating the isolated average theoretical processing rate of each operation sequence,
wherein the isolated average theoretical processing rate of the operation sequence is the average theoretical processing rate for the actual product output from the operation sequence as if its operation were completely separated or independent from other operation sequences; and,
summing up the “isolated” average theoretical processing rate of each operation sequence to obtain the average theoretical processing rate of subsystem (R_{avg(CT)}^{(th)}.

119. The method of claim 118 wherein (R_{avg(CT)}^{(th)}) is used to calculate P_{a(CT)}^{(th)}, theoretical total product output/processes (units) from the subsystem in a total time T_{T},
P_{a(CT)}^{(th)}=(R_{avg(CT)}^{(th)})(T_{T}) (2b)
and the overall throughput effectiveness is defined as
$${OTE}_{( CT )} = \frac{{P}_{g ( CT )}}{{P}_{a ( CT )}^{( th )}} \qquad ( 1 b )$$
where P_{g(CT)} is the total good product output (units) from the subsystem during the period of T_{T}.

120. The method of claim 118, comprising determining the overall throughput effectiveness (OTE) of step (i) by determining the product of the available efficiency, the performance efficiency, and the quality efficiency
OTE_{(CT)}=(A_{eff(CT)})(P_{eff(CT)})(Q_{eff(CT)}) (10b).

121. The method of claim 120, wherein the available efficiency for the subsystem is defined as
$${A}_{eff ( CT )} = \frac{{T}_{U ( CT )}}{{T}_{T}} \qquad ( 6 b )$$
where T_{U(CT)} is the uptime for the subsystem during the period of T_{T} or where the uptime for the subsystem during the period of T_{T} is calculated by
T_{U(CT)}=T_{T}−T_{D(CT)}−T_{NS(CT)} (7b)
where T_{D(CT)} is the downtime (including scheduled and unscheduled downtime) for the subsystem during the period of T_{T′}; and T_{NS(CT)} is the nonscheduled time for the subsystem during the period of T_{T};
wherein the performance efficiency is defined as
$${P}_{eff ( CT )} = \frac{{P}_{a ( CT )}}{{R}_{avg ( CT )}^{( th )} {T}_{U ( CT )}} , \qquad ( 8 b )$$
where P_{a(CT)} is the total actual product (units) processed by the Cluster Tool during the period of T_{T};
and, the quality efficiency of the subsystem is defined as
$${Q}_{eff ( CT )} = \frac{{P}_{g ( CT )}}{{P}_{a ( CT )}} . \qquad ( 9 b )$$

122. The method of claim 23 wherein step (g) comprises calculating average theoretical processing rates of chamber and pseudo-chambers in a Series-Connected subsystem for all operation sequences (OSs) by using the following equation
$${R}_{iso ( ij )}^{S ( th )} = \frac{{P}_{a ( i )}}{{\sum }_{i} \frac{{P}_{a ( i )}}{{R}_{avg ( ij )}^{( th )}}} \qquad ( 3 b )$$
where Rᵢₛₒ₍ᵢⱼ₎^{S(th)} is an isolated average theoretical processing rate of operation sequence i and chamber j in the Series-Connected subsystem; R_{avg(ij)}^{(th)} is the average theoretical processing rate of operation sequence i and chamber j; and _{Pa(i)} is the total product output/processed (units) from operation sequence i in a total time T_{T},
wherein the “isolated” average theoretical processing rate of the pseudo-chamber is the average theoretical processing rate for the actual product output from the pseudo-chamber in an operation sequence as if its operation were completely separated or independent from other operation sequences;
calculating the “isolated” average theoretical processing rates of chamber and pseudo-chambers in a Parallel-Connected subsystem for all operation sequences (OSs) by using the following equation
$${R}_{iso ( ij )}^{P ( th )} = \frac{{P}_{ath ( ij )}}{{\sum }_{i} \frac{{P}_{ath ( ij )}}{{R}_{avg ( ij )}^{( th )}}} \qquad ( 4 b )$$
where Rᵢₛₒ₍ᵢⱼ₎^{*th)} is the isolated average theoretical processing rate of operation sequence i and chamber j in the Parallel-Connected subsystem; and Pₐₜₕ₍ᵢⱼ₎ is the total theoretical product output/processed (units) from operation sequence i and chamber j in a total time T_{T} and is determined by
$${P}_{ath ( ij )} = \frac{( {P}_{a ( i )} ) ( {R}_{avg ( ij )}^{( th )} )}{{\sum }_{j ∈ Par ( i )} {R}_{avg ( ij )}^{( th )}} \qquad ( 5 b )$$
where Par₍ᵢ₎ represents a Parallel-Connected subsystem in operation sequence I;
calculating the isolated average theoretical processing rate of each operation sequence,
wherein the isolated average theoretical processing rate of the operation sequence is the average theoretical processing rate for the actual product output from the operation sequence as if its operation were completely separated or independent from other operation sequences; and,
summing up the “isolated” average theoretical processing rate of each operation sequence to obtain the average theoretical processing rate of subsystem (R_{avg(CT)}^{(th)}).

123. The method of claim 122 wherein (R_{avg(CT)}^{(th)}) is used to calculate P_{a(CT)}^{(th)}, theoretical total Product output/processes (units) from the subsystem in a total time T_{T},
P_{a(CT)}^{(th)}=(R_{avg(CT)}^{(th)})(T_{T}) (2b)
and the overall throughput effectiveness is defined as
$${OTE}_{( CT )} = \frac{{P}_{g ( CT )}}{{P}_{a ( CT )}^{( th )}} \qquad ( 1 b )$$
where P_{g(CT)} is the total good product output (units) from the subsystem during the period of T_{T}.

124. The method of claim 122, comprising determining the overall throughput effectiveness (OTE) of step (i) by determining the product of the available efficiency, the performance efficiency, and the quality efficiency
OTE_{(CT)}=(A_{eff(CT)})(P_{eff(CT)})(Q_{eff(CT)}) (10b.

125. The method of claim 124, wherein the available efficiency for the subsystem is defined as
$${A}_{eff ( CT )} = \frac{{T}_{U ( CT )}}{{T}_{T}} \qquad ( 6 b )$$
where T_{U(CT)} is the uptime for the subsystem during the period of T_{T} or where the uptime for the subsystem during the period of T_{T} is calculated by
T_{U(CT)}=T_{T}−T_{D(CT)}−T_{NS(CT)} (7b)
where T_{D(CT)} is the downtime (including scheduled and unscheduled downtime) for the subsystem during the period of T_{T}; and T_{NS(CT)} is the nonscheduled time for the subsystem during the period of T_{T}; wherein the performance efficiency is defined as
$${P}_{eff ( CT )} = \frac{{P}_{a ( CT )}}{{R}_{avg ( CT )}^{( th )} {T}_{U ( CT )}} , \qquad ( 8 b )$$
where P_{a(CT)} is the total actual product (units) processed by the Cluster Tool during the period of T_{T};
and, the quality efficiency of the subsystem is defined as
$${Q}_{eff ( CT )} = \frac{{P}_{g ( CT )}}{{P}_{a ( CT )}} . \qquad ( 9 b )$$

126. The computer system of claim 70, wherein step (g) comprises calculating average theoretical processing rates of chamber and pseudo-chambers in a Series-Connected subsystem for all operation sequences (OSs) by using the following equation
$${R}_{iso ( ij )}^{S ( th )} = \frac{{P}_{a ( i )}}{{\sum }_{i} \frac{{P}_{a ( i )}}{{R}_{avg ( ij )}^{( th )}}} \qquad ( 3 b )$$
where Rᵢₛₒ₍ᵢⱼ₎^{S(th)} is an isolated average theoretical processing rate of operation sequence i and chamber j in the Series-Connected subsystem; R_{avg(ij)}^{(th)} is the average theoretical processing rate of operation sequence i and chamber j; and Pₐ₍ᵢ₎ is the total product output/processed (units) from operation sequence i in a total time T_{T},
wherein the “isolated” average theoretical processing rate of the pseudo-chamber is the average theoretical processing rate for the actual product output from the pseudo-chamber in an operation sequence as if its operation were completely separated or independent from other operation sequences;
calculating the “isolated” average theoretical processing rates of chamber and pseudo-chambers in a Parallel-Connected subsystem for all operation sequences (OSs) by using the following equation
$${R}_{iso ( ij )}^{P ( th )} = \frac{{P}_{ath ( ij )}}{{\sum }_{i} \frac{{P}_{ath ( ij )}}{{R}_{avg ( ij )}^{( th )}}} \qquad ( 4 b )$$
where Rᵢₛₒ₍ᵢⱼ₎^{P(th)} is the isolated average theoretical processing rate of operation sequence i and chamber j in the Parallel-Connected subsystem; and Pₐₜₕ₍ᵢⱼ₎ is the total theoretical product output/processed (units) from operation sequence i and chamber j in a total time T_{T} and is determined by
$${P}_{ath ( ij )} = \frac{( {P}_{a ( i )} ) ( {R}_{avg ( ij )}^{( th )} )}{{\sum }_{j ∈ Par ( i )} {R}_{avg ( ij )}^{( th )}} \qquad ( 5 b )$$
where Par₍ᵢ₎ represents a Parallel-Connected subsystem in operation sequence l;
calculating the isolated average theoretical processing rate of each operation sequence,
wherein the isolated average theoretical processing rate of the operation sequence is the average theoretical processing rate for the actual product output from the operation sequence as if its operation were completely separated or independent from other operation sequences; and,
summing up the “isolated” average theoretical processing rate of each operation sequence to obtain the average theoretical processing rate of subsystem (R_{avg(CT)}^{(th)}).

127. The computer system of claim 126 wherein (R_{avg(CT)}^{(th)}) is used to calculate P_{a(CT)}^{(th)}, theoretical total product output/processes (units) from the subsystem in a total time T_{T},
P_{a(CT)}^{(th)}=(R_{avg(CT)}^{(th)})(T_{T}) (2b)
and the overall throughput effectiveness is defined as
$${OTE}_{( CT )} = \frac{{P}_{g ( CT )}}{{P}_{a ( CT )}^{( th )}} \qquad ( 1 b )$$
where P_{g(CT)} is the total good product output (units) from the subsystem during the period of T_{T}.

128. The computer system of claim 126, comprising determining the overall throughput effectiveness (OTE) of step (i) by determining the product of the available efficiency, the performance efficiency, and the quality efficiency
OTE_{(CT)}=(A_{eff(CT)})(P_{eff(CT)})(Q_{eff(CT)}) (10b).

129. The computer system of claim 128, wherein the available efficiency for the subsystem is defined as
$${A}_{eff ( CT )} = \frac{{T}_{U ( CT )}}{{T}_{T}} \qquad ( 6 b )$$
where T_{U(CT)} is the uptime for the subsystem during the period of T_{T} or where the uptime for the subsystem during the period of T_{T} is calculated by
T_{U(CT)}=T_{T}−T_{D(CT)}−T_{NS(CT)} (7b)
where T_{D(CT)} is the downtime (including scheduled and unscheduled downtime) for the subsystem during the period of T_{T}; and T_{NS(CT)} is the nonscheduled time for the subsystem during the period of T_{T};
wherein the performance efficiency is defined as
$${P}_{eff ( CT )} = \frac{{P}_{a ( CT )}}{{R}_{avg ( CT )}^{( th )} {T}_{U ( CT )}} , \qquad ( 8 b )$$
where P_{a(CT)} is the total actual product (units) processed by the Cluster Tool during the period of T_{T};
and, the quality efficiency of the subsystem is defined as
$${Q}_{eff ( CT )} = \frac{{P}_{g ( CT )}}{{P}_{a ( CT )}} . \qquad ( 9 b )$$

130. The computer system of claim 92, wherein step (g) comprises calculating average theoretical processing rates of chamber and pseudo-chambers in a Series-Connected subsystem for all operation sequences (OSs) by using the following equation
$${R}_{iso ( ij )}^{S ( th )} = \frac{{P}_{a ( i )}}{{\sum }_{i} \frac{{P}_{a ( i )}}{{R}_{avg ( ij )}^{( th )}}} \qquad ( 3 b )$$
where Rᵢₛₒ₍ᵢⱼ₎^{S(th)} is an isolated average theoretical processing rate of operation sequence i and chamber j in the Series-Connected subsystem; R_{avg(ij)}^{(th)} is the average theoretical processing rate of operation sequence i and chamber j; and Pₐ₍ᵢ₎ is the total product output/processed (units) from operation sequence i in a total time T_{T},
wherein the “isolated” average theoretical processing rate of the pseudo-chamber is the average theoretical processing rate for the actual product output from the pseudo-chamber in an operation sequence as if its operation were completely separated or independent from other operation sequences;
calculating the “isolated” average theoretical processing rates of chamber and pseudo-chambers in a Parallel-Connected subsystem for all operation sequences (OSs) by using the following equation
$${R}_{iso ( ij )}^{P ( th )} = \frac{{P}_{ath ( ij )}}{{\sum }_{i} \frac{{P}_{ath ( ij )}}{{R}_{avg ( ij )}^{( th )}}} \qquad ( 4 b )$$
where Rᵢₛₒ₍ᵢⱼ₎^{P(th)} is the isolated average theoretical processing rate of operation sequence i and chamber j in the Parallel-Connected subsystem; and Pₐₜₕ₍ᵢⱼ₎ is the total theoretical product output/processed (units) from operation sequence i and chamber j in a total time T_{T} and is determined by
$${P}_{ath ( ij )} = \frac{( {P}_{a ( i )} ) ( {R}_{avg ( ij )}^{( th )} )}{{\sum }_{j ∈ Par ( i )} {R}_{avg ( ij )}^{( th )}} \qquad ( 5 b )$$
where Par₍ᵢ₎ represents a Parallel-Connected subsystem in operation sequence l;
calculating the isolated average theoretical processing rate of each operation sequence,
wherein the isolated average theoretical processing rate of the operation sequence is the average theoretical processing rate for the actual product output from the operation sequence as if its operation were completely separated or independent from other operation sequences; and,
summing up the “isolated” average theoretical processing rate of each operation sequence to obtain the average theoretical processing rate of subsystem (R_{avg(CT)}^{(th)}).

131. The computer system of claim 130 wherein (R_{avg(CT)}^{(th)}) is used to calculate P_{a(CT)}^{(th)}, theoretical total product output/processes (units) from the subsystem in a total time T_{T},
P_{a(CT)}^{(th)}=(R_{avg(CT)}^{(th)})(T_{T}) (2b)
and the overall throughput effectiveness is defined as
$${OTE}_{( CT )} = \frac{{P}_{g ( CT )}}{{P}_{a ( CT )}^{( th )}} \qquad ( 1 b )$$
where P_{g(CT)} is the total good product output (units) from the subsystem during the period of T_{T}.

132. The computer system of claim 130, comprising determining the overall throughput effectiveness (OTE) of step (i) by determining the product of the available efficiency, the performance efficiency, and the quality efficiency
OTE_{(CT)}=(A_{eff(CT)})(P_{eff(CT)})(Q_{eff(CT)}) (10b).

133. The computer system of claim 132, wherein the available efficiency for the subsystem is defined as
$${A}_{eff ( CT )} = \frac{{T}_{U ( CT )}}{{T}_{T}} \qquad ( 6 b )$$
where T_{U(CT)} is the uptime for the subsystem during the period of T_{T} or where the uptime for the subsystem during the period of T_{T} is calculated by
T_{U(CT)}=T_{T}−T_{D(CT)}−T_{NS(CT)} (7b)
where T_{D(CT)} is the downtime (including scheduled and unscheduled downtime) for the subsystem during the period of T_{T}; and T_{NS(CT)} is the nonscheduled time for the subsystem during the period of T_{T};
wherein the performance efficiency is defined as
$${P}_{eff ( CT )} = \frac{{P}_{a ( CT )}}{{R}_{avg ( CT )}^{( th )} {T}_{U ( CT )}} , \qquad ( 8 b )$$
where P_{a(CT)} is the total actual product (units) processed by the Cluster Tool during the period of T_{T};
and, the quality efficiency of the subsystem is defined as
$${Q}_{eff ( CT )} = \frac{{P}_{g ( CT )}}{{P}_{a ( CT )}} . \qquad ( 9 b )$$

134. The computer program product of claim 96, wherein step (g) comprises calculating average theoretical processing rates of chamber and pseudo-chambers in a Series-Connected subsystem for all operation sequences (OSs) by using the following equation
$${R}_{iso ( ij )}^{S ( th )} = \frac{{P}_{a ( i )}}{{\sum }_{i} \frac{{P}_{a ( i )}}{{R}_{avg ( ij )}^{( th )}}} \qquad ( 3 b )$$
where Rᵢₛₒ₍ᵢⱼ₎^{S(th)} is an isolated average theoretical processing rate of operation sequence i and chamber j in the Series-Connected subsystem; R_{avg(ij)}^{(th)} is the average theoretical processing rate of operation sequence i and chamber j; and Pₐ₍ᵢ₎ is the total product output/processed (units) from operation sequence i in a total time T_{T},
wherein the “isolated” average theoretical processing rate of the pseudo-chamber is the average theoretical processing rate for the actual product output from the pseudo-chamber in an operation sequence as if its operation were completely separated or independent from other operation sequences;
calculating the “isolated” average theoretical processing rates of chamber and pseudo-chambers in a Parallel-Connected subsystem for all operation sequences (OSs) by using the following equation
$${R}_{iso ( ij )}^{P ( th )} = \frac{{P}_{ath ( ij )}}{{\sum }_{i} \frac{{P}_{ath ( ij )}}{{R}_{avg ( ij )}^{( th )}}} \qquad ( 4 b )$$
where Rᵢₛₒ₍ᵢⱼ₎^{P(th) is} the isolated average theoretical processing rate of operation sequence i and chamber j in the Parallel-Connected subsystem; and Pₐₜₕ₍ᵢⱼ₎ is the total theoretical product output/processed (units) from operation sequence i and chamber j in a total time T_{T} and is determined by
$${P}_{ath ( ij )} = \frac{( {P}_{a ( i )} ) ( {R}_{avg ( ij )}^{( th )} )}{{\sum }_{j ∈ Par ( i )} {R}_{avg ( ij )}^{( th )}} \qquad ( 5 b )$$
where Par₍ᵢ₎ represents a Parallel-Connected subsystem in operation sequence l;
calculating the isolated average theoretical processing rate of each operation sequence,
wherein the isolated average theoretical processing rate of the operation sequence is the average theoretical processing rate for the actual product output from the operation sequence as if its operation were completely separated or independent from other operation sequences; and, summing up the “isolated” average theoretical processing rate of each operation sequence to obtain the average theoretical processing rate of subsystem (R_{avg(CT)}^{(th)}).

135. The computer program product of claim 134 wherein (R_{avg(CT)}^{(th)}) is used to calculate P_{a(CT)}^{(th)}, theoretical total product output/processes (units) from the subsystem in a total time T_{T},
P_{a(CT)}^{(th)}=(R_{avg(CT)}^{(th)})(T_{T}) (2b)
and the overall throughput effectiveness is defined as
$${OTE}_{( CT )} = \frac{{P}_{g ( CT )}}{{P}_{a ( CT )}^{( th )}} \qquad ( 1 b )$$
where P_{g(CT)} is the total good product output (units) from the subsystem during the period of T_{T}.

136. The computer program product of claim 134, comprising determining the overall throughput effectiveness (OTE) of step (i) by determining the product of the available efficiency, the performance efficiency, and the quality efficiency
OTE_{(CT)}=(A_{eff(CT)})(P_{eff(CT)})(Q_{eff(CT)}) (10b).

137. The computer program product of claim 136, wherein the available efficiency for the subsystem is defined as
$${A}_{eff ( CT )} = \frac{{T}_{U ( CT )}}{{T}_{T}} \qquad ( 6 b )$$
where T_{U(CT)} is the uptime for the subsystem during the period of T_{T} or where the uptime for the subsystem during the period of T_{T} is calculated by
T_{U(CT)}=T_{T}−T_{D(CT)}−T_{NS(CT)} (7b)
where T_{D(CT)} is the downtime (including scheduled and unscheduled downtime) for the subsystem during the period of T_{T}; and T_{NS(CT)} is the nonscheduled time for the subsystem during the period of T_{T};
wherein the performance efficiency is defined as
$${P}_{eff ( CT )} = \frac{{P}_{a ( CT )}}{{R}_{avg ( CT )}^{( th )} {T}_{U ( CT )}} , \qquad ( 8 b )$$
where P_{a(CT)} is the total actual product (units) processed by the Cluster Tool during the period of T_{T};
and, the quality efficiency of the subsystem is defined as
$${Q}_{eff ( CT )} = \frac{{P}_{g ( CT )}}{{P}_{a ( CT )}} . \qquad ( 9 b )$$
